(19) United States
(12) Patent Application Publication
(10) Pub. No.: US 2005/0202912 A1
(43) Pub. Date: Sep. 15, 2005

(54) Adjuster systems for continuous variable transmissions

(76) Inventor: Armin Sebastian Tay, West Covina, CA (US)

Correspondence Address: ARMIN TAY, 2403 NIKKI COURT #2, WEST COVINA, CA, 91792, US

(21) Appl. No.: 11/039,297

(22) Filed: Jan. 20, 2005

Related U.S. Application Data
(63) Continuation-in-part of application No. PCT/US03/32161, filed on Oct. 8, 2003.
(60) Provisional application No. 60/545,010, filed on Feb. 17, 2004.
(60) Provisional application No. 60/572,017, filed on May 17, 2004.
(60) Provisional application No. 60/576,687, filed on Jun. 3, 2004.
(60) Provisional application No. 60/579,407, filed on Jun. 14, 2004.
(60) Provisional application No. 60/588,416, filed on Jul. 15, 2004.
(60) Provisional application No. 60/588,871, filed on Jul. 15, 2004.
(60) Provisional application No. 60/610,638, filed on Sep. 15, 2004.
(60) Provisional application No. 60/634,314, filed on Dec. 6, 2004.

(51) Int. Cl. F16H 9/02; F16H 63/00

(52) U.S. Cl. 474/83; 474/53

(57) ABSTRACT

Rotational position adjuster systems that can increase the performance of CVTs that suffer from either or both transition flexing and a limited duration at which the transmission ratio can be changed by providing proper rotational adjustment.

### CROSS REFERENCE TO RELATED APPLICATIONS

This invention is a Continuation-in-part (CIP) of International Application PCT/US2003/032161, which was filed on Oct. 8, 2003. In addition, this invention is entitled to the benefit of Provisional Patent Application (PPA) Ser. No. 60/545,010 filed on Feb. 17, 2004, PPA Ser. No. 60/572,017 filed on May 17, 2004, PPA Ser. No. 60/576,687 filed on Jun. 3, 2004, PPA Ser. No. 60/579,407 filed on Jun. 14, 2004, PPA Ser. No. 60/588,416 filed on Jul. 15, 2004, PPA Ser. No. 60/588,871 filed on Jul. 15, 2004, PPA Ser. No. 60/610,638 filed on Sep. 15, 2004, and PPA Ser. No. 60/634,314 filed on Dec. 6, 2004.

### BACKGROUND

1. Field of Invention

This invention relates to rotational position adjuster systems that can increase the performance of CVTs that suffer from either or both transition flexing and a limited duration at which the transmission ratio can be changed.

2. Description of Prior Art

Most mechanical CVTs available today are either a V-belt CVT, a cone CVT, a toroidal CVT, or a ratcheting CVT. A V-belt CVT basically has two push-belt sheaves that are coupled by a V-belt. Each push-belt sheave consists of two halves, where the width between the halves can be adjusted so as to adjust the radial position of the V-belt on the sheaves. A cone CVT basically has two cones, which are mounted on opposite shafts such that the apex of one cone is opposite from the apex of the other cone. The cones are then coupled by a belt. And for a toroidal CVT, torque is normally transmitted from one smooth surfaced rotating member to another smooth surfaced rotating member through the shear forces of a fluid that is pressed between the rotating members. The main disadvantage of a V-belt CVT, a cone CVT and a toroidal CVT is that they depend on friction to transmit torque. In order to transmit a large amount of torque by friction, large normal forces have to be generated. And generating these large normal forces reduces the efficiency of those CVTs. Furthermore, in most applications, in order to change the transmission ratio for those CVTs, one torque transmitting surface has to slide relative to another torque transmitting surface. And here sliding a torque transmitting surface relative to another normally requires a large actuating force and can cause a lot of wear in the torque transmitting surfaces. As mentioned earlier, another type of CVT is a ratcheting CVT. A ratcheting CVT normally has a ratcheting mechanism that converts oscillatory motion into rotational motion. Although a ratcheting CVT does not have to depend on friction to transmit torque, because of its ratcheting action, its operation is inefficient and unsmooth.

Cone assemblies, and CVTs utilizing those cone assemblies for which torque transmission does not have to depend on friction or a ratcheting mechanism have been described in U.S. Pat. No. 6,656,070. The advantages of the CVTs described in U.S. Pat. No. 6,656,070 is that they can transmit torque without depending on friction and that the transmission ratio can be changed without having excessive sliding between the torque transmitting surfaces. One CVT of U.S. Pat. No. 6,656,070, which is labeled as CVT 1, consist of a cone assembly with two oppositely positioned torque transmitting members, used to transmit torque, that is coupled to another cone assembly with two oppositely positioned torque transmitting members by a transmission belt, see FIG. 3. Another CVT of U.S. Pat. No. 6,656,070, which is labeled as CVT 2, consist of two cone assemblies with one torque transmitting member each, that are keyed on an input/output shaft so that the torque transmitting member of one cone assembly is positioned opposite of the torque transmitting member of the other cone assembly. The cone assemblies are then coupled by transmission belts to transmission pulleys keyed on an output/input shaft, see FIG. 13. The performances of the CVTs of U.S. Pat. No. 6,656,070 are reduced by transition flexing, which is flexing of the torque transmitting member(s) and coupling member(s), if applicable, due to instances where the circumferences of the cone assemblies where the torque transmitting member(s) are positioned are not a multiple of the width of the teeth of the torque transmitting member(s); and by a limited duration at which the transmission ratio can be changed. Excessive cycles of transition flexing can reduce the life of a CVT. And a limited duration at which the transmission ratio can be changed reduces the transmission ratio changing responsiveness of a CVT.

The purpose of this application is to improve the performance of CVTs that suffer from either or both transition flexing and a limited duration at which the transmission ratio can be changed, by eliminating or significantly reducing transition flexing and by substantially increasing the duration at which the transmission ratio of those CVTs can be changed. Although the emphasis is in improving the performance of the CVTs of U.S. Pat. No. 6,656,070, other type of CVTs that suffer from the same problem can benefit from this invention as well.

### SUMMARY

It is an object of this invention to provide adjuster systems that can increase the performance of CVTs, that suffer from either or both transition flexing and a limited duration at which the transmission ratio can be changed, so that an efficient non-friction dependent CVT that does not suffer from transition flexing or a limited duration at which the transmission ratio can be changed can be constructed.

### OBJECTS AND ADVANTAGES

In applying principles of this invention to various CVTs which suffer from either or both transition flexing and a limited duration at which the transmission ratio can be changed, the objects and advantages of the present invention are:
a) To provide adjuster systems that can eliminate or significantly reduce transition flexing in the CVTs, as to increase the live of the CVTs.
b) To provide adjuster systems that can substantially increase the duration at which the transmission ratio of the CVTs can be changed, as to improve the transmission ratio changing responsiveness of the CVTs,

### DRAWING FIGURES

In the drawings, closely relayed figures have the same number but different alphabetic suffixes.

FIG. 1A is a sectional front-view of CVT 1 of U.S. Pat. No. 6,656,070.

FIG. 1B is a top-view of CVT 1 of U.S. Pat. No. 6,656,070.

FIG. 2 is a sectional front-view of CVT 1.1.

FIG. 3 is a top-view of CVT 1.1.

FIG. 4 is a top-view of transition flexing adjuster AD1A 101A.

FIG. 5 is a top-view of mover adjuster AD2A 102A.

FIG. 6 is a partial top-view of transition flexing adjuster AD1A 101A.

FIG. 7 is a partial top-view of transition flexing adjuster AD1A 101, on which a relative rotational position sensor SN3A 133A is mounted.

FIG. 8 is a top-view of rotatable coupling 190.

FIG. 9 is a top-view of a ring and brush electrical connection.

FIG. 10 is a sectional front-view of constrainer mechanism CN1A 111A.

FIGS. 11A-11D shows how the relative rotational position between the torque transmitting members need to be adjusted in order to eliminate transition flexing.

FIG. 12A-12C show graphs that show the required rotational rotation, l_{θ}, vs. arc length of the critical non-torque transmitting arc, l_{c}.

FIG. 13 is a top-view of CVT 2.

FIG. 14 is a top-view of CVT 2.1.

FIGS. 15A-15D show sectional front-views of CVT 2.1, which show the angle θ, which is the angle between the neutral point, N, and the midpoint, M, of the upper positioned torque transmitting member, and the direction of transmission ratio change rotation, Δθ.

FIG. 16 shows an equation that can be used in order to calculate transmission ratio change rotation.

FIGS. 17A-17C, 18A, 18B, 19A, 19B, 20A, 20B show sectional front-views of CVT 2.1, which are used in order to illustrate the required direction of the adjusting rotation, ω_{A}, of transmission pulley 41C in order to compensate for transmission ratio change rotation.

FIG. 21A shows a top-view of electrical adjuster 160.

FIG. 21B shows a front-view of electrical adjuster 160.

FIG. 22 shows a top-view of CVT 1.2.

FIG. 23 shows a top-view of CVT 2.2.

FIG. 24 shows a top-view of CVT 2.3.

FIG. 25 shows a top-view of CVT 2.4.

FIG. 26 shows a top-view of CVT 2.5.

FIG. 27 show a top-view of differential adjuster shaft 1.

FIG. 28 show a top-view of differential adjuster shaft 2.

FIG. 29 show a top-view of differential adjuster shaft 3.

FIG. 30 show a partial phantom-view of the differential of differential adjuster shaft 3.

FIG. 31 show a top-view of differential adjuster shaft 4.

FIG. 32 show a partial phantom-view of the differential of differential adjuster shaft 4.

FIG. 33 shows a partial side-view of differential 212C, which utilizes the index wheel mechanism.

FIG. 34A shows partial top-view of the index wheel mechanism in its locking position.

FIG. 34B shows partial top-view of the index wheel mechanism in its stepwise releasing mode.

FIG. 34C shows partial top-view of the index wheel mechanism in its completely releasing mode.

FIG. 35 shows a top-view of a configuration where a differential adjuster shaft is connected to a mover frame.

FIG. 36 shows a top-view of a configuration of a differential adjuster shaft where its differential shafts are replaced by splines. On those splines, spline sleeves on which the transmission pulleys are keyed-on are slideably mounted.

FIG. 37A shows a top-view of spring-loaded adjuster AS1 171.

FIG. 37B shows a partial front-view of spring-loaded adjuster AS1 171.

FIG. 37C shows a partial side-view of spring-loaded adjuster AS1 171, showing the hidden inner profile of the adjuster.

FIG. 37D shows a sectional top-view of spring-loaded adjuster AS1 171.

FIG. 38A shows a front-view of spring-loaded adjuster AS2 172.

FIG. 38B shows a top-view of spring-loaded adjuster AS2 172.

FIG. 39A shows a front-view of mechanical adjuster AM1 181.

FIG. 39B shows a top-view of mechanical adjuster AM1 181.

FIG. 40 shows a top-view of CVT 2.6.

FIG. 41 shows a top-view of CVT 2.7.

FIG. 42 shows a top-view of CVT 1.3.

FIGS. 43A and 43B show sectional front-views of a CVT 2 showing the guiding wheels 200.

FIG. 44 shows a load cell wheel that is used to measure the tension of a transmission belt via a load cell.

FIG. 45 shows a the mounting of a cone assembly in the sliding cone mounting configuration.

FIG. 46 shows a side-view of the transmission belt tensioning mechanism used in the sliding cone mounting configuration.

FIG. 47 shows a front-view of a tensioning slider A used in the transmission belt tensioning mechanism shown in FIG. 46.

FIG. 48A shows as a front-view of a chain link for a chain, which can be used in a CVT, for which the depth of its left side plate is deeper than that of its right side plate.

FIG. 48B shows as a front-view of a chain link for a chain, which can be used for a CVT, for which rubber legs are attached to the chain link plates.

FIG. 49A shows a side-view of a link A as seen from the right side of the link which is used to form a torque transmitting member chain, which is a torque transmitting member formed by chain links.

FIG. 49B shows a front-view of a link A, which is used to form a torque transmitting member chain.

FIG. 50A shows a side-view of a torque transmitting member chain, as seen from the right side of the chain, formed by alternating links A 270 and links B 272.

FIG. 50B shows a front-view of a torque transmitting member chain formed by alternating links A 270 and links B 272.

FIG. 51A shows a side-view of an end link configuration for a link A as seen from the right side of the link.

FIG. 51B shows a front-view of an end link configuration for a link A.

FIG. 52A shows a side-view of a single tooth link.

FIG. 52B shows a front-view of a single tooth link.

FIG. 53 shows a reshaped left link plate of a link that can be used to form a torque transmitting member chain.

FIG. 54A shows how to adjust the location of the reinforcements in a torque transmitting member in order to increases or decrease the height of its neutral-axis.

FIG. 54B shows how to adjust the dimensions of a torque transmitting member in order to increases or decrease the height of its neutral-axis.

FIG. 55 shows a front-view of the chain torque transmitting member.

FIG. 56 shows a torque transmitting member that is formed by a left torque transmitting side member and by a right torque transmitting side member.

FIG. 57A shows a partial top-view of a torque transmitting side member.

FIG. 57B shows a partial side-view of a torque transmitting side member.

FIG. 57C shows an end-view of a torque transmitting side member.

FIG. 58 show as a top-view of a single tooth cone.

FIG. 59 show as a top-view of a single tooth cone that has a supporting surface.

FIG. 60A shows a side-view of an inverted belt that can be used with a single tooth cone.

FIG. 60B shows as sectional-view of an inverted belt that can be used with a single tooth cone.

FIG. 61A shows a top-view of an specialized inverted belt that can be used with a single tooth cone that has a supporting surface.

FIG. 61B shows a side-view of an specialized inverted belt that can be used with a single tooth cone that has a supporting surface.

FIG. 62, shows a side-view of a chain link of an inverted chain that can be used with a single tooth cone.

FIG. 63, shows a sectional-view of a single tooth cone CVT 2 cut near the smaller end of one of its cones which utilizes a supporting wheel.

FIG. 64 shows a top-view reinforced transmission belt 300.

FIG. 65 shows a partial sectional view of a torque transmitting member mated with a transmission belt, where between their teeth, gaps exist.

### REFERENCE NUMERALS IN DRAWINGS

The labeling of parts described in U.S. Pat. No. 6,656,070 has been changed in this application. Also here the letter M in a label, stands for member. This label is used to label different members of a part that is given one number but consist of more than one member. And the letter S in a label, stands for shape. This label is used to label the different shapes of a part. Same parts that are used in different location might have a different label, such as a change in the letter subsequent to the labeling number, or a different number altogether if this helpful in describing the invention. However, if two parts have the same number then they are identical parts, regardless of the letter following their number, except that additional shapes, which are labeled accordingly, might be added to it.
1 torque transmitting member 1
2 torque transmitting member 2
3 transmission belt
4 non-torque transmitting arc A
5 non-torque transmitting arc B
6 transmission belt tooth
7 transmitting member tooth
10 shaft SH0
11 input shaft SH1
12 output shaft SH2
13 input shaft SH3
14 output shaft SH4
15 input spline shaft SH5
16 output shaft SH6
17 input spline shaft SH7
18 output shaft SH8
19 shaft SH9
21A cone assembly CS1A
21A-M1 torque transmitting member CS1A-M1
21A-M2 torque transmitting member CS1A-M2
21A-M3 cone CS1A-M3
21B cone assembly CS1B
21B-M1 torque transmitting member CS1B-M1
21B-M2 torque transmitting member CS1B-M2
21B-M3 cone CS1B-M3
22A cone assembly CS2A
22A-M1 torque transmitting member CS2A-M1
22A-M1-S1 attachment pin CS2A-M1-S1
22A-M2 torque transmitting member CS2A-M2
22A-M2-S1 attachment pin CS2A-M2-S1
22A-M4 telescope CS2A-M4
22A-M5 telescope CS2A-M5
22A-M5-S1 telescope constrainer clevis CS2A-M5
22A-M6 mover sleeve CS2A-M6
22B cone assembly CS2B
22B-M1 torque transmitting member CS2A-M1
22B-M1-S1 attachment pin CS2B-M1-S1
22B-M2 torque transmitting member CS2B-M2
22B-M2-S1 attachment pin CS2B-M2-S1
22B-M4 telescope CS2B-M4
22B-M5 telescope CS2B-M5
22C cone assembly CS2C
22C-M2 torque transmitting member CS2C-M2
22C-M6 mover sleeve CS2A-M6
22D cone assembly CS2D
22D-M2 torque transmitting member CS2D-M2
22D-M6 mover sleeve CS2A-M6
22B-M6 mover sleeve CS2B-M6
23 cone assembly CS3
23A cone assembly CS3A
23A-M1 torque transmitting member CS3A-M1
23A-M2 non-torque transmitting member CS3A-M2
23A-M3 cone CS3A-M3
23B cone assembly CS3B
23B-M1 torque transmitting member CS3B-M1
23B-M2 non-torque transmitting member CS3B-M2
23B-M3 cone CS3B-M3
23C cone assembly CS3C
23C-M1 torque transmitting member CS3C-M1
23C-M2 non-torque transmitting member CS3C-M2
23C-M3 cone CS3C-M3
23D cone assembly CS3D
23D-M1 torque transmitting member CS3D-M1
23D-M2 non-torque transmitting member CS3D-M2
23D-M3 cone CS3D-M3
24 cone assembly CS4
24-M1 torque transmitting member CS4-M1
24A cone assembly CS4A
24A-M1 torque transmitting member CS4A-M1
24B cone assembly CS4B
24B-M1 torque transmitting member CS4A-M1
24B-M6 mover sleeve CS4B-M6
24C cone assembly CS4C
24C-M1 torque transmitting member CS4C-M1
24D cone assembly CS4D
24D-M1 torque transmitting member CS4D-M1
25 cone assembly CS5
25-S1 cone slider
25-M1 rotor
25-M2 cone slider nut
26 cone assembly CS6
26-M1 mover slide
26-M2 mover slide collar
26-M3 torque transmitting member CS6-M3
26-M3-S1 slider attachment
26-M3-S2 transmitting member threaded extension
26-M4 cone CS6-M4
26-M5 transmitting member clamp
26-M6 transmitting member locking-ring
26-M7 transmitting member slider
26-M7-S1 slider locking-ring gap
31A transmission belt BL1A
31B transmission belt BL1B
32 transmission belt BL2
32A transmission belt BL2A
32B transmission belt BL2B
32C transmission belt BL2C
32D transmission belt BL2D
41 transmission pulley PU1
41A transmission pulley PU1A 41A
41B transmission pulley PU1B 41B
41C transmission pulley PU1C 41C
41D transmission pulley PU1B 41D
42A transmission pulley PU2A 42A
42B transmission pulley PU2A 42B
51A spline sleeve SP1A
51B spline sleeve SP1B
61 tensioning wheel TW1
61A tensioning wheel TW1A
61B tensioning wheel TW1B
61C tensioning wheel TW1C
61D tensioning wheel TW1D
61E tensioning wheel TW1E
61F tensioning wheel TW1F
62 load cell wheel
70 load cell lower slider
71 load cell upper slider
72 vertical guide
101A transition flexing adjuster AD1A
101A-ML adjuster body AD1A-M1
101A-M2 adjuster output member AD1A-M2
101A-M2-S1 adjuster output shaft AD1A-M2-S1
101A-M2-S2 adjuster extension arm ADA1A-M2-S2
101A-M2-S3 adjuster balancing arm AD1A-M2-S3
101A-M2-S4 telescope attachment plates ADA1A-M2-S4
101B transition flexing adjuster AD1B
101B-M1 adjuster body AD-1B-M1
101B-M2 adjuster output member AD1B-M2
102A mover adjuster AD2A
102A-M1 adjuster body AD2A-M1
102A-M2 adjuster output member AD1A-M2
102A-M1-S1 adjuster attachment ring AD2A-M1-S1
102B mover adjuster AD2B
102B-M1 adjuster body AD2B-M1
102B-M2 adjuster output member AD1B-M2
103 adjuster AD3
103-M1 adjuster body AD3-M1
103-M2 adjuster output member AD3-M2
104 adjuster AD4
105 adjuster AD5
105-M1 adjuster body AD5-M1
105-M2 adjuster output member AD5-M2
111A constrainer mechanism CN1A
111A-M1 constrainer slide
111A-M2 constrainer slider
111A-M2-S1 constrainer slider clevis
111A-M3 constrainer link
111A-M4 constrainer pins
111B constrainer mechanism CN1B
121 computer CP1
122 computer CP2
131A transmission ratio sensor SN1A
131B transmission ratio sensor SN1B
132 rotational position sensor SN2
132A rotational position sensor SN2A
132B rotational position sensor SN2B
132C rotational position sensor SN2C
132D rotational position sensor SN2D
132E rotational position sensor SN2E7676ort98
133 relative rotational position sensor
133A relative rotational position sensor SN3A
133B relative rotational position sensor SN3B
134C torque sensor SN4C
134D torque sensor SN4D
135 load cell
141A brush BR1A
141B brush BR1A
151A electrical ring RN1A
151A-S1 insulated fins RN1A-S1
151B electrical ring RN1B
151B-S1 insulated fins RN1B-S1
160 electrical adjuster
160-M1 adjuster motor
160-M2 worm gear
160-M3 adjuster gear
160-M3-S1 spur gear
160-M3-S2 adjuster gear extension
160-M3-S3 adjuster gear flange
160-M4 attachment sleeve
160-M4-S1 attachment sleeve arm 1
160-M4-S2 attachment sleeve arm 2
160-M4-S3 attachment sleeve fins
160-M4-S4 attachment sleeve flange
160-M4-S5 attachment sleeve extension 160-M5 electrical adjuster set-screw
160-M6 electrical rings
160-M7 adjuster motor holder
160-M8 counter-weight
160-M9 electrical cable
160-M10 electrical adjuster nut
171 spring-loaded adjuster AS1
171-M1 spring-loaded adjuster body
171-M2 spring-loaded adjuster shaft
171-M2-S1 spring-loaded adjuster flange
171-M3 adjuster spring
171-M4 shaft end attachment
171-M4-S1 shaft end attachment extension arm
171-M4-S2 shaft end attachment balancing arm
171-M4-S3 shaft end attachment mounting plate
171-M5 spring-loaded adjuster cap
172 spring-loaded adjuster AS2
172-M1 limiter rod
172-M2 limiter notch
181 mechanical adjuster AM1
181-M1 cam
181-M1-S1 top cam shape
181-M1-S2 right cam shape
181-M1-S3 bottom cam shape
181-M1-S4 left cam shape
181-M2 cam sleeve
181-M2-S2 cam sleeve attachment sleeve
181-M2-S3 cam sleeve constrainer sleeve
181-2-S4 cam sleeve counter-weight
181-M2-S5 controller rod counter-weight arm
181-M2-S6 counter-weight arm counter-weight
181-M3 cam sleeve set-screw
181-M4 follower
181-M4-S1 follower top
181-M4-S2 follower round
181-M4-S3 follower shoulder
181-M4-S4 follower bottom
181-M5 follower spring
181-M6 link AM1-M6
181-M6-S1 link shape AM1-M6-S1
181-M6-S2 link shape AM1-M6-S2
181-M7 link AM1-M7
181-M8 output disk
181-M8-S1 output disk arm
181-M8-S2 output disk counter-weight
181-M9 link bolt
181-M10 controller rod
181-M10-S1 pivot shape
181-M10-S2 parallel shape
181-M11 controller rod counter-weight
181-M12 link nut
181-M13 controller rod slider
181-M14 controller rod disk
181-M15 controller rod disk shaft
181-M16 cam adjuster gear rack
181-M17 gear rack shaft
181-M18 cam adjuster gear
182 mechanical adjuster AM2
182-M1 adjuster slider plate
182-M2 cam adjuster extension arm
182-M3 cam adjuster balancing arm
182-M4 adjuster slider plate back tube
182-M5 cam adjuster slider
182-M6 adjuster slider plate front tube
182-M8 output disk AM2-M8
190 rotatable coupling
190-M1 coupling sleeve
190-M2 joiner sleeve
190-M3 joiner sleeve ends
200 guiding wheel
210 input gear
211 differential adjuster input shaft
212 differential
212-S1 differential outer teeth
212A differential A
212B differential B
212B-S2 differential B attachment sleeve
212B-S3A differential B counter-weight
212B-M1 differential B pinion 1
212B-M2 differential B gear 1
212B-M3 differential B pinion 2
212B-M3-S1 differential B pinion 2 shaft
212B-M4 differential B gear 2
212C differential C
212C-S2 differential C attachment sleeve
212C-M3 differential C pinion 2
212C-M3-S1 differential C pinion 2 shaft
212C-S3 differential C counter-weight
212D differential D
212D-S2 differential D attachment sleeve
212D-M3 differential D pinion 2
212D-M3-S1 differential D pinion 2 shaft
212D-S3 differential D counter-weight
213A differential shaft A
213B differential shaft B
213C differential shaft C
213D differential shaft D
213-S1 differential shaft flange
214A adjuster shaft A
214B adjuster shaft B
214-S1 adjuster shaft flange
215 adjuster shaft gear
216 differential shaft gear
217 differential brake
220 index wheel mechanism frame
221 index wheel
222 locking pin
222-S1 locking pin lock
222-S2 locking pin rod
223 locking pin spring
224 solenoid A
224-S1 solenoid A rod
225 solenoid A spring
226 solenoid B
227 small index wheel mechanism gear
228 large index wheel mechanism gear
230 mover frame
230-S1 mover arm
230-M1 mover frame flange plates
230-M2 mover arm bearing
231 mover gear rack
232 input gear sleeve
233 input gear spline
240A differential spline A
240B differential spline B
241 differential spline sleeve
241-M1 differential spline sleeve set-screw
241-M2 differential spline sleeve nut
241-S1 differential spline sleeve pulley mount shape
241-S2 differential spline sleeve bearing mount shape
242 mover frame A
242-S1 mover arm A
242-S2 mover rod
242-M1 mover arm A bearing
243 gear rack A
250 sliding cone spline
251 mover frame B
251-S1 mover arm B
251-S2 mover rod B
251-M1 mover arm B bearing
252 gear rack B
253 tensioning slide A
254 tensioning slide B
255 tensioning slide end A
256 tensioning slide end B
257 tensioning slide connector
258 tensioning slider A
258-S1 tensioning slider A block
258-S2 tensioning slider A clevis
259 tensioning slider B
260 fixed vertical guide
268-M1 left chain link 1 side plate
268-M2 right chain link 1 side plate
268-M3 chain link 1 pin
269-M1 left chain link 2 rubber leg
269-M2 right chain link 2 rubber leg
269-M3 chain link 2 pin
270 link A
270-S1 link A tooth
270-S2 left link A plate
270-S3 right link A plate
270-S4 link A base 270-S4
270-S5 link A attachment plate
271 link rivet
272 link B
273-S1 single link tooth
273-S2 single link base
273-S3 single link attachment plate
274 left link plate
275-S1 chain torque transmitting member tooth
275-S2 chain torque transmitting member base
275-S3 chain torque transmitting member left compensating shape
275-S4 chain torque transmitting member right compensating shape
280A left torque transmitting side member
280B right torque transmitting side member
280 torque transmitting side member
280-S1 side member teeth
280-S2 lateral bending reinforcement
281 side member attachment pin
281-S1 side member attachment plate
282 side member reinforcement
290 single tooth cone
290-S1 single tooth cone smaller end
290-S2 single tooth cone side surface
290-S3 fixed tooth
291-S1 supported single tooth cone smaller end
291-S2 supported single tooth cone side surface
291-S3 supported single tooth cone fixed tooth
291-S4 supported single tooth cone supporting surface
292 inverted belt
293 supported single tooth cone inverted belt
293-S1 tooth constraining surface
294 inverted belt tensioning wheel
295 inverted belt pulley
296 supporting wheel
297 inverted chain link
297-S1 inverted chain pin hole
297-S2 inverted chain tooth cut out profile
300 reinforced transmission belt
300-S1 reinforced transmission belt tooth
301 steel reinforcement plate
302 wire reinforcement

### DESCRIPTION OF INVENTION—PREFERRED EMBODIMENTS

In this section, first the preferred embodiments of adjuster systems for CVT 1 and CVT 2 of U.S. Pat. No. 6,656,070 will be described. Then, an electrical adjuster that can be used in an adjuster system is described.

The purpose of this invention is to introduce adjuster systems, hence specific details concerning the CVTs that can benefit from them, such as the method of attaching a torque transmitting member to a cone assembly, and the method of changing the axial position of the torque transmitting members, are not described in this section. These details are described in U.S. Pat. No. 6,656,070.

Also in case no specific method of fixing one part to another is described, then the method of gluing one part to another can be used. Although more sophisticated methods might be preferable, having to explain these methods would complicate the description of the invention without helping in describing the essence of the invention. Also in case no specific method for keying a part is provided than set-screws that screw completely or partially through the part to be keyed and the shaft on which it is keyed on can be used.

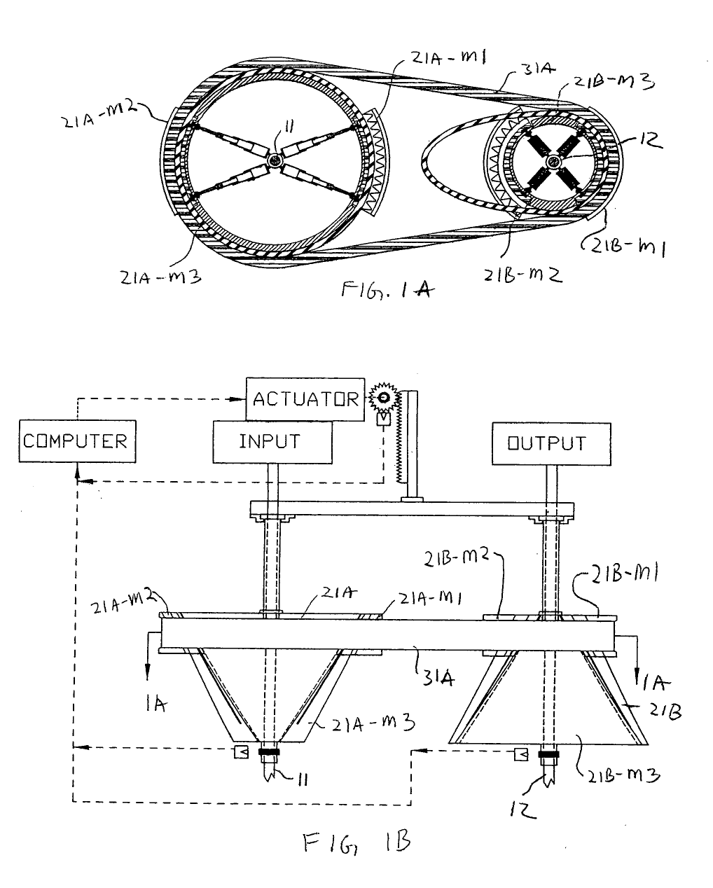

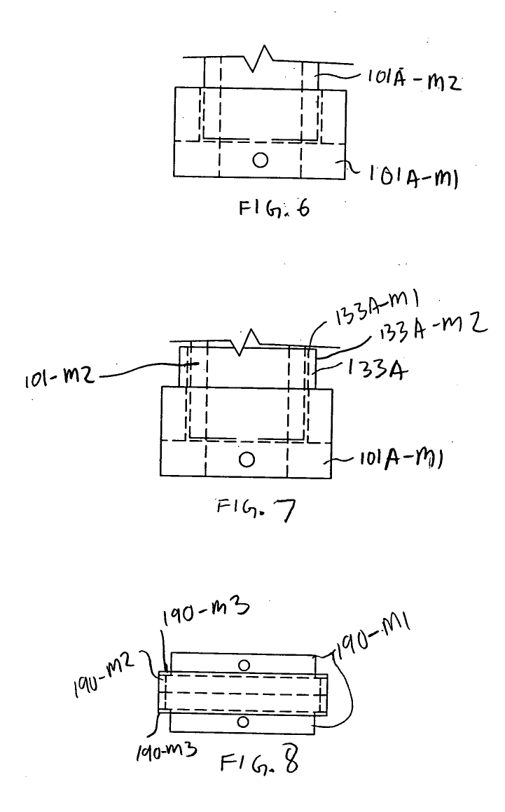

Adjuster System for CVT 1 (FIGS. 1A, 1B, 2 to 10, 11A to 11D, 12A to 12C)

Here the CVT 1 to which an adjuster system is added is labeled as CVT 1.1. CVT 1.1 is almost identical to CVT 1 of U.S. Pat. No. 6,656,070, shown in FIGS. 1A & 1B. CVT 1 mainly consist of a cone assembly CS1A 21A and a cone assembly CS1B 21B, which are identical and each have two opposite positioned torque transmitting members which are rotatably constrained but are allowed to slide axially relative to the surface of their cone assembly. The torque transmitting members of cone assembly CS1A 21A are labeled as torque transmitting member CS1A-M1 21A-M1 and torque transmitting member CS1A-M2 21A-M2, while the cone of cone assembly 21A is labeled as cone CS1A-M3 21A-M3. And the torque transmitting members of cone assembly CS1B 21B are labeled as torque transmitting member CS1B-M1 21B-M1 and torque transmitting member CS1B-M2 21B-M2, while the cone of cone assembly 21B is labeled as cone CS1B-M3 21B-M3. The cone assembly CS21A 21A is keyed to the input shaft SH1 11, and the cone assembly CS1B 21B is keyed to the output shaft SH2 12. In order to transmit torque from the input shaft SH1 111 to the output shaft SH2 12, the torque transmitting members of cone assembly CS1A 21A are coupled with the torque transmitting members of cone assembly CS1B 21B by transmission belt BL1A 31A. The transmission ratio is changed, by changing the axial position of the torque transmitting members. And in order to change the axial position of the torque transmitting members, each cone assembly has a mover sleeve, which can slide axially relative to its shaft. And each torque transmitting member is connected to a mover sleeve by two telescopes, so that the axial position of the torque transmitting members depend on the axial position of the mover sleeves. Detailed description of the mover sleeves and the telescopes can be found in U.S. Pat. No. 6,656,070.

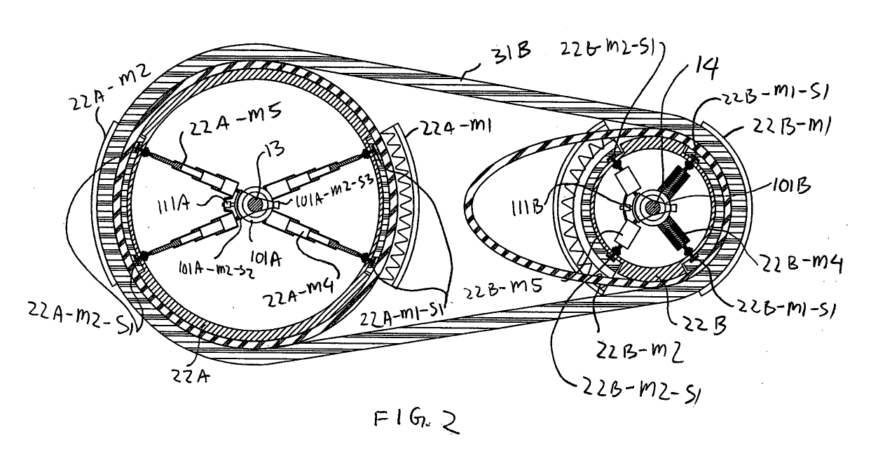

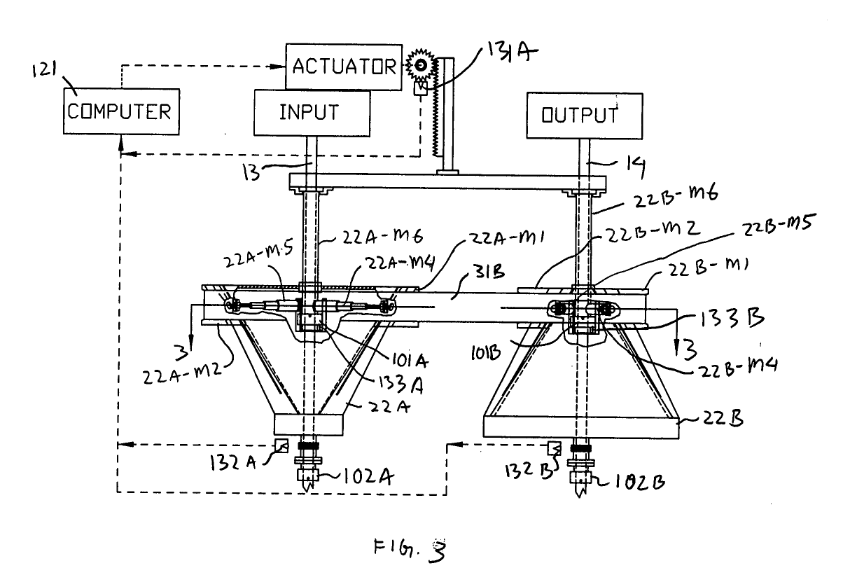

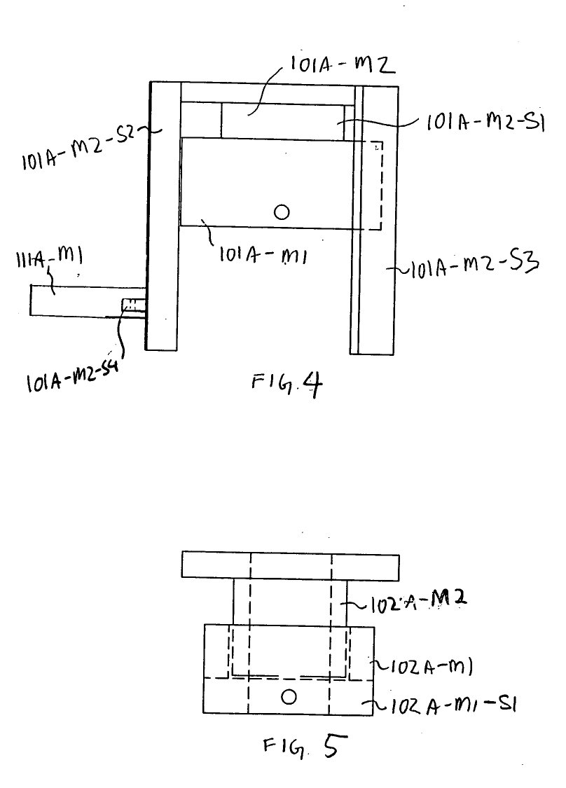

The transmission ratio can only be changed when for both cone assemblies only one torque transmitting member is in contact with transmission belt BL1A 31A. Otherwise stalling of the transmission ratio changing actuator occurs. The configuration where the transmission ratio can be changed is referred to as a moveable configuration. Also as described earlier, here transition flexing is not eliminated. CVT 1.1, which is shown in FIG. 2 and FIG. 3, is slightly different than CVT 1. For CVT 1.1, like for CVT 1, a cone assembly with two transmitting members is coupled by a transmission belt, which here is labeled as transmission belt BL1B 31B to another cone assembly with two torque transmitting members. However, for CVT 1.1, in order to eliminate or significantly reduce transition flexing, a transition flexing adjuster AD1A 101A is added to a slightly modified version of cone assembly CS1A 21A, which is labeled as cone assembly CS2A 22A, and a transition flexing adjuster AD1B 101B is added to a slightly modified version of cone assembly CS1B, which is labeled as cone assembly CS2B 22B. Also here the input shaft is labeled as input shaft SH3 13 and the output shaft is labeled as output shaft SH4 14. As can be seen from the labeling, here cone assembly CS2A 22A is identical to cone assembly CS2B 22B. Transition flexing adjuster AD1A 101A, which is shown in detail in FIGS. 4, 6, and 7, has an adjuster body AD1A-M1 101A-M1 and an adjuster output member AD1A-M2 101A-M2. Transition flexing adjuster AD1B 10B is identical to transition flexing adjuster AD1A 101A. The adjuster body AD1A-M1 101A-M1 of transition flexing adjuster AD1A 101A is fixed to the end of a mover sleeve CS2A-M6 22A-M6, where the two telescopes CS2A-M4 22A-M4 of torque transmitting member CS2A-M1 22A-M1 are attached. And the adjuster output member AD1A-M2 of transition flexing adjuster AD1A is used to mount the two telescopes CS2A-M5 22A-M5 of torque transmitting member CS2A-M2 22A-M2. A constraining mechanism CN1A 111A, which will be described in detail later, is used such that the adjuster output member AD1A-M2 101A-M2 of transition flexing adjuster AD1A 101A can be used to adjust the rotational position of torque transmitting member CS2A-M2 22A-M2. And the adjuster body AD1B-M1 101B-M1 of transition flexing adjuster AD1B 101B is fixed to the end of the mover sleeve CS2B-M6 22B-M6, where the telescopes CS2B-M4 22B-M4 of torque transmitting member CS2B-M1 22B-M1 are attached. And the adjuster output member AD1B-M2 101B-M2 of transition flexing adjuster AD1B 101B is used to mount the telescopes CS22B-M5 22B-M5 of torque transmitting member CS2B-M2 22B-M2. And a constraining mechanism CN1B 111B, is used such that the adjuster output member AD1B-M2 101B-M2 of transition flexing adjuster AD1B 101B can be used to adjust the rotational position of torque transmitting member CS2B-M2 22B-M2. Since cone assembly CS2B 22B is identical to cone assembly CS2A 22A, except that is mounted on the output shaft SH4 14 instead on the input shaft SH3 13, the only difference between constraining mechanism CN1B 111B and constraining mechanism CN1A 111A is that is mounted on cone assembly CS2B 22B instead of cone assembly CS2A 22A.

And in order to substantially increase the duration at which the transmission ratio can be changed, a mover adjuster AD2A 102A and a mover adjuster AD2B 102B, which are basically identical to the transition flexing adjuster 101A are used. Mover adjuster AD2A 102A, which is shown in FIG. 5, has an adjuster body AD2A-M1 102A-M1 and an adjuster output member AD2A-M2 102A-M2. And mover adjuster AD2B 102B, which is identical to mover adjuster AD2A 102A, has an adjuster body AD2B-M1 102B-M1 and an adjuster output member AD2B-M2 102B-M2.

The adjuster body AD2A-M1 102A-M1 of mover adjuster AD2A 102A is keyed to the input shaft SH3 13, and cone assembly CS2A 22A is fixed to the adjuster output member AD2A-M2 102A-M2 of mover adjuster AD2A 102A, see FIG. 3. And the body of mover adjuster AD2B 102B is keyed to the output shaft SH4 14, and cone assembly CS2B 22B is fixed to the output member AD2B-M2 of mover adjuster AD2B 102B.

In order to properly control the transition flexing adjusters AD1A and AD1B and the mover adjusters AD2A and AD2B, a computer CP1 121, which controls these adjusters based on the input of a transmission ratio sensor SN1A 131A, a rotational position sensors SN2A 132A, a rotational position sensor SN2B 132B, a relative rotational position sensor SN3A 133A, which shown in detail in FIG. 7, and a relative rotational position sensor SN3B 133B, is used. If more practical, the relative rotational position sensors can be replaced with rotational position sensors that monitor the rotational positions of the adjuster output members of the transition flexing adjusters. The transmission ratio sensor SN1A 131A is mounted on a frame so that it can be used to monitor the rotation of the transmission ratio gear rack gear via a sensor strip that is wrapped around the transmission ratio gear rack gear, so that computer CP1 121 can determine the transmission ratio, and hence the axial position of the torque transmitting members relative to the cones on which they are attached. And from that information computer CP1 121 can determine the pitch diameter, which as described earlier is the diameter of the surfaces of the cones where the torque transmitting members are positioned. A detailed description on how the transmission ratio gear rack and the transmission ratio gear rack gear are used to change the transmission ratio can be found in U.S. Pat. No. 6,656,070. The rotational position sensors SN2A 132A, is mounted on a frame so that it can monitor the rotational position of cone assembly CS2A 22A via a sensor strip wrapped around cone assembly CS2A 22A. The rotational position sensors SN2B 132B, is mounted on a frame so that it can monitor the rotational position of cone assembly CS2B 22B via a sensor strip wrapped around cone assembly CS2B 22B. The relative rotational position sensor SN3A 133A, consist of a sensor inner sleeve SN3A-M1 133A-M1 and a sensor outer sleeve SN3A-M2 133A-M2, were the sensor inner sleeve SN3A-M1 133A-M1 is located inside the sensor outer sleeve SN3A-M2 133A-M2. The sensor inner sleeve SN3A-M1 133A-M1 and the sensor outer sleeve SN3A-M2 133A-M2 can rotate relative to each other. The amount of rotation between the sensor inner sleeve SN3A-M1 133A-M1 and the sensor outer sleeve SN3A-M2 133A-M2 can be monitored by computer CP1 121. The sensor inner sleeve SN3A-M1 133A-M1 is keyed to the adjuster output member AD1A-M2 101A-M2 of transition flexing adjuster AD1A 101A, and the sensor outer sleeve SN3A-M2 is mounted on the adjuster body AD1A-M2 of transition flexing adjuster AD1A 101A. Hence using the relative rotational position sensor SN3A, the computer CP1 121 can determine the rotational position of the adjuster output member AD1A-M2 relative to the rotational position of the adjuster body AD1A-M1. And hence the rotational position of torque transmitting member CS2A-M2 22A-M2 relative to torque transmitting member CS2A-M1 22A-M1. And in order to monitor the rotational position of torque transmitting member CS2B-M2 22B-M2 relative torque transmitting member CS2B-M1 22B-M1, a sensor SN3B 133B is mounted on the transition flexing adjuster AD1B 101B in the same manner as sensor SN3A 133A is mounted on transition flexing adjuster AD1A 101A. Hence by using the sensors above computer CP1 121, can determine the axial position of the torque transmitting members relative to the cones on which they are attached, and hence the pitch diameter; and the rotational positions of the torque transmitting members.

In order to connect the transmission ratio sensor SN1A 131A, the rotational position sensor SN2A 132A, and the rotational position sensor SN2B 132B to computer CP1 121, simple wire connections are used. Also since transition flexing adjusters AD1A 101A, transition flexing adjuster AD1B 101B, mover adjuster AD2A 102A, mover adjuster AD2B 102B, relative rotational position sensor SN3A 133A, and relative rotational position sensor.

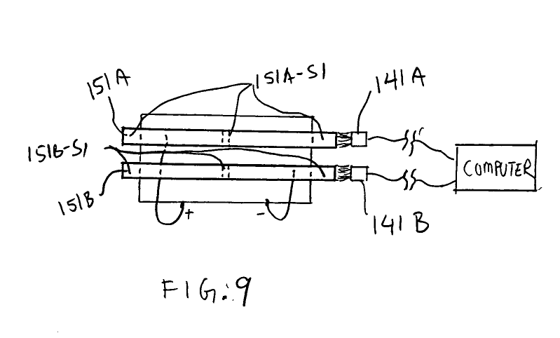

SN3B 133B are rotating relative to computer CP1 121, in order to connect these transition flexing adjusters, mover adjusters and, relative rotational position sensors to the computer CP1 121, a ring and brush connection, is used. An example of a ring and brush connection is shown in FIG. 9. Here two output connections of computer CP1 121, one positive and one negative, are directed to two pair of brushes, labeled as brush BR1A 141A and brush BR1B 141B, by cables. Brush BR1A 141A is in contact with the positive electrical ring RN1A 151A. And brush BR1B 141B is in contact with the negative electrical ring RN1B 151B. The electrical rings are attached to the body of the adjuster by insulated fins RN1A-S1 151A-S1 and insulated fins RN1B-S1 151B-S1. And cables are used to direct the current or signal from the electrical rings to the electrical poles of the adjuster.

A configuration for the transition flexing adjuster AD1A 101A, which has an adjuster body AD1A-M1 101A-M1 and an adjuster output member AD1A-M2 101A-M2, is shown in FIG. 4. Here the adjuster output member AD1A-M2 101A-M2 can rotate relative to the adjuster body AD1A-M1 101A-M1, which is mounted at the end of the mover sleeve CS2A-M6 22A-M6, see FIG. 3. The mover sleeve CS2A-M6 22A-M6 is almost identical to the mover sleeve used in CVT 1, hence it can also slide axially relative to its cone and is used to change the axial position of its torque transmitting members. The adjuster body AD1A-M1 101A-M1 is fixed to the mover sleeve CS2A-M6 22A-M6, but the adjuster output member AD1A-M1 101A-M1 can rotate relative to the mover sleeve CS2A-M6. The telescopes CS2A-M4 22A-M4, described in detail in U.S. Pat. No. 6,656,070, of torque transmitting member CS2A-M1 22A-M1 are attached to the mover sleeve CS2A-M6, and the telescopes CS2A-M5 22A-M5 of torque transmitting member CS2A-M2 22A-M2 are attached to the adjuster output member AD1A-M2 101A-M2. Here the adjuster output member AD1A-M2 101A-M2, see FIG. 4, has the following shapes, it has an adjuster output shaft AD1A-M2-S1 101A-M2-S1, on which an adjuster extension arm AD1A-M2-S2 101A-M2-S2 is attached. The adjuster extension arm AD1A-M2-S2 101A-M2-S2 has an L-shape. The short leg of the L-shaped adjuster extension arm AD1A-M2-S2 101A-M2-S2 is extending radially outwards from the center of the front surface of the adjuster output shaft AD1A-M2-S1 101A-M2-S1. The long leg of the L-shaped adjuster extension arm AD1A-M2-S2 101A-M2-S2 is parallel to the adjuster output shaft AD1A-M2-S1 101A-M2-S1 and is extending axially backwards so that the telescopes CS2A-M5 22A-M5 of torque transmitting member CS2A-M2 22A-M2 can be attached at the same axial position as the telescopes CS2A-M4 22A-M4 of torque transmitting member CS2A-M1 22A-M1. This leg has two telescopes attachment plates AD1A-M2-S4 101A-M2-S4, which are used to attach the telescopes CS2A-M5 22A-M5 to this leg, in the same manner the telescope attachments plates on the mover sleeve are used to attach telescopes to it, as described in detail in U.S. Pat. No. 6,656,070. In addition, a constrainer slide 11A-M1 is also attached to this leg. Furthermore, in order to balance the centrifugal forces of the adjuster extension arm AD1A-M2-S2 101A-M2-S2 and its attachments, an adjuster balancing arm AD1A-M2-S3 101A-M2-S3, which also has an L-shape, is positioned opposite from the adjuster extension arm AD1A-M2-S2 101A-M2-S2 on the front surface of the adjuster output shaft adjuster AD1A-M2-S1 101A-M2-S1.

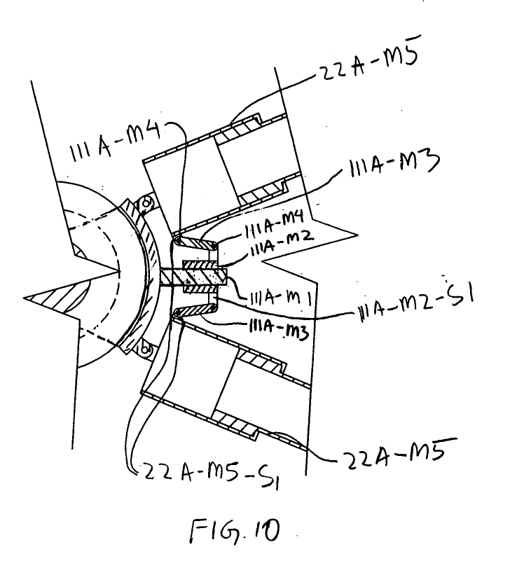

Furthermore in order to ensure that the adjuster output member AD1A-M2 101A-M2 can be used to control the rotational position of torque transmitting member CS2A-M2, a constrainer mechanism CN1A 111A, shown in FIG. 10, is attached to the long leg of the L-shaped adjuster extension arm AD1A-M2-S2 101A-M2-S2. The constrainer mechanism consist of a constrainer slide 111A-M1, that is placed between the telescopes attachment plates of the long leg of the L-shaped adjuster extension arm AD1A-M2-S2 101A-M2-S2; a constrainer slider 111A-M2, that is slideably inserted into the constrainer slide 11A-M1; and two constrainer links 111A-M3, each connecting the bottom member of telescope CS2A-M5 22A-M5 to the constrainer slider 111A-M2. The constrainer slide 111A-M1 is shaped like slender round rod, on which the constrainer slider 111A-M2 is slideably inserted. The constrainer slider 111A-M2 is shaped like a sleeve, which has two identical slider clevises 111A-M2-S1 which are positioned opposite of each other. Each slider clevis of the constrainer slider consist of two parallel slider clevis plates, which are flat plates, which flat surfaces are perpendicular to the side surface of the constrainer slider. Each slider clevis plate has a hole and the outer edge of each slider clevis plate is rounded-off. Each constrainer link 111A-M3 is shaped like slender flat bar that has a constrainer link hole, which is a hole that is slightly larger than the holes of the slider clevis plates, at each end. The end of each constrainer link is rounded-off so that a half disk shape, which diameter is identical to the width of the constrainer link and which center is located at the center of the constrainer link hole, exist at each end of the constrainer link. Furthermore, the bottom member of each telescopes CS2A-M5 22A-M5 also has a telescope constrainer clevis CS2A-M5-S1 22A-M5-S1. The position of the telescope constrainer clevis on the bottom member of one telescope CS2A-M5 22A-M5 is identical to that of the other telescope CS2A-M5 22A-M5. Each telescope constrainer clevis consists of two parallel telescope constrainer clevis plates. The telescope constrainer clevis plates are flat plates, which flat surfaces are perpendicular to the side surfaces of their telescopes. Each telescope constrainer clevis plate has a hole, which is slightly smaller than the constrainer link holes, and the outer edge of each telescope constrainer clevis plate is rounded-off. In order to connect the bottom members of the telescopes CS2A-M5 22A-M5 to the constrainer slider 111A-M2, constrainer pins 111A-M4 are used. The constrainer pins 111A-M4 are shaped like slender round rods. Here one constrainer link hole of each constrainer link 111A-M3 is placed between the slider clevis plates of a slider clevis 111A-M2-S1, such that a constrainer pin CN1A-M4 111A-M4 can be inserted through the constrainer link holes and those slider clevis holes. The body of a constrainer pin 111A-M4 has a diameter small enough such that a constrainer link 111A-M3 can freely rotate on it, but large enough such that a constrainer pin CN1A-M4 111A-M4 can be securely held in place relative to its slider clevis 111A-M2-S1 by friction between the slider clevis hole surfaces and the body of the constrainer pin 111A-M4. Also, the constrainer pins 111A-M4 are long enough such that sufficient engagement between the constrainer pins 111A-M4 an a set of slider clevis plates of a slider clevis 111A-M2-S1 can exist.

And the other constrainer link hole of each constrainer link 111A-M2-S1 is placed between a set of telescope constrainer clevis plates of a telescope constrainer clevis CS2A-M5-S1 22A-M5-S1, such that a constrainer pin 111A-M4 can be inserted through the constrainer link holes and the telescope constrainer clevis plate holes. Here the diameters of the constrainer pins are small enough such that the constrainer links can freely rotate on them, but large enough such that they can be securely held in place relative to their telescope constrainer clevis plates by friction between their side surfaces and the telescope constrainer clevis hole surfaces. In addition, the constrainer pins are long enough such that sufficient engagement between the constrainer pins and a set of telescope constrainer clevis plates can exist.

In addition, while the slots of the cone of cone assembly CS2A where the attachment pins CS2A-M1-S1 22A-M1-S1, used to attach torque transmitting member CS2A-M1 22A-M1 to a cone assembly CS2A 22A, are inserted, should allow minimal rotational movements between torque transmitting member CS2A-M1 22A-M1 and its cone, the slots where the attachment pins CS2A-M2-S1 22A-M2-S1 of torque transmitting members CS2A-M2 22A-M2 are inserted should allow sufficient rotational movement between the torque transmitting member CS2A-M2 22A-M2 and its cone such that transition flexing can be eliminated. Hence here, the attachment pins of torque transmitting member CS2A-M2 22A-M2 are placed in a gap. In this application, a torque transmitting member which attachment pins are placed in a gap will be referred to as a gap mounted torque transmitting member.

From the description above it can be observed that the torque transmitting member CS2A-M1 22A-M1 is rotatably constrained relative to mover sleeve CS2A-M6 22A-M6, and torque transmitting member CS2A-M2 22A-M2 is rotatably constrained relative to the adjuster output member AD1A-M2 101A-M2, and since the adjuster output member AD1A-M2 101A-M2 can rotate relative to the mover sleeve CS2A-M6 22A-M6, the transition flexing adjuster AD1A 101A can be used by computer CP1 121 to adjust the rotational position of the torque transmitting member CS2A-M2 22A-M2 relative to torque transmitting member CS2A-M1 22A-M1. As described earlier, like CVT 1, CVT 1.1 has two identical cone assemblies, one on the input shaft SH3 13, which is labeled as cone assembly CS2A 22A, and another one on the output shaft SH4 14, which is labeled as cone assembly CS2B 22B. Hence here, the transition flexing adjuster AD1B is identical to transition flexing adjuster AD1A, and is mounted on cone assembly CS2B 22B in the same manner as transition flexing adjuster AD1A is mounted on cone assembly CS2A 22A.

Next the mover adjusters AD2A and AD2B, which will be used to substantially increase the duration at which the transmission ratio can be changed, are described. In order to substantially increase the duration at which the transmission ratio can be changed, the mover adjusters will be used to try maintain CVT 1.1 in a moveable configuration, as shown in FIG. 2 and described in detail in U.S. Pat. No. 6,656,070, regardless of the rotational position of the input shaft SH3 13 and the output shaft SH4 14. This is achieved by allowing the cone assemblies to slip relative to their shaft so that they are maintained in a moveable configuration. Here movable adjuster AD2A is used to allow cone assembly CS2A 22A, positioned on the input shaft SH3 13, to slip relative to the input shaft SH3 13. And movable adjuster AD2B is used to allow cone assembly CS2B 22B, positioned on the output shaft SH4 14, to slip relative to the output shaft SH4 14. In order to achieve this, the adjuster body AD2A-M1 102A-M1 of movable adjuster AD2A is keyed to the input shaft SH3 13 so that it is constrained from rotating and moving axially relative to input shaft SH3 13. And the cone assembly CS2A 22A is fixed to the adjuster output member AD2A-M2 102A-M2 of movable adjuster AD2A 102A so that it is constrained from rotating and moving axially relative the adjuster output member AD2A-M2 102A-M2. In order to mount mover adjuster AD2A 102A to input shaft SH3 13, mover adjuster AD2A 102A has an sliding hole, which center is located at the center-axis of mover adjuster AD2A 102A and goes through the entire axial length of mover adjuster AD2A 102A, except through the adjuster attachment ring AD2A-M1-S1 102A-M1-S1, which has a mounting hole, which is of a smaller diameter. The diameter of the sliding hole of mover adjuster AD2A 102A is considerably larger than the diameter of output shaft SH13 13 so that adjuster output member AD2A-M2 102A-M2 can freely rotate relative to output shaft SH13 13. And in order to mount the adjuster body AD2A-M1 102A-M1 of mover adjuster AD2A 102A to the output shaft SH13 13, the adjuster body AD2A-M1 102A-M1 has an adjuster attachment ring AD2A-M1-S1 102A-M1-S1 that extends axially backwards from the adjuster body AD2A-M1. The diameter of the mounting hole of the adjuster attachment ring AD2A-M1-S1 is only slightly larger than the diameter of input shaft SH3 13, so that the adjuster body AD2A-M1 102A-M1 can be securely mounted on input shaft SH3 13. In addition, the adjuster attachment ring AD2A-M1-S1 has a set-screw that is used to prevent the adjuster body AD2A-M1 102A-M1 from moving axially and from rotating relative to input SH3 13. The mover adjuster AD2B 102B is used to mount cone assembly CS2B 22B on output shaft SH4 14 in the same manner as the mover adjuster AD2A 102A is used to mount cone assembly CS2A 22A on input shaft SH3 13. And as described earlier, the rotational position of cone assembly CS2A 22A, which is mounted on the input shaft SH3 13, is monitored by computer CP1 121 via rotational position sensor SN2A 132A. And the rotational position of cone assembly CS2B 22B, which is mounted on the output shaft SH4 14, is monitored by computer CP1 121 via rotational position sensor SN2A 132A.

Now that the physical configuration of CVT 1.1, including its adjuster system, has been described. The operation of transition flexing adjuster AD1A 101A, transition flexing adjuster AD1B 101B, mover adjuster AD2A 102A, and mover adjuster AD2B 102B will described.

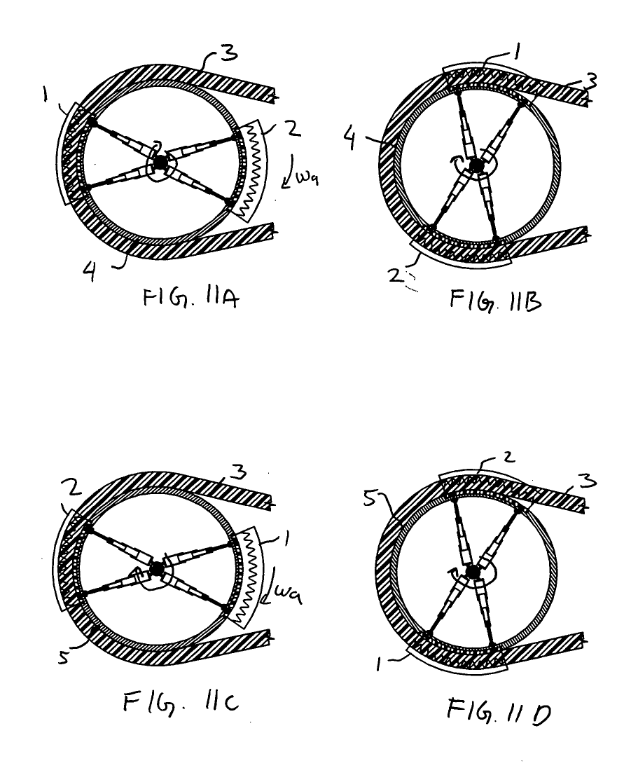

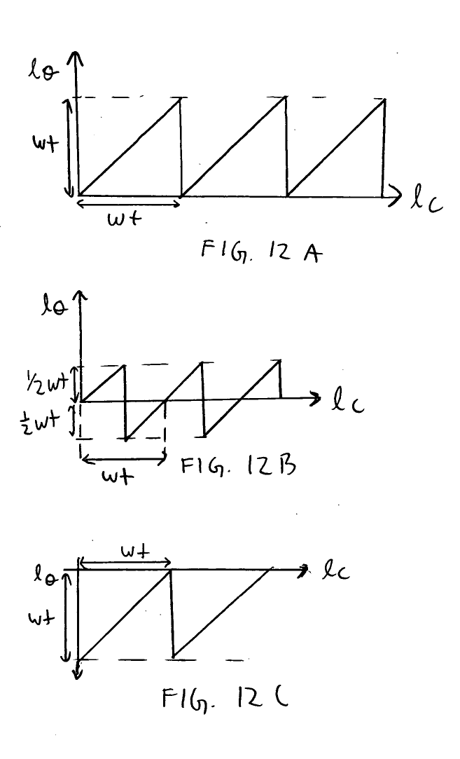

In order to explain the operation of the transition flexing adjusters, first the required relative rotational movements between the torque transmitting members of a cone assembly CS2 22, such as cone assembly CS2A 22A or cone assembly CS2B 22B, in order to eliminate transition flexing will be described. The relative rotational movements that can be used to eliminate transition flexing are shown in FIGS. 11A, 11B, 11C, and 11D, which show the different rotational positions of a cone assembly CS2 22 as it is rotated clockwise. For illustrative purposes, one torque transmitting member is referred to as torque transmitting member 11 and the other torque transmitting member is referred to as torque transmitting member 22. We start with FIG. 11A, here torque transmitting member 11 is in contact with the transmission belt 3 while torque transmitting member 22 is not. Here in order to eliminate transition flexing that will occur when torque transmitting member 22 comes in contact with the transmission belt 3, the lower positioned space between the torque transmitting members, which in this case is non-torque transmitting arc A 4, needs to be a multiple of the width of the teeth of the torque transmitting members. If this is the case then no adjustment for the rotational position of torque transmitting member 22 relative to torque transmitting member 11 is needed. Otherwise a transition flexing adjuster needs to rotate one torque transmitting member clockwise or counter-clockwise relative to the other torque transmitting member such that the non-torque transmitting arc A 4 is a multiple of the width of the teeth of the torque transmitting members. In FIG. 11A, the rotation provided by the transition flexing adjuster is shown as ωa, which is arbitrarily selected as clock-wise. After some rotation of the cone assembly, both torque transmitting member 11 and torque transmitting member 22, as shown in FIG. 1I B, are in contact with the transmission belt 3. During this configuration, the transition flexing adjuster maintains the relative rotational position between the torque transmitting members, such that the non-torque transmitting arc A 4, which in this instance is covered by the transmission belt 3, remains a multiple of the width of the teeth of the torque transmitting members. After some further rotations of the cone assembly, torque transmitting member 11 comes out of contact with the transmission belt 3, as shown in FIG. 11C. Here in order to eliminate transition flexing that will occur when the torque transmitting member 11 comes in contact with transmission belt 3 again, the lower positioned space between the torque transmitting members, which in this case is non-torque transmitting arc B 5, needs to be a multiple of the width of the teeth of the torque transmitting members. If this is the case then no adjustment for the rotational position of torque transmitting member 11 relative to torque transmitting member 22 is needed. Otherwise a transition flexing adjuster needs to rotate one torque transmitting member clockwise or counter-clockwise relative to the other torque transmitting member such that the non-torque transmitting arc B 5 is a multiple of the width of the teeth of the torque transmitting members. In FIG. 11C, the rotation provided by the transition flexing adjuster is also shown as ωa, which in this instance is again arbitrarily selected as clock-wise. After some rotation, both the torque transmitting member 11 and the torque transmitting member 22, as shown in FIG. 11D, are in contact with transmission belt 3. During this configuration, the transition flexing adjuster maintains the relative rotational position between the torque transmitting members, such that the non-torque transmitting arc B 5, which is covered by the transmission belt 3 remains a multiple of the width of the teeth of the torque transmitting members. For clockwise rotation of a cone assembly, as shown in FIG. 11A-11D, the lower positioned non-torque transmitting arc is the critical non-torque transmitting arc, since it is the non-torque transmitting arc that is about to be completely covered by the transmission belt so that it has to be adjusted immediately. However, for counter-clockwise rotation of a cone assembly CS2 22, the upper positioned non-torque transmitting arc is the critical torque transmitting arc, since in this case it is the non-torque transmitting arc that is about to be completely covered by the transmission belt so that it has to be adjusted immediately.

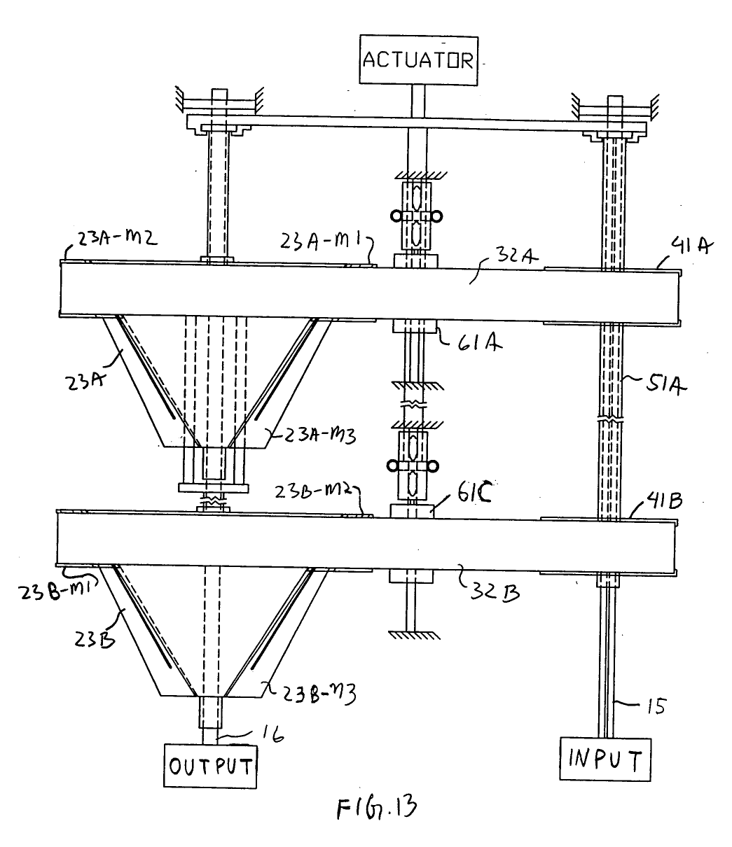

Graphs showing the required relative rotation between the torque transmitting members (l_{θ}) vs. the arc length of the critical non-torque transmitting arc (l_{c}) are shown in FIGS. 12A, 12B, 12C. For these graphs, the y-axis represents the required arc length, l_{θ}, that the torque transmitting member that is about to engage with its belt has to be rotated relative to the torque transmitting member currently engaged. For cases where the cone assemblies are rotated counter-clockwise, a positive value for l_{θ} represents counter-clockwise rotation, and a negative value for theta represents clockwise rotation. And for cases where the cone assemblies are rotated clockwise, a positive value for l_{θ} represents clockwise rotation, and a negative value for theta represents counter-clockwise rotation. And the x-axis represents the arc length of the critical non-torque transmitting arc, l_{c}. Here the width wt corresponds to the width of the teeth of the torque transmitting members.

Now the operation of the mover adjusters in order to substantially increase the duration at which the transmission ratio can be changed will be described. When the transmission ratio is about to be changed, the computer CP1 121 monitors the rotational position of the cone assemblies CS2A 22A and CS2B 22B using the rotational position sensors SN2A 132A and SN2B 132B, and once the cone assemblies are in a moveable configuration, such as shown in FIG. 2, the moveable adjusters AD2A 102A and AD2B 102B allow the cone assemblies to slip relative to their shaft such that they are maintained in a movable configuration. Then the transmission ratio is changed. In cases where the adjusters can not be continuously maintained in a moveable configuration, due to practical or economical reasons for example, then the moveable adjusters can be used to at least substantially increase the duration that the cone assemblies are in a moveable configuration.

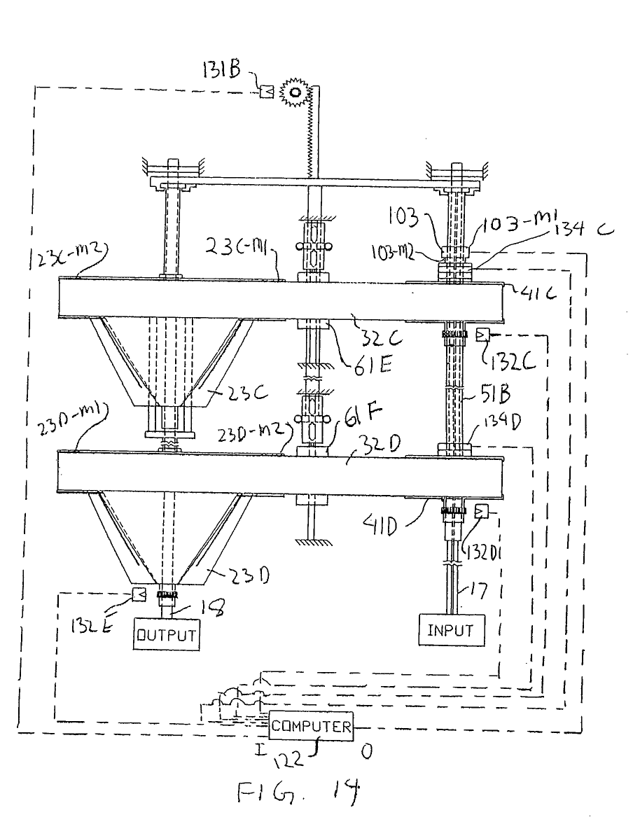

Adjuster System for CVT 2 (FIGS. 13, 14, 15A to 15D, 16, 17A to 17C, 18A, 18B, 19A, 19B, 20A, 20B)

Here a slightly modified version if CVT 2 to which an adjuster system is added is labeled as CVT 2.1. CVT 2.1 is almost identical to CVT 2 of U.S. Pat. No. 6,656,070. CVT 2, which is shown in FIG. 13, consist mainly of two transmission pulleys, transmission pulley PU1A 41A and transmission pulley PU1B 41B, and two cone assemblies which each have a torque transmitting member and a non-torque transmitting member, labeled as cone assembly CS3A 23A and cone assembly CS3B 23B. The torque transmitting member of cone assembly CS3A 23A is labeled as torque transmitting member CS3A-M1 23A-M1; and the torque transmitting member of cone assembly CS3B 23B is labeled as torque transmitting member CS3B-M1 23B-M1. And the non-torque transmitting member of cone assembly CS3A 23A is labeled as non-torque transmitting member CS3A-M2 23A-M2; and the non-torque transmitting member of cone assembly CS3B 23B is labeled as non-torque transmitting member CS3B-M2 23B-M2. Also the cone of cone assembly CS3A is labeled as cone CS3A-M3 23A-M3 and the cone of cone assembly CS3B is labeled as cone CS3B-M3 23B-M3. Each torque transmitting member and each non-torque transmitting member is attached to its cone such that it can slide axially relative to its cone, but is restrained from rotating relative to the its cone. The torque transmitting members are used for torque transmission, and the non-torque transmitting members are mainly used to maintain the axial position of their transmission belt and guide their transmission belt during transmission ratio change. The transmission pulleys PU1A 41A and PU1B 41B are keyed to a spline sleeve SP1A 51A, which is slideably mounted on the input spline shaft SH5 15, and the cone assemblies CS3A 23A and CS3B 23B are keyed to the output shaft SH6 16 in a manner such that the torque transmitting member of one cone assembly is positioned opposite from the torque transmitting member of the other cone assembly. In order to transmit torque from the input spline shaft SH5 15 to the output shaft SH6 16, a transmission belt BL2A 32A is used to couple transmission pulley PU1A 41A with cone assembly CS3A 23A, in a manner such that torque transmitting member CS3A-M1 23A-M1 can properly engage with transmission belt BL2A 32A. And a transmission belt BL2B 32B is used to couple transmission pulley PU1B 41B with cone assembly CS3B 23B, in a manner such that torque transmitting member CS3B-M1 23B-M1 can properly engage with transmission belt BL2B 32B. The transmission ratio is changed by changing the axial position of the torque transmitting members and the transmission pulleys relative to of their cone, in a manner such that for all transmission ratios, the torque transmitting members can properly engage with their transmission pulley. The transmission ratio can only be changed when only one torque transmitting member is in contact with its transmission belt, otherwise stalling of the transmission changing actuator occurs. And in order to maintain the proper tension in the transmission belts and help maintain the proper longitudinal shape of the transmission belts as the transmission ratio is changed, each transmission belt has two tensioning wheels, see U.S. Pat. No. 6,656,070. The tensioning wheels for transmission belt BL2A 32A are labeled as tensioning wheel TW1A 61A and tensioning wheel TW1B 61B. And the tensioning wheels for transmission belt BL2B 32B are labeled as tensioning wheel TW1C 61C and tensioning wheel TW1D 61D. Each tensioning wheel is always in contact with the inner surface of its transmission belt, and is positioned between its cone assembly and its transmission pulley. For each transmission belt, one tensioning wheel is in contact with the slack side of the transmission belt, and the other tensioning wheel is in contact with the tight side of the transmission belt. From the description above, it becomes obvious that CVT 2 allows its transmission belts to flex more in order to compensate for transition flexing than CVT 1, since here the lengths of the transmission belts that can flex always extend from the torque transmitting members to the transmission pulleys, while for CVT 1 in some instances the length that its transmission belt can flex only extend from one torque transmitting member to the other.

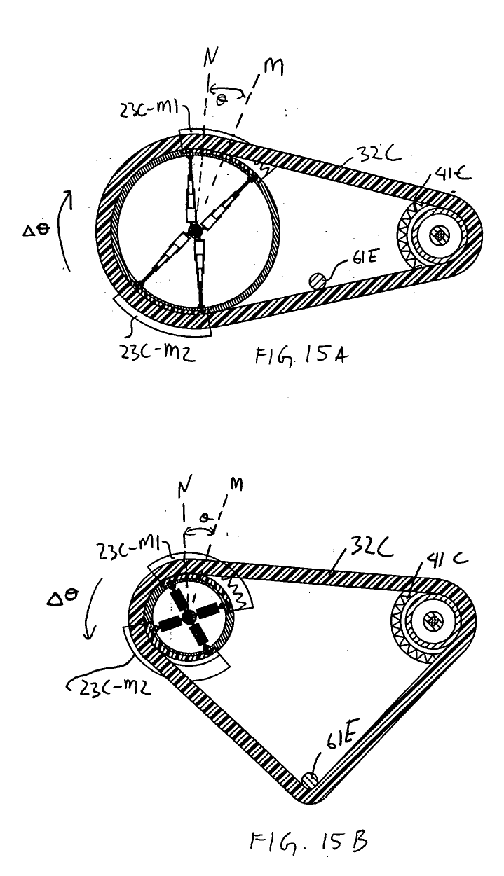

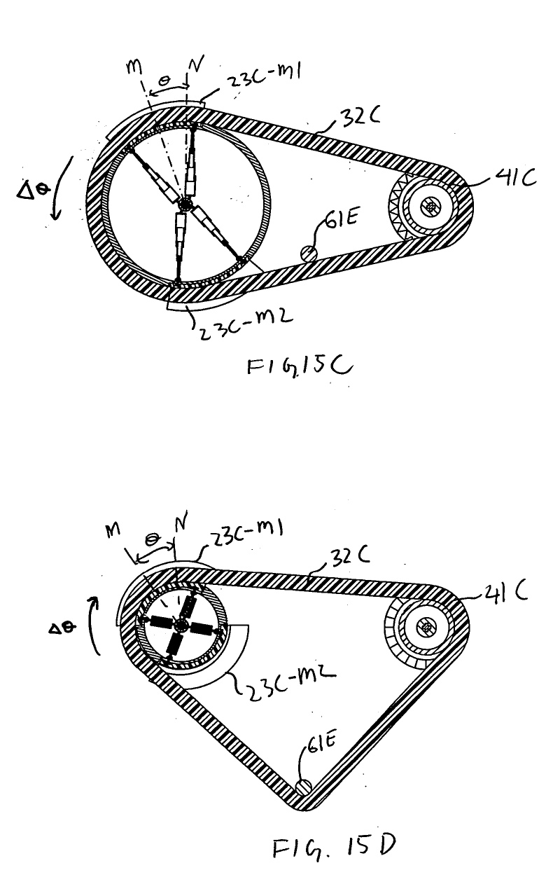

CVT 2.1, see FIGS. 14, 15A, 15B, 15C, and 15D, is slightly different than CVT 2. Like CVT 2, for CVT 2.1 the two transmission pulleys are mounted on the input spline shaft, which here is labeled as input spline shaft SH7 17, by the use of an spline sleeve SP1B 51B. And like CVT 2, each transmission pulley is coupled to a cone assembly with a torque transmitting member and a non-torque transmitting member that are directly mounted on an output shaft, which here is labeled as output shaft SH8 18, by a transmission belt. Here the cone assemblies are labeled as cone assembly CS3C 23C and cone assembly CS3D 23D, and the transmission belts are labeled as transmission belt BL2C 32C and transmission belt BL2D 32D. And the torque transmitting member of cone assembly CS3C 23C is labeled as torque transmitting member CS3C-M1 23C-M1, and the torque transmitting member of cone assembly CS3D 23D is labeled as torque transmitting member CS3D-M1 23D-M1. And the non-torque transmitting member of cone assembly CS3C 23C is labeled as non-torque transmitting member CS3C-M2 23C-M2, and the non-torque transmitting member of cone assembly CS3D 23D is labeled as non-torque transmitting member CS3D-M1 23D-M2. While the cone of cone assembly CS3C is labeled as cone CS3C-M2 23C-M3, and the cone of cone assembly CS3D is labeled as cone CS3D-M3 23D-M3. However unlike CVT 2, for CVT 2.1 for each transmission belt, only one tensioning wheel is used. These tensioning wheels operate and are mounted in the same manner as the tensioning wheels mounted on the slack side of the transmission belts of CVT 2. Here the tensioning wheel for transmission belt BL2C 32C is labeled as tensioning wheel TW1E 61E and the tensioning wheel for transmission belt BL2D 32D is labeled as tensioning wheel TW1E 61F.

Like CVT 2, in order to change the transmission ratio, a transmission ratio changing actuator is used. The strength of the transmission ratio changing actuator should be limited such that under no condition should it be able to cause excessive high stresses in the transmission belts. So that it will stall or slip in instances when it is about to cause excessive high stresses in the transmission belts. But in order to avoid unnecessary stalling or slipping of the transmission ratio changing actuator, it should be strong enough to be able to stretch the transmission belts within an acceptable limit.

Furthermore, for CVT 2.1, in order to eliminate or significantly reduce transition flexing, and substantially increase the duration at which the transmission ratio can be changed, an adjuster AD3 103 is used. Like the adjusters described earlier, adjuster AD3 103 has an adjuster body AD3-M1 103-M1 and an adjuster output member AD3-M2 103-M2, that can rotate relative to the adjuster body AD3-M1 103-M1. The adjuster body AD3-M1 is mounted on spline sleeve 51B using a set-screw so that it is axially and rotatably constrained relative to spline sleeve 5B. And on the adjuster output member AD3-M2 103-M2, the transmission pulley PU1C 41C is fixed via a torque sensor SN4C 134C, so that adjuster output member AD3-M2 103-M2 is virtually axially and rotatably constrained relative to transmission pulley PU1C 41C. And since the adjuster output member AD3-M2 103-M2 can rotate relative to the adjuster body AD3-M1, transmission pulley PU1C 41C can rotate relative to spline sleeve 51B. However, no adjuster is used to mount transmission pulley PU1D 41D to spline sleeve 51B. Here transmission pulley PU1D 41D is mounted to spline sleeve 51B via a torque sensor SN4D 134D, so that transmission pulley PU1D 41D is virtually axially and rotatably constrained relative to spline sleeve 51B.

In order to control adjuster AD3 103, a computer CP2 122, which controls adjuster AD3 103 based on the input from a transmission ratio sensor SN1B 131B, a rotational position sensor SN2C 132C, a rotational position sensor SN2D 132D, a rotational position sensor SN2E 132E, a torque sensor SN4C 134C, and a torque sensor SN4D 134D is used.

The transmission ratio sensor SN1B 131B is mounted on a frame so that it can be used to monitor the rotation of the transmission ratio gear rack gear via a sensor strip wrapped around the transmission ratio gear rack gear, so that computer CP2 122 can determine the transmission ratio, and hence the axial position of the torque transmitting members relative to the cones on which they are attached. And from that information computer CP2 122 can determine the pitch diameter, which as described earlier is the diameter of the surfaces of the cones where the torque transmitting members are positioned. A detailed description on how the transmission ratio gear rack and the transmission ratio gear rack gear are used to change the transmission ratio can be found in U.S. Pat. No. 6,656,070.

The rotational position sensors SN2E 132E, is mounted on a frame so that it can be used to monitor the rotational position of output shaft SH8 18 via a sensor strip wrapped around output shaft SH8 18. And from that information computer CP2 122 can determine the rotational position of the torque transmitting members. The rotational position sensor SN2C 132C, is mounted on a frame so that it can be used to monitor the rotational position of transmission pulley PU1C 41C via a sensor strip wrapped around a portion of transmission pulley PU1C 41C, or the adjuster output member on which transmission pulley PU1C 41C is mounted. And the rotational position sensor SN2D 132D, is mounted on a frame so that it can be used to monitor the rotational position of transmission pulley PU1D 41D via a sensor strip wrapped around transmission pulley PU1D 41D, or the adjuster output member on which transmission pulley PU1C 41C is mounted. Using the rotational position sensor SN2C 132C and SN2D 132D, computer CP2 122 can determine the absolute rotational position of the transmission pulleys and the rotational position of one transmission pulley relative to the other. Also if more advantageous, here a rotational position sensors that monitor the rotational position of the transmission pulleys can be replaced with a relative rotational position sensor that monitors the rotation between the adjuster body and the adjuster output member of adjuster AD3 103, and hence the relative rotational position between the transmission pulleys.

The torque sensors SN4C 134C and SN4B 134D, which each have a body and an output shaft, can measure the torque applied between their body and their output shaft. However unlike an adjuster, no significant rotation between the body and the output shaft of a torque sensor is allowed. Torque sensor SN4A 134C is used to measure the pulling load on transmission pulley PU1C 41C due to the torque at input spline shaft SH7 17 and the rotational resistance provided by cone assembly CS3C 23C. And torque sensor SN4D 134D is used to measure the pulling load on transmission pulley PU1D 41D due to the torque at input spline shaft SH7 17 and the rotational resistance provided by cone assembly CS3D 23D. Here the body of torque sensor SN4C 134C, is fixed to the adjuster output member AD3-M2 103-M2 and the output shaft of torque sensor SN4C 134C is fixed to transmission pulley PU1C 41C; and the body of torque sensor SN4D 134D is keyed to the spline sleeve SP1B 51B, and transmission pulley PU1D 41D is keyed to the output shaft of torque sensor SN4D 134D.

In order to connect the transmission ratio sensor SN1B 131B and the rotational position sensor SN2C 102C to computer CP2 122, simple wire connections are used. And since adjuster AD3 103, torque sensor SN4C 134C, and torque sensor SN4D 134D are rotating relative to computer CP2 122, in order to connect them to computer CP2 122, the ring and brush connection, is used. An example of a ring and brush connection is shown in FIG. 9 and is described earlier.

Now that the physical configuration of CVT 2.1, including its adjuster system has been described, the operation of the adjuster AD3A 103A to eliminate transition flexing and the operation of the adjuster AD3A 103A to substantially increase the duration at which the transmission ratio can be changed will described.

In order to eliminate transition flexing the rotational position between transmission pulley PU1C 41C and transmission pulley PU1D 41D is adjusted by adjuster AD3A 103A. Here the procedure to eliminate transition flexing is similar to the procedure to eliminate transition flexing for CVT 1.1 as shown in FIGS. 11A-11D. However while in FIGS. 11A-11D, the rotational position of torque transmitting member 11 relative to torque transmitting member 22 is adjusted, here the rotational position of transmission pulley PU1D 41D relative to transmission pulley PU1C 41C is adjusted. Here in instances were the pitch diameter, which is the diameter of the cone assemblies were the torque transmitting members are positioned is not a multiple of the width of the teeth of the torque transmitting members, each time a torque transmitting member is about to come into contact with its transmission belt, the position of its transmission belt is adjusted, by adjusting the relative position between the transmission pulleys, so that that torque transmitting member perfectly engages with its transmission belt.

As in CVT 1.1, here the graphs shown in FIGS. 12A, 12B, 12C can be used to determine the amount of adjustment required. Here the required amount of relative rotation between a transmission belt and its torque transmitting member (l_{θ}) vs. the arc length of the critical non-torque transmitting arc (l_{c}), which is the non-torque transmitting arc that is about to be completely covered by a transmission belt are shown in FIGS. 12A, 12B, 12C. For these graphs, the y-axis represents the required arc length, l_{θ}, that a transmission belt has to be rotated relative to its cone assembly. Here for cases where the cone assemblies are rotated counter-clockwise, a positive value for l_{θ} represents clockwise rotation, and a negative value for theta represents counter-clockwise rotation. And for cases where the cone assemblies are rotated clockwise, a positive value for l_{θ} represents counter-clockwise rotation, and a negative value for theta represents clockwise rotation. And the x-axis represents the arc length of the critical non-torque transmitting arc, l_{c}. Here the width wt corresponds to the width of the teeth of the torque transmitting members.

And although the following adjustment is not critical and can be omitted, the performance of the CVT can be increased when in instances when both torque transmitting members are in contact with their transmission belt, adjuster AD3A 103A is used to adjust the rotational position between the transmission pulleys so as to properly adjust the torque applied to each transmission pulley so that the torque rating and/or the durability of the CVT is maximized. One method is to have adjuster AD3 103 try to evenly distribute the load on each tooth. In order to achieve this, the rotational position sensor is used to estimate the amount of teeth of each transmission pulley that is transmitting torque at that instance, and the torque sensors can be used to determine the load on each transmission pulley. And by dividing the measured load on a transmission pulley by its estimated amount of teeth, the load on each of its teeth can be estimated. Another method is to have adjuster AD3 103 try to maintain an even tension in the transmission belts.

Furthermore, although the following is also not critical and can be omitted, the torque sensors SN4C 134C and SN4D 134D can also be used as a diagnostic device that ensures the proper operation of adjuster AD3 103 in trying to eliminate transition flexing. For instance, when under non-transmission ratio changing operation the reading of torque sensor SN4C 134C when only transmission pulley PU1C 41C is transmitting torque is significantly different than the reading of torque sensor SN4D 134D when only transmission pulley PU1D 41D is transmitting torque, or when the reading of a torque sensor is excessively high, the controlling computer of the CVT can take corrective actions and safety steps that prevents or minimizes damages to the CVT, such as adjusting the adjustment provided in order to eliminate transition flexing, or signaling alarms, or initiating shutdowns.

The reason why adjuster AD3 103 is needed in order to substantially increase the duration at which the transmission ratio can be changed is because of transmission ratio change rotation. Transmission ratio change rotation is rotation of a cone assembly that occurs when the axial position of its torque transmitting member is changed while it is in contact with its transmission belt. In order to help explain transition ratio change rotation, the points where the transmission belts first touch the upper surface of their cone assembly will be referred to as points N. Here points N are neutral points, which are points where almost no sliding between the transmission belts and the surface of their cone assembly occur when the pitch diameter of the cone assemblies are changed, regardless of the rotational position of the torque transmitting members. This is because the lengths of the transmission belts from their point N to the points where the horizontal mirror lines of the transmission pulleys intersect the surfaces of the transmission pulleys remain almost constant as the transmission ratio is changed, since the center distance between the cone assemblies and the transmission pulleys do not change; however this is only true for reasonable changes in pitch diameter of the cone assemblies. And point N is also the neutral point because changes in the pitch diameter of the cone assemblies do not affect the portions of the transmission belts that are not in contact with a cone assembly.

Note, for other configurations of a CVT, point N might be positioned elsewhere. For CVTs that utilizes transmission pulleys, a point N is most likely located at a point that corresponds to the end point of a portion of a transmission belt which length from the point where the horizontal mirror line of a transmission pulley intersect the surface of that transmission pulley to point N remains almost constant as the pitch diameter of its cone assembly is changed. For different configurations of CVTs, the location of point N can easily be determined experimentally, by simply determining the point where almost no sliding between the transmission belt and the surface of its cone assembly occur as the pitch diameter of the cone assembly is changed.

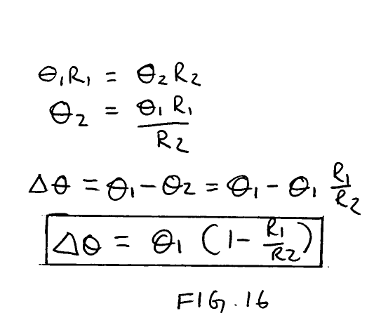

When the midpoint of the torque transmitting member is not positioned at point N, then significant transmission ratio change rotation occurs. The amount of transmission ratio change rotation depends on the angle θ, which is the angle between the midpoint of the torque transmitting member, referred to as point M, and point N. And the direction of transmission ratio change rotation depends on whether the midpoint of the torque transmitting member is positioned to the left or to the right of point N, and on whether the pitch diameter of the torque transmitting member is increased or decreased. The reason that transmission ratio change rotation has to occur is because if no slippage between the torque transmitting member and the transmission belt is allowed, then the arc length between point N and the midpoint of the torque transmitting member, point M, has to remain constant regardless of the pitch diameter. For a given initial angle θ₁, initial radius R₁, and final radius R₂, the transmission ratio change rotation, Δθ, can be determined from the equation shown in FIG. 16. From the equation shown in FIG. 16, it can be seen that the transmission ratio change rotation, Δθ, increases with an increase in initial angle θ₁. Also from FIGS. 15A-15D, where the initial angle θ₁ is simply labeled as θ, it can be observed that clockwise transmission ratio change rotation occurs when the pitch diameter is increased and the center of the torque transmitting member is positioned to the left of point N, see FIG. 15D, and when the pitch diameter is decreased and the center of the torque transmitting member is positioned to the right of point N, see FIG. 15A. And counter-clockwise transmission ratio change rotation occur when the pitch diameter is increased and the center of the torque transmitting member is positioned to the right of point N, see FIG. 15B, and when the pitch diameter is decreased and the center of the torque transmitting member is positioned to the left of point N, see FIG. 15C.

Furthermore, because of the configuration of CVT 2.1, in instances where both torque transmitting member CS3C-M1 23C-M1 and torque transmitting member CS3D-M1 23D-M1 are in contact with their transmission belt, the transmission ratio change rotation for cone assembly CS3C 23C is different from that of cone assembly CS3D 23D. Hence in order to allow the transmission ratio to be changeable when both torque transmitting members are in contact with their transmission belts, compensating relative rotation between either the cone assemblies or the transmission pulleys has to occur. As described earlier, the relative rotational position between the cone assemblies will not be changed, since it is desired to keep the rotational position of torque transmitting member CS3D-M1 23D-M1 opposite or close to opposite from the rotational position of torque transmitting member CS3C-M1 23C-M1. Therefore, in order to compensate for the transmission ratio change rotation, adjuster AD3 103 is used to adjust the rotational position of transmission pulley PU1C 41C relative to transmission pulley PU1D 41D. In order to compensate for the transmission ratio change rotation, adjuster AD3 103 is used to rotate transmission pulley PU1C 41C relative to transmission pulley PU1D 41D such that the pulling loads on the transmission pulleys, as measured by torque sensor SN4C 134C and torque sensor SN4D 134D, are about equal.

Besides eliminating transition flexing and compensating for transmission ratio change rotation, the adjuster system for CVT 2.1 can also be used to compensate for wear that causes unequal pulling loads in the alternating transmission pulleys.

The rotational movements between transmission pulley PU1C 41C and transmission pulley PU1D 41D for different rotational positions and transmission ratio changes (increasing/decreasing) as to compensate for transmission ratio change rotation, and the rotational movements between transmission pulley PU1C 41C and transmission pulley PU1D 41D as to eliminate or reduce transition flexing, when the input shaft is rotated clock-wise are described below:

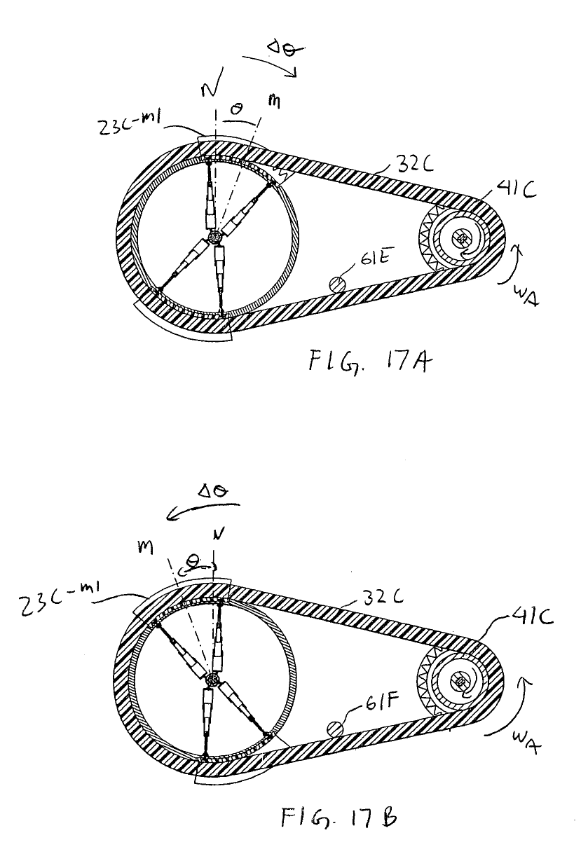

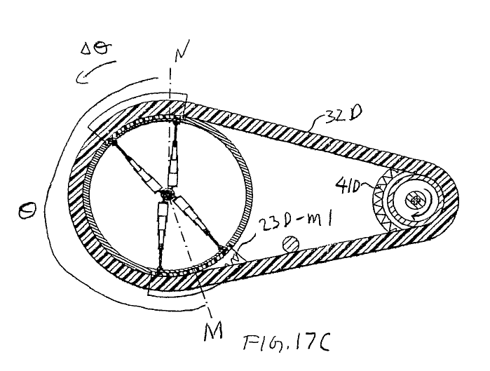

Decreasing Pitch Diameter and Torque Transmitting Member CS3C-M1 23-M1 on Upper Half (FIGS. 17A-17C)

Here while torque transmitting member CS3C-M1 23C-M1 is on the upper half and torque transmitting member CS3D-M1 23D-M1 is not in contact with its transmission belt, adjuster AD3 103 is used to eliminate transition flexing in instances where the circumferences of the surfaces of the cone assemblies where the torque transmitting members are positioned are not a multiple of the width of the teeth of the torque transmitting members. Note, the operation to eliminate transition flexing of adjuster AD3 103 also occurs in instances where the transmission ratio is not changed. Hence in this instance adjuster AD3 103 is not used to compensate for transmission ratio change rotation, despite the fact that due to transition ratio change rotation the cone assemblies are rotated counter-clockwise. Since here only one torque transmitting member is in contact with its transmission belt, transmission ratio change rotation can not cause excessive stretching of the transmission belts. And some counter-clockwise rotation of the cone assemblies, which causes slippage at the output shaft, slightly reduces the performance of the CVT, but is not damaging the CVT.

And once both torque transmitting member CS3C-M1 23C-M1 and torque transmitting member CS3D-M1 23D-M1 are in contact with their transmission belts, see FIGS. 17A-17C, it can be observed that here when point M of torque transmitting member CS3C-M1 23C-M1 is positioned to the right of point N, see FIG. 17A, the transmission ratio change rotation of cone assembly CS3C-M1 23C-M1 is clockwise. And when torque transmitting member CS3C-M1 23C-M1 is positioned to the left of point N, see FIG. 17B, the transmission ratio change rotation of cone assembly CS3C 23C is counter-clockwise. And in this case, the transmission ratio change rotation of cone assembly CS3D 23D is always counter-clockwise, see FIG. 17D From FIGS. 17B and 17C it can be seen that here if torque transmitting member CS3C-M1 23C-M1 is positioned to the left of point N, θ of cone assembly CS3D 23D is always greater than θ of cone assembly CS3C 23C. Hence, regardless of whether the transmission ratio change rotation of cone assembly CS3C 23C is clockwise or counter-clockwise, here changing the transmission ratio causes cone assembly CS3D 23D to rotate counter-clockwise relative to cone assembly CS3C 23C. In order to compensate for the transmission ratio change rotation, adjuster AD3 103 needs to rotate transmission pulley PU1C 41C counter-clockwise relative to transmission pulley PU1D 41D. As discussed previously, here the pulling load in the transmission pulleys PU1C 41C and PU1D 41D will be used to control the rotation of adjuster AD3 103. Here once the pulling load in transmission pulley PU1D 41D falls below certain value relative to the pulling load in transmission pulley PU1C 41C, the adjuster AD3 103 rotates transmission pulley PU1C 41C counter-clockwise relative to transmission pulley PU1D 41D. And once the difference in pulling load between transmission pulley PU1D 41D and transmission pulley PU1C 41C has reached an acceptable value, the adjuster AD3 103 stops rotating. In FIGS. 17A and 17B, the rotation provided by adjuster AD3 103 is labeled as ω_{A}. Also, here the pulling load is the load that tends to rotate a transmission pulley counter-clock-wise.

And once torque transmitting member CS3C-M1 23C-M1 comes out of contact with its transmission belt, during transmission ratio change as during non-transmission ratio change operation, adjuster AD3 103 is active in instances where the circumferences of the surfaces of the cone assemblies where the torque transmitting members are positioned are not a multiple of the width of the teeth of the torque transmitting members. Since in this instance only one torque transmitting member is contact with its transmission belt, it is not necessary for adjuster AD3 103 to compensate for transmission ratio change rotation, despite the fact that due to transmission ratio change rotation, cone assembly CS3D 23D, and hence output shaft SH8 18 are rotated counter-clockwise. Since some counter-clockwise rotation applied to cone assembly CS3D 23D, which causes slippage at the output shaft SH8 18, slightly reduces the performance of the CVT but is not damaging the CVT.

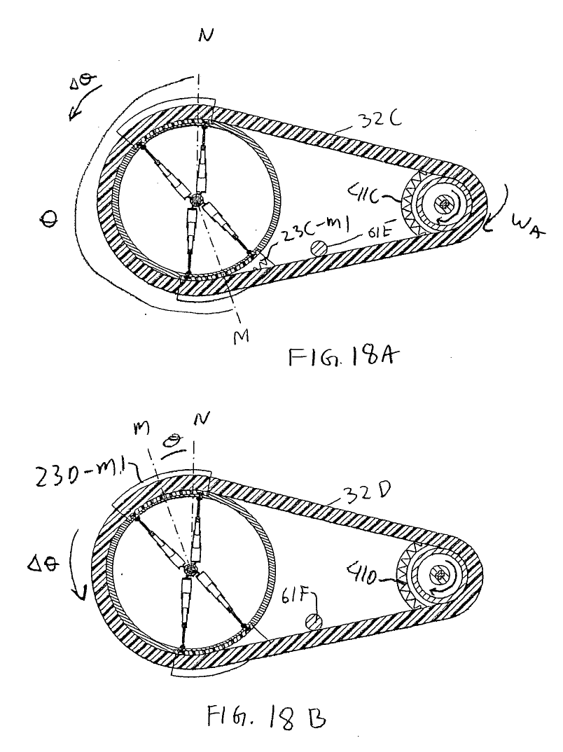

Decreasing Pitch Diameter and Torque Transmitting Member CSC3C-M1 23C-M1 on Lower Half (FIGS. 18A & 18B)

Here while torque transmitting member CS3C-M1 23C-M1 is on the lower half and not in contact with its transmission belt, during the transmission ratio change as during non-transmission ratio change operation, adjuster AD3 103 is used to compensate for transition flexing in instances where the circumferences of the surfaces of the cone assemblies where the torque transmitting members are positioned are not a multiple of the width of the teeth of the torque transmitting members. Since in this instance only one torque transmitting member is in contact with its transmission belt, it is not necessary for adjuster AD3 103 to compensate for transmission ratio change rotation, despite the fact that due to transition ratio change rotation the cone assemblies are rotated counter-clockwise. Since some counter-clockwise rotation of the cone assemblies, which causes slippage at the output shaft, slightly reduces the performance of the CVT but is not damaging the CVT.

And once both torque transmitting member CS3C-M1 23C-M1 and torque transmitting member CS3D-M1 23D-M1 are in contact with their transmission belt, see FIGS. 18A & 18B, adjuster AD3 103 is used to compensate for transmission ratio change rotation. By using the same method described in the previous section, where torque transmitting member CS3C-M1 23C-M1 is positioned on the upper half and both torque transmitting members are in contact with their transmission belt, it becomes clear that here in order to compensate for the transmission ratio change rotation, the adjuster AD3 103 needs to rotate transmission pulley PU1C 41C clockwise relative to transmission pulley PU1D 41D. As discussed previously, here the pulling load in the transmission pulleys PU1C 41C and PU1D 41D will be used to control the rotation of adjuster AD3 103. Here once the pulling load in transmission pulley PU1D 41D increases above a certain value relative to the pulling load in transmission pulley PU1C 41C, the adjuster AD3 103 rotates transmission pulley PU1C 41C clockwise relative to transmission pulley PU1D 41C. And once the difference in pulling load between the transmission pulleys has reached an acceptable value, adjuster AD3 103 stops rotating.

And once torque transmitting member CS3D-M1 23D-M1 comes out of contact with its transmission belt, during the transmission ratio change, as during non-transmission ratio change operation, adjuster AD3 103 is used to eliminate transition flexing in instances where the circumferences of the surfaces of the cone assemblies where the torque transmitting members are positioned are not a multiple of the width of the teeth of the torque transmitting members. However since in this instance only one torque transmitting member is in contact with its transmission belt, adjuster AD3 103 is not used to compensate for transmission ratio change rotation, despite the fact that transmission ratio change rotation rotates cone assembly CS3C-M1 23C-M1, and hence output shaft SH8 18, counter-clockwise. Since some counter-clockwise rotation applied to cone assembly CS3C 23C, which causes slippage at the output shaft SH8 18, slightly reduces the performance of the CVT but is not damaging the CVT.

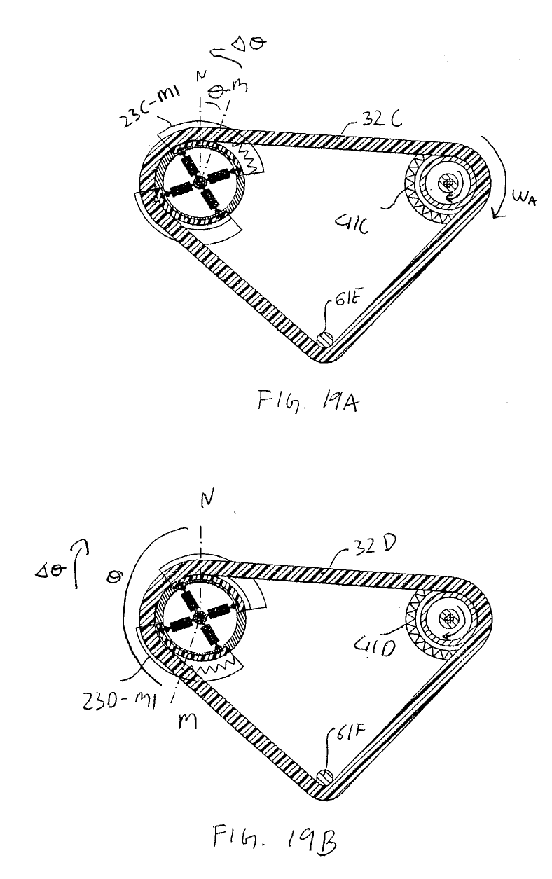

Increasing Pitch Diameter and Torque Transmitting Member CS3C-M1 23C-M1 on Upper Half (FIGS. 19A & 19B)

Here while torque transmitting member CS3C-M1 23C-M1 is on the upper half and torque transmitting member CS3D-M1 23D-M1 is not in contact with its transmission belt, during transmission ratio change as during non-transmission ratio change operation, adjuster AD3 103 is used to eliminate transition flexing in instances where the circumferences of the surfaces of the cone assemblies where the torque transmitting members are positioned are not a multiple of the width of the teeth of the torque transmitting members. Since in this instance only one torque transmitting member is in contact with its transmission belt, the adjuster AD3 103 is not used to compensate for transmission ratio change rotation, despite the fact that due to transition ratio change rotation the cone assemblies are rotated clockwise for the same reason discussed earlier.

And once both, torque transmitting member CS3C-M1 23C-M1 and torque transmitting member CS3D-M1 23D-M1 are in contact with their transmission belts, see FIGS. 19A & 19B, adjuster AD3 103 is used to compensate for transmission ratio change rotation. As discussed earlier, here the direction of the transmission ratio change rotation is simply opposite from that were the transmission ratio is decreased. And as described before here a larger angle between the midpoint of a torque transmitting member and point N, results in a larger transmission ratio change rotation. Previously it was described that when the transmission ratio is decreased and torque transmitting member CS3C-M1 23C-M1 is positioned on the upper half and both torque transmitting members are in contact with their transmission belt, the adjuster AD3 103 needs to rotate transmission pulley PU1D 41C counter-clockwise relative to transmission pulley PU1D 41D. Hence in this case, the adjuster AD3 103 needs to rotate transmission pulley PU1C 41C clockwise relative to transmission pulley PU1D 41D. As discussed previously, here the pulling load in the transmission pulleys will be used to control the compensating rotation of the adjuster AD3 103. Here once the pulling load in transmission pulley PU1D 41D increases above a certain value relative to the pulling load in transmission pulley PU1C 41C, the adjuster AD3 103 rotates transmission pulley PU1C 41C clockwise relative to transmission pulley PU1D 41D. And once the difference in the pulling load between transmission pulleys has reached an acceptable value, the adjuster AD3 103 stops rotating.

And once torque transmitting member CS3C-M1 23C-M1 comes out of contact with its transmission belt, during transmission ratio change as under non-transmission change operation, the adjuster AD3 103 is active in instances where the circumferences of the surfaces of the cone assemblies where the torque transmitting members are positioned are not a multiple of the width of the teeth of the torque transmitting members. Since in this instance only one torque transmitting member is in contact with its transmission belt, the adjuster AD3 103 is not used to compensate for transmission ratio change rotation, despite the fact that transmission ratio change rotation rotates cone assembly CS3D-M1 23D-M1, and hence output shaft SH8 18, clockwise. Since some clockwise rotation applied to the output shaft SH8 18 is not damaging the CVT, and actually increases the total amount of rotation at the output shaft SH8 18 at the expense of the work provided by the transmission ratio changing actuator.

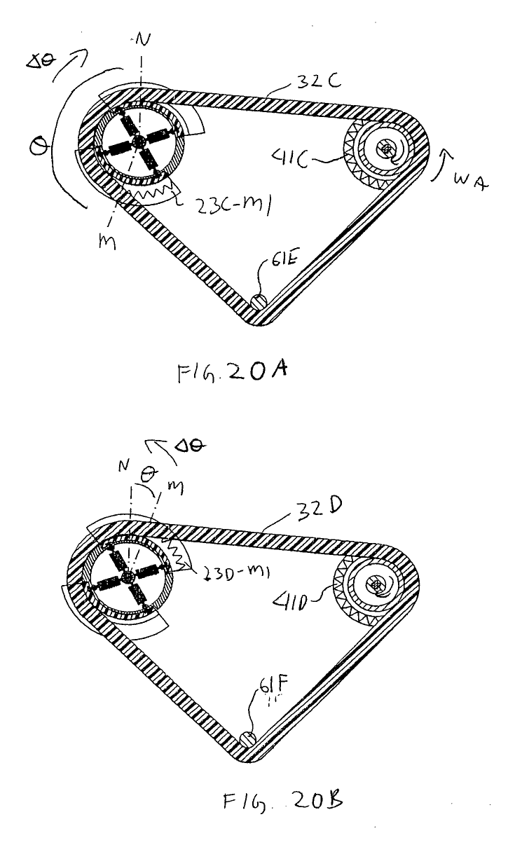

Increasing Pitch Diameter and Torque Transmitting Member CS3C-M1 23C-M1 on Lower Half (FIGS. 20A & 20B)

Here while torque transmitting member CS3C-M1 23C-M1 is on the lower half and not in contact with its transmission belt, during transmission ratio as during non-transmission ratio change operation, the adjuster AD3 103 is used to eliminate transition flexing in instances where the circumferences of the surfaces of the cone assemblies where the torque transmitting members are positioned are not a multiple of the width of the teeth of the torque transmitting members. In this instance the adjuster AD3 103 is not used to compensate for transmission ratio change rotation, despite the fact that due to transition ratio change rotation the cone assemblies are rotated clockwise for the same reasons discussed earlier.

And once both torque transmitting member CS3C-M1 23C-M1 and torque transmitting member CS3D-M1 23D-M1 are in contact with their transmission belts, see FIGS. 20A & 20B, the adjuster AD3 103 is used to compensate for transmission ratio change rotation. As discussed earlier, here the direction of the transmission ratio change rotation is simply opposite from that were the transmission ratio is decreased. And as described before here a larger angle between the midpoint of a torque transmitting member and point N, results in a larger transmission ratio change rotation. Previously it was described that when the transmission ratio is decreased and torque transmitting member CS3C-M1 23C-M1 is positioned on the lower half and both torque transmitting members are in contact with their transmission belt, the adjuster AD3 103 needs to rotate transmission pulley PU1C 41C clockwise relative to transmission pulley PU1D 41D. Hence here, the adjuster AD3 103 needs to rotate transmission pulley PU1C 41C counter-clockwise relative to transmission pulley PU1D 41D. As discussed previously, here the pulling load in the transmission pulleys will be used to control the rotation of adjuster AD3 103. Once the pulling load in transmission pulley PU1D 41D decreases below a certain value relative to the pulling load in transmission pulley PU1C 41C, the adjuster AD3 103 rotates transmission pulley PU1C 41C counter-clockwise relative to transmission pulley PU1D 41D. And once the difference in pulling load between transmission pulleys has reached an acceptable value, the adjuster AD3 103 stops rotating.

And once torque transmitting member CS3D-M1 23D-M1 comes out of contact with its transmission belt, during transmission ratio change as during non-transmission ratio change rotation, adjuster AD3 103 is used to eliminate transition flexing in instances where the circumferences of the surfaces of the cone assemblies where the torque transmitting members are positioned are not a multiple of the width of the teeth of the torque transmitting members. However in this instance the adjuster AD3 103 is not used to compensate for the transmission ratio change rotation, despite the fact that transmission ratio change rotation rotates cone assembly CS3C-M1 23C-M1, and hence output shaft SH8 18, clockwise. Since some clockwise rotation applied to the output shaft SH8 18 is not damaging the CVT, and actually increases the total amount of rotation at the output shaft SH8 18 at the expense of the work provided by the transmission ratio changing actuator.

Despite the utilization of adjuster AD3 103, occasional stalling of the transmission ratio changing actuator can still be allowed, as long as the stalling is sufficiently reduced as to justify the cost of the adjuster. Since although it might be theoretically possible to completely eliminate stalling of the transmission ratio changing actuator, by also taking into account the flexibility of the transmission belts, this might not be economically practical. The cost to implement this might not compensate for the additional duration at which the transmission ratio can be changed.

Furthermore, in the instances where the adjuster AD3 103 needs to rotate transmission pulley PU1C 41C clockwise relative to transmission pulley PU1D 41D, adjuster AD3 103 needs to provide a pulling torque, which might be quite large, since it has to overcome the rotational resistance of cone assembly CS3C 23C. This situation is similar to a situation where a load is pulled up a cliff. And in the instances where adjuster AD3 103 needs to rotate transmission pulley PU1C 41C counter-clockwise relative to transmission pulley PU1D 41D, adjuster AD3 103 needs to provide a releasing torque, which allows transmission pulley PU1C 41C to slip relative to the input shaft. Unlike the pulling torque, the releasing torque does not have to provide torque that overcomes the rotational resistance of cone assembly CS3C 23C. Here when a holding mechanism, which prevents transmission pulley PU1C 41C from freely rotating counter-clockwise is used, the only load adjuster AD3 103 needs to exert is due to friction. This situation is similar to a situation where a load is lowered down a cliff using a winch which has a locking mechanism that prevents the load from going down the cliff without any input at the winch. By providing both transmission pulleys with an adjuster, the need of the adjusters to provide a pulling torque can be eliminated. Since here, in order to compensate for transmission ratio change rotation, one adjuster needs to provide a pulling torque, and the other adjuster needs to provide a releasing torque. Hence here the adjusters can be operated such that only the adjuster that needs to provide a releasing torque is active. Also, by providing both transmission pulleys with an adjuster, the adjusters can also be operated as to eliminate any rotation at the output shaft due the changing of the transmission ratio.

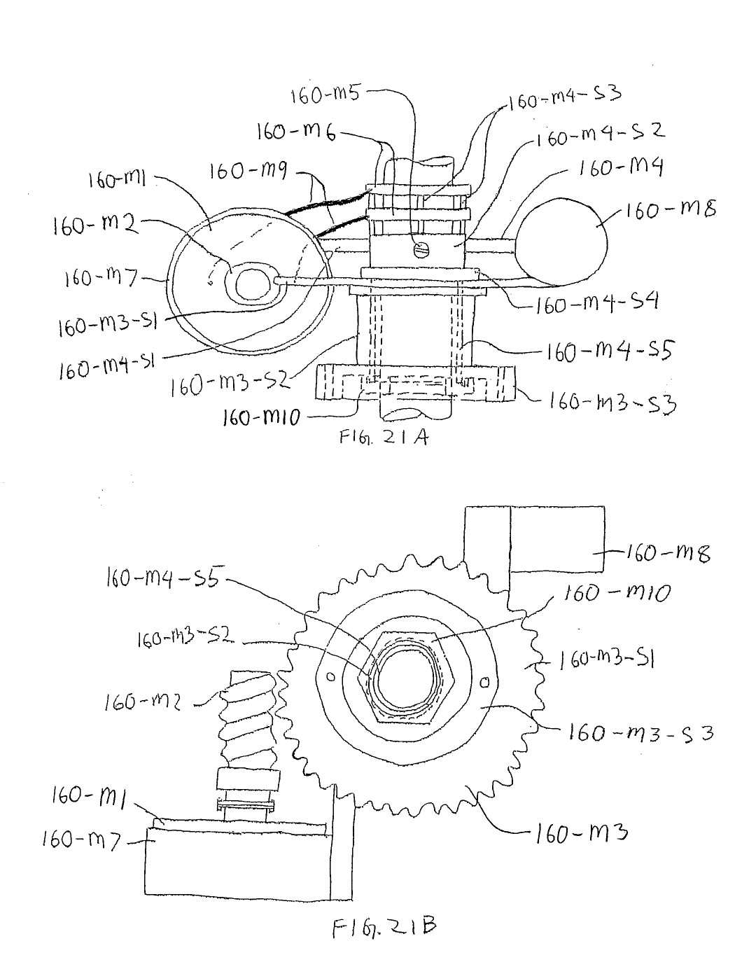

Electrical Adjuster (FIGS. 21A and 21B)

In this section a design for an electrical adjuster 160, that can be used as a transition flexing adjuster, mover adjuster, or adjuster AD3 103 is described.

All the adjusters described in this invention consist of an adjuster body and an adjuster output member, that can rotate relative to the adjuster body. In order for the adjuster to transmit torque from a transmission pulley or a cone assembly that is fixed to the adjuster output member to the shaft to which the adjuster body is fixed, the adjuster output member has to be able to hold the adjuster output member fixed relative to the adjuster body despite the fact that torque is applied at the adjuster output member. This can be can be achieved by using an electrical brake or a holding mechanism.

For the electrical adjuster 160, shown as top-view in FIG. 21A and as a front-view in FIG. 21B, a holding mechanism is used. Here the adjuster motor 160-M1 drives a worm gear 160-M2, which engages with an adjuster gear 160-M3. The helix angle of the worm gear 160-12, (x, is designed such that the worm gear 160-M2 can drive the adjuster gear 160-M3 but the adjuster gear 160-M3 can't drive the worm gear 160-M2. Hence here, the worm gear 160-M2 and the adjuster gear 160-M3 form the holding mechanism that allows the torque applied at the adjuster output member to be transmitted to the adjuster body.

The body of the adjuster consists mainly of an attachment sleeve 160-M4, which has an attachment sleeve arm 1160-M4-S1, an attachment sleeve arm 2 160-M4-S2, an adjuster motor holder 160-M7, and a counter-weight 160-M8. The attachment sleeve 160-M4 can be fixed to an input shaft, an output shaft, or a spline sleeve, so that it is rotatably and axially constrained relative to the shaft or sleeve on which it is attached using a electrical adjuster set screw 160-M5. Extending radially outwards from the side surfaces of the attachment sleeve 160-M4 are the two attachment sleeve arms 160-M4-S1 and 160-M4-S2. Attached to attachment sleeve arm 1 160-M4-S1 is the adjuster motor holder 160-M7, on which the adjuster motor 160-M1 is pressed in such that due to friction, the adjuster motor 160-M1 can not move axially or rotate relative to the adjuster motor holder 160-M7. And attached to the attachment sleeve arm 2 160-M4-S2 is counter-weight 160-M8, which is used to counter-balance the centrifugal force of the adjuster motor holder 160-M7, the adjuster motor 160-M1, and the worm gear 160-M2. Using another adjuster motor with a worm gear to counter-balance the centrifugal force of the existing adjuster motor 160-M1 and worm gear 160-M2 should also work. The additional adjuster motor can be used to increase the torque capacity of the electrical adjuster 160, or it can be used as a back-up in case the main adjuster motor 160-M1 fails.

And extending axially backwards from the attachment sleeve 160-M4 are four attachment sleeve fins 160-M4-S3, spaced at 90 deg. from each other, on which two electrical rings 160-M6 are securely pressed in, as to prevent them from rotating or from moving axially relative to the attachment sleeve fins 160-M4-S3. Each electrical ring 160-M6 is connected to a pole/connection of the adjuster motor 160-M1. The surfaces of the attachment sleeve fins 160-M4-S3 in contact with the electrical rings 160-M6 are insulated such that the electricity directed to the electrical rings 160-M6 by some electrical brushes are directed to the electrical poles of the adjuster motor 160-M1 by electrical cables 160-M9. If an electric motor that requires more than two input signals is used, than additional electrical rings 160-M6 and electrical cables 160-M9 are needed.

Positioned axially in front of the attachment sleeve 160-M4 is an attachment sleeve flange 160-M4-S4, which is larger in diameter than the main body of attachment sleeve 160-M4. And positioned axially in front of the attachment sleeve flange 160-M4-S4 is an attachment sleeve extension 160-M4-S5, which is shaped like a hollow cylinder which has a smooth side surface, except at its front end, were it is threaded.

The adjuster gear 160-M3, with which the worm gear 160-M2 engages, is shaped like a spur gear, that has a centrically positioned cylindrical extension at its front surface. The spur gear shaped portion of adjuster gear 160-M3 is labeled as spur gear 160-M3-S1. And shaped axially in front of the spur gear 160-M3-S1 is an adjuster gear extension 160-M3-S2, which is shaped like a hollow cylinder, which center is positioned at the center of the spur gear 160-M3-S1. And positioned axially in front of the adjuster gear extension 160-M3-S2 is an adjuster gear flange 160-M3-S3, which is shaped like a disk that has a thick rim. The rim portion of adjuster gear flange 160-M3-S3 extends forwards beyond the surface of its disk shape. On the rim portion of the adjuster gear flange 160-M3-S3, two bolt holes that can be used to attach the electrical adjuster 160 to a torque transmitting device such as a cone assembly, a transmission pulley, an attachment extension on which the telescopes of a torque transmitting member can be attached, etc. The adjuster gear 160-M3 also has a centrically positioned hole that goes through all shapes of the adjuster gear 160-M3, so that it can be slid onto the attachment sleeve extension 160-M4-S5. When adjuster gear 160-M3 is slid onto attachment sleeve extension 160-M4-S5 until the back surface of adjuster gear 160-M3 is in contact with the attachment sleeve flange 160-M4-S4, the threaded portion of attachment sleeve extension 160-M4-S5 is not covered by the disk shaped portion of adjuster gear flange 160-M3-S3 but is only covered by its flange shaped portion. The engagement between the back surface of adjuster gear 160-M3 and the attachment sleeve flange 160-M4-S4 prevents the adjuster gear 160-M3 from moving axially backwards relative to the attachment sleeve 160-M4, and in order to prevent the adjuster gear 160-M3 from moving axially forwards relative to the attachment sleeve 160-M4, an electrical adjuster nut 160-M10 is threaded onto the threaded portion of the attachment sleeve extension 160-M4-S5. The width of the electrical adjuster nut 160-M10 should be less than the thickness of the rim shape of adjuster gear flange 160-M3-S3. Since the adjuster gear 160-M3 has to rotate relative to the attachment sleeve 160-M4, friction between the engaging surfaces of the attachment sleeve 160-M4, the adjuster gear 160-M3, and the electrical adjuster nut 160-M10 should be minimized. This can be done by coating the engaging surfaces of the adjuster gear with bronze.

It might also be useful to have a limiting clutch attached between the shaft of the adjuster motor and the worm gear, as a safety measure in case the controlling computer fails to control the electrical actuator properly. It is also recommended that a housing that protects the components of the electrical adjuster from dirt is used.

Additional Embodiments

In this section first some alternate configurations for adjuster systems for CVT 1 and CVT 2 utilizing the components described earlier are presented. Then differential adjuster shafts which can be used to replace the shaft on which the transmission pulleys are mounted of a CVT 2 will be presented. Then alternate adjusters, such as a spring-loaded adjuster and a mechanical adjuster are described. Next a method to compensate for the inaccuracy of the adjusters by having gaps between the teeth of the torque transmitting members and their transmission belt will be described. Then a friction clutch mounting method, which can be used for rotational position adjustment or as a safety measure, will be described. And after that, an alternate method to measure the torque applied on a transmission pulley will be described. In addition, some additional information for the CVTs of U.S. Pat. No. 6,656,070 not directly directed towards adjuster systems will be presented.

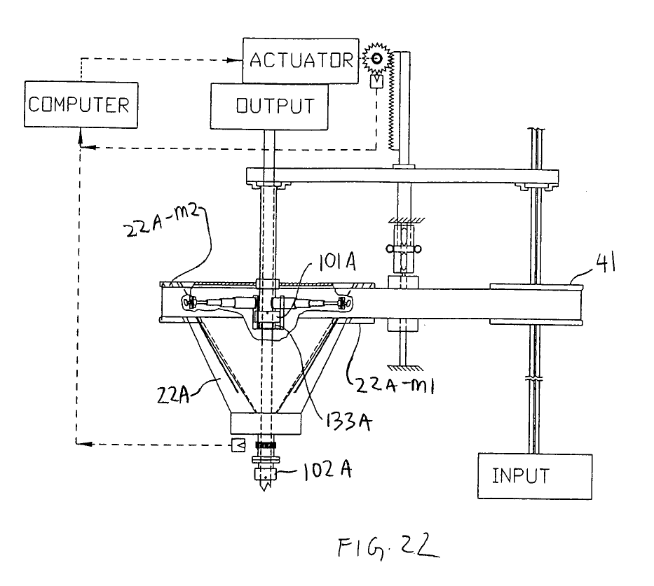

CVT 1.2 (FIG. 22)

This CVT, which is shown in FIG. 22, is almost identical to CVT 1.1, which is shown in FIG. 3, except that here cone assembly 22B is replaced with a transmission pulley 41; and a transmission belt and transmission belt tensioning mechanism, used in CVT 2.1, is used. In this case only one moveable adjuster, one transition flexing adjuster, one rotational position sensor, and one relative rotational position sensor is needed.

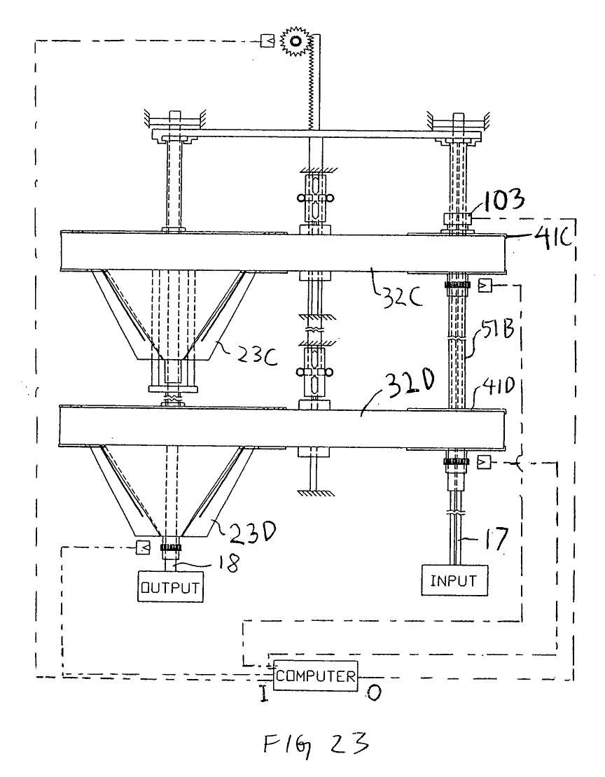

CVT 2.2 (FIG. 23)

CVT 2.2, shown in FIG. 23, is identical to CVT 2.1, which is shown in FIG. 14, except that here no torque sensors are used to control the relative rotational position of the transmission pulleys. Here only the rotational position sensors are used to control the rotational position of the adjuster mounted transmission pulley in order to eliminate transition flexing and compensate for transmission ratio change rotation. Here in order to compensate for transmission ratio change rotation, the rotational position of the adjuster mounted transmission pulley is controlled based on the results obtained from the equation shown in FIG. 16, where Δθ from the adjuster mounted cone assembly is subtracted from Δθ of the non-adjuster mounted cone assembly. It is preferred that counter-clockwise rotations are considered positive and clockwise rotations are considered negative. Here the values for θ should be continuously recalculated at short enough intervals as to minimize stalling of the transmission ratio changing actuator, since the values for θ continuously change as the cone assemblies are rotating. Also here, only θ for one cone assembly needs to be monitored, since the controlling computer can determined θ for the other cone assembly mathematically. Also for configurations were the change in pitch diameter is large, the equation shown in FIG. 16 is not very accurate. This is because as described earlier, as the pitch diameter is changed, the lengths of the transmission belts from their point N to the points where the horizontal mirror line of the transmission pulleys intersect the surfaces of the transmission pulleys remain almost constant only for small changes in pitch diameter. However, this should not be a problem, since here the values for θ are calculated at short intervals so that the changes in pitch diameter between one calculated value and its subsequent calculated value should be small. And some discrepancy between the actual values and the calculated values for Δθ can be compensated by some flexing of the transmissions belts. However, if desired a more accurate equation for calculating Δθ, which takes into account the changes in pitch diameter and which will be referred to as the adjusted equation, is presented in the following paragraphs.

The adjusted equation, takes into account the changes in θ due to the change in the radius of the cone assembly where its torque transmitting member is positioned as its pitch diameter is changed, labeled as dθ/dR; and takes into account the rotation of the cone assembly also due to the change in the radius, labeled as dθᵣₒₜ/dR. For the adjusted equation, first the equation shown in FIG. 16 is modified by replacing θ₁ with (θ₁+dθ/dR); and then dθᵣₒₜ/dR is added to the modified equation. Here in instances were θ, θ₁ in FIG. 16, increases with the change in radius, dθ/dR is positive, and in instances were θ decreases with the change in radius, dθ/dR is negative. Also, in instances were dθᵣₒₜ/dR increases the value for Δθ with the change in radius, dθᵣₒₜ/dR is positive, and in instances were dθᵣₒₜ/dR decreases the value for Δθ with the change in radius, dθᵣₒₜ/dR is negative. Note, here the positive and negative signs for dθ/dR and dθᵣₒₜ/dR do not have anything to do with the direction of rotation of the cone assembly, since at this stage the values for 0 and Δθ are considered positive regardless of the direction of rotation of the cone assembly. However, once the magnitudes for Δθ has been calculated using the adjusted equation, then the signs for the Δθs based on the direction of their rotation are assigned. As before, it is preferred that counter-clockwise rotations are considered positive and clockwise rotations are considered negative.

A rough estimation for the values for dθ/dR and dθᵣₒₜ/dR, which here are assumed to be identical, can be obtained experimentally. This can be done by using a configuration for a CVT 2 where only one cone assembly is coupled to its transmission pulley by a transmission belt. Also in order to monitor dθ/dR and dθᵣₒₜ/dR as the pitch diameter, and hence radius, of the coupled cone assembly is changed, a computer that can monitor the rotational position of the coupled cone assembly and the transmission ratio via appropriate sensors is needed. The experiment is conducted by first positioning the transmission belt at the smallest pitch diameter, and positioning the midpoint of the torque transmitting member at the location where the transmission belt first touches the upper surface of the cone assembly. Then, the transmission belt is moved towards the largest pitch diameter, while the transmission ratio and the rotation of the cone assembly is continuously monitored by the computer. The computer can then use this information to compute the values for dθ/dR and dθᵣₒₜ/dR, which can then be used in the adjusted equation.

The method for determining dθ/dR and dθᵣₒₜ/dR described in the previous paragraph might not be accurate enough for some applications. If this is the case, then the values for dθ/dR can be determined by again using a configuration for a CVT 2 where only one cone assembly is coupled to its transmission pulley by a transmission belt. However here, it might be easier to use a cone assembly that does not have a torque transmitting member. The experiment is conducted by first positioning the transmission belt at the smallest pitch diameter and then moving it towards the largest pitch diameter while continuously monitoring the location of point N, which is the point where the transmission belt first touches the upper surface of the cone assembly. Here the movement of point N as the pitch diameter, and hence radius, is changed is dθ/dR. And the values for dθᵣₒₜ/dR can be determined by the same method used in the previous paragraph. However here instead of moving the transmission belt in one step, the transmission belt should be moved in a stepwise manner. So that by making adjustments as necessary, it can be assured that the midpoint of the torque transmitting member is positioned at or close enough to point N each time the pitch diameter is changed.

Also in cases where acceptable flexing in the transmission belts can not compensate for the inaccuracy of the equation shown in FIG. 16 or its adjusted equation, stalling of the transmission ratio changing actuator occurs.

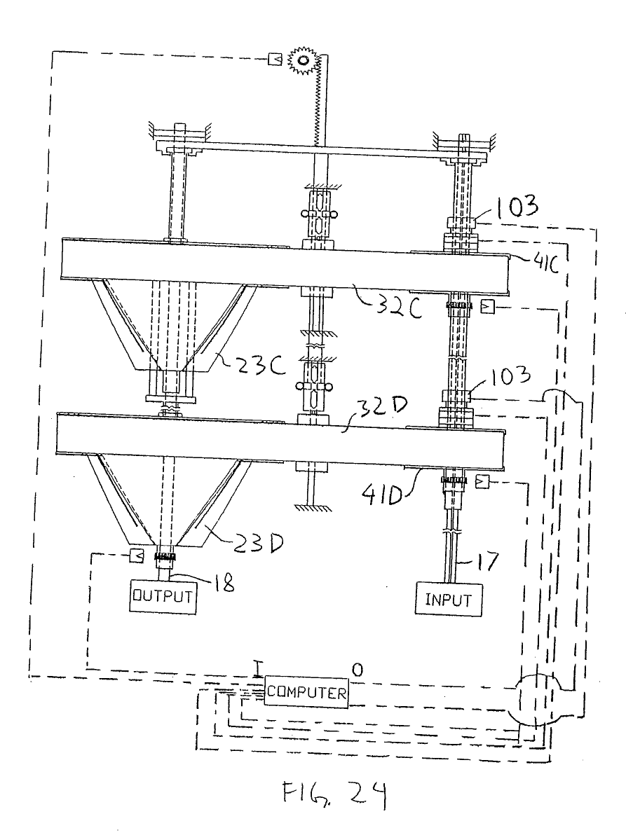

CVT 2.3 (FIG. 24)

CVT 2.3, shown in FIG. 24, is identical to CVT 2.1, except that here two adjusters are used, one for each transmission pulley. Here in order to eliminate transition flexing any or both adjusters can be used. And in order to distribute the torque loading on the cone assemblies when both torque transmitting members are transmitting torque and in order to compensate for transmission ratio change rotation, only the adjuster that needs to provide a releasing torque can be made active so as to reduce the required torque capacity of the adjusters, see last paragraph of the Adjuster System for CVT 2 Section.

CVT 2.4 (FIG. 25)

CVT 2.4, shown in FIG. 25, is identical to CVT 2.3, except that here no torque sensors are used. Here only the rotational position sensors are used to control the adjusters in order to eliminate transition flexing and compensate for transmission ratio change rotation. In order to eliminate transition flexing any or both adjusters can be used. And in order the compensate for transmission ratio change rotation, the active adjuster, which is the adjuster that is providing a releasing torque, can be controlled by using eqn. 16 or its adjusted equation as described in the CVT 2.2 Section; or by using the over adjustment method describe later in this section.

When eqn. 16 or its adjusted equation is used, in instances where the active adjuster, which is the adjuster that is providing a releasing torque, is providing too little adjustment then the transmission ratio changing actuator should stall before excessive flexing of the transmission belts occur. And in instances where the active adjuster is providing too much adjustment, then the active adjuster should stall or slip before excessive flexing of the transmission belts occur. Stalling of the active adjuster might be preferred over stalling of the transmission ratio changing actuator, since stalling of the active adjuster will not reduce the duration at which the transmission ratio can be changed. Therefore, a more conservative estimation for the equation shown in FIG. 16 or its adjusted equation, see the CVT 2.2 Section, might be preferred.

Furthermore, instead of using the equation shown in FIG. 16 or its adjusted equation to control the adjusters, a simpler and more effective method might be to use the over adjustment method. In this method, during transmission ratio change, when both torque transmitting members are in contact with their transmission belt, the active adjuster, which should be the adjuster that is providing a releasing torque, continuously rotates at full capacity so as to provide more adjustment than required. Here when adjustment is required the active adjuster will provide adjustment and when not, the adjuster will simply stall or slip and flex the transmission belts within an acceptable limit. In order to ensure this, the torque of the adjusters should be small enough or a slipping clutch that ensures this can also be used.

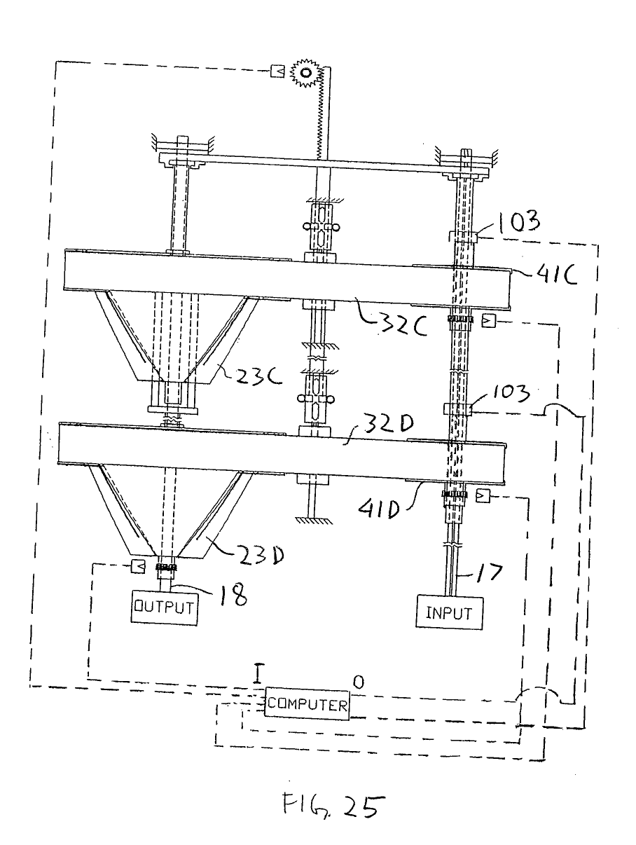

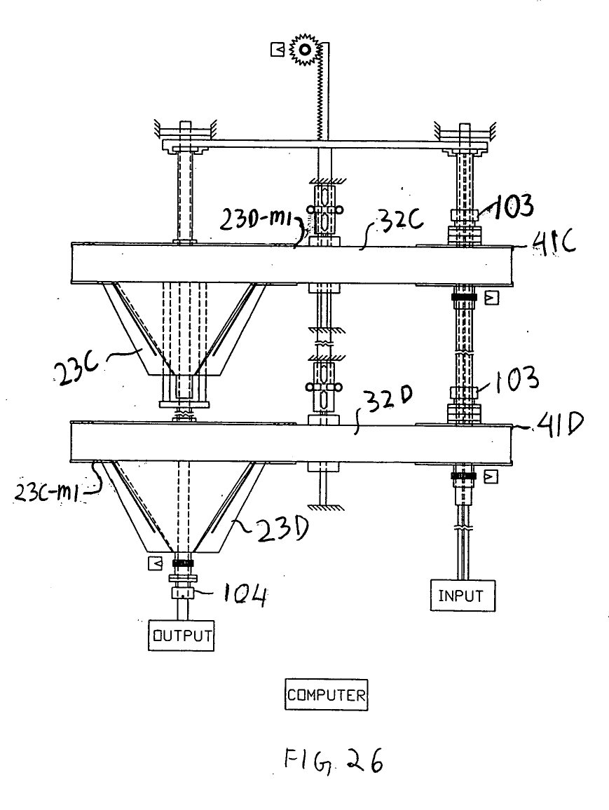

CVT 2.5 (FIG. 26)

CVT 2.5, which is shown in FIG. 26, is almost identical to CVT 2.1; however here in order to eliminate transition flexing, the relative rotational movements between torque transmitting member 11 and torque transmitting member 22, as described for CVT 1.1, is used for torque transmitting member CS3C-M1 23C-M1 and torque transmitting member CS3D-M1 23D-M1. In order to achieve this, the front cone assembly, has to be rotated relative to the back cone assembly or vice-versa. Hence here an adjuster AD4 104, that can adjust the rotational position of cone assembly CS3D 23D relative to cone assembly CS3C 23C is used.

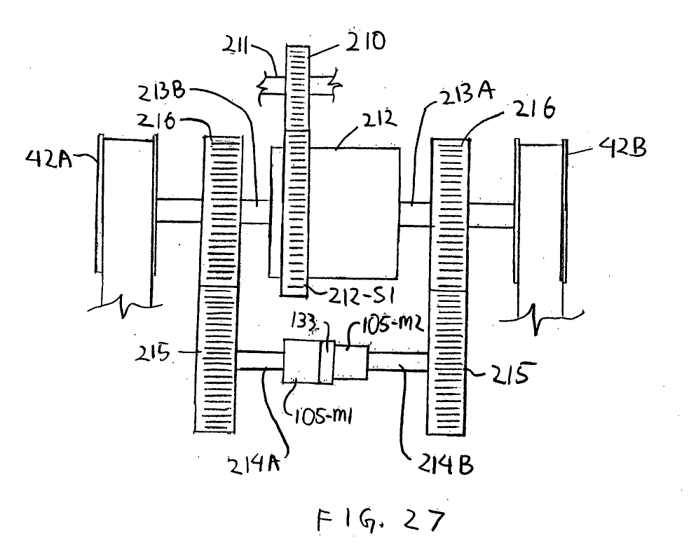

Differential Adjuster Shaft for CVT 2 (FIGS. 27, 28, 29, 30, 31, 32, 33 34A, 34B, 34C, 35, 36)

In this section first the advantages of using a differential adjuster shaft, which is a shaft or spline that uses a differential, in a CVT 2 will be described. Then, the preferred and alternate configurations for differential adjuster shafts will be described. Next, the mounting details of a differential adjuster shaft, so as to allow axial movements for it's transmission pulleys, will be described.

As described in the previous sections, in a configuration where each transmission pulley is mounted on an adjuster, in order to distribute the torque loading on the cone assemblies when both torque transmitting members are transmitting torque and in order to compensate for transmission ratio change rotation, only the adjuster that needs to provides a releasing torque can be made active. Hence under this configuration, unlike the configuration where only one adjuster is used, the adjusters do not have to provide a pulling torque. And not having to provide a pulling torque can significantly lower the torque requirements of the adjuster. However, the obvious disadvantage for this configuration is that here two adjusters are needed instead of one.

By the use of a differential adjuster shaft, such as differential adjuster shaft 1 shown in FIG. 27, the need for an adjuster to provide a pulling torque can be eliminated while only using one adjuster. In FIG. 27, the power from the driving source is directed to the differential 212 through the engagement of power gear 210, keyed on differential adjuster input shaft 211, and the differential outer teeth 212-S1. Differential 212 has a differential shaft 213A and a differential shaft 213B, which are mounted in the same manner as the rear axles of a car are mounted on their rear differential. Using this mounting, the rotational position of differential shaft A 213A and differential shaft B 213B can be adjusted relative to the rotational position of the differential, in manner such that any rotation of differential shaft A 213A relative to the housing of the differential results in the same amount but oppositely directed rotation of the differential shaft B 213B relative to the housing of the differential and vice-versa. Then a transmission pulley PU2A 42A is keyed to differential shaft A 213A and transmission pulley PU2B 42B is keyed to differential shaft B 213B. In order to eliminate transition flexing and compensate for transmission ratio change rotation the rotational position of transmission pulley PU2A 42A relative to transmission pulley PU2B 42B needs to be controllably adjusted. In order to achieve this, an adjuster AD5 105, which has an adjuster body AD5 105-M1, fixed to an adjuster shaft A 214A, and an adjuster output member AD5 105-M2, fixed to an adjuster shaft B 214B, is used. Here adjuster AD5 105 is used to controllably adjust the rotational position of adjuster shaft A 214A relative to adjuster shaft B 214B. In order to eliminate transition flexing, adjuster AD5 105 needs to provide proper clockwise or counter-clockwise rotation. Here the amount of adjustment provided is measured by a relative rotational position sensor 133, which is mounted on the shaft end of adjuster body AD5 105-M1 so that it can measure the amount that adjuster output member AD5 105-M2 rotates relative to adjuster body AD5 105-M1. And in order to compensate for transmission ratio change rotation, adjuster AD5 105 continuously rotates the transmission pulley that tends to rotate clockwise relative to the other transmission pulley, clockwise at full capacity so as to provide more adjustment than required. Here when adjustment is required the active adjuster will provide adjustment and when not, the adjuster will simply stall or slip and flex the transmission belts within an acceptable limit. In order to ensure this, the torque of the adjusters should be small enough or a slipping clutch that ensures this can also be used. Adjuster shaft A 214A is then coupled to differential shaft A 213A through the engagement of an adjuster shaft gear 215, keyed on adjuster shaft A 214A, and a differential shaft gear 216, keyed on differential shaft A 213A. And like adjuster shaft A 214A, adjuster shaft B 214B is then also coupled to differential shaft B 213B through the engagement of a adjuster shaft gear 215 and a differential shaft gear 216.

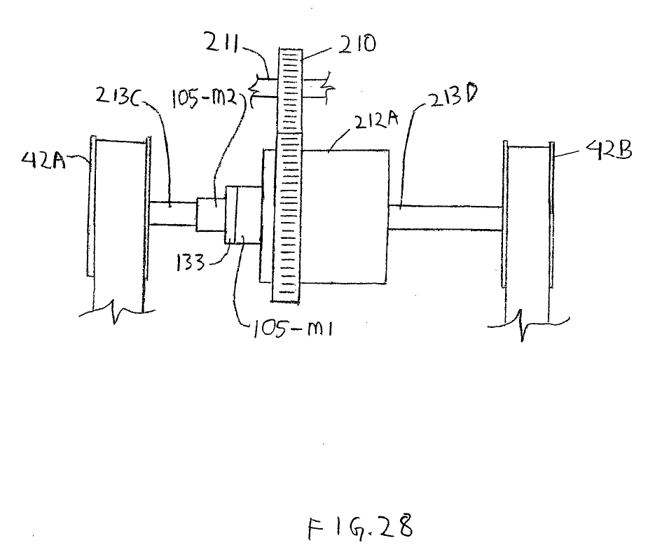

An alternate configuration for a differential adjuster shaft, which is referred to differential adjuster shaft 2, is shown in FIG. 28. This design is identical to differential adjuster shaft 1; except here, in order to control the rotational position between its differential shafts, which here are labeled as differential shaft C 213C and differential shaft D 213D, instead of using adjuster shafts coupled by gears, here the adjuster body AD5 105-M1 is fixed to the housing of its differential, which here is labeled as differential A 212A; and the adjuster output member AD5 105-M2 is keyed to differential shaft C 213C. And as in differential adjuster shaft 1, here a relative rotational position sensor 133 is mounted on the shaft end of adjuster body AD5 105-M1.

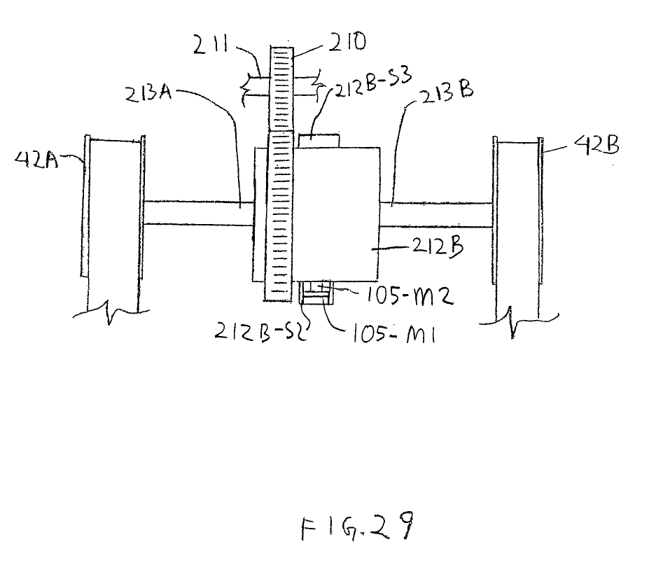

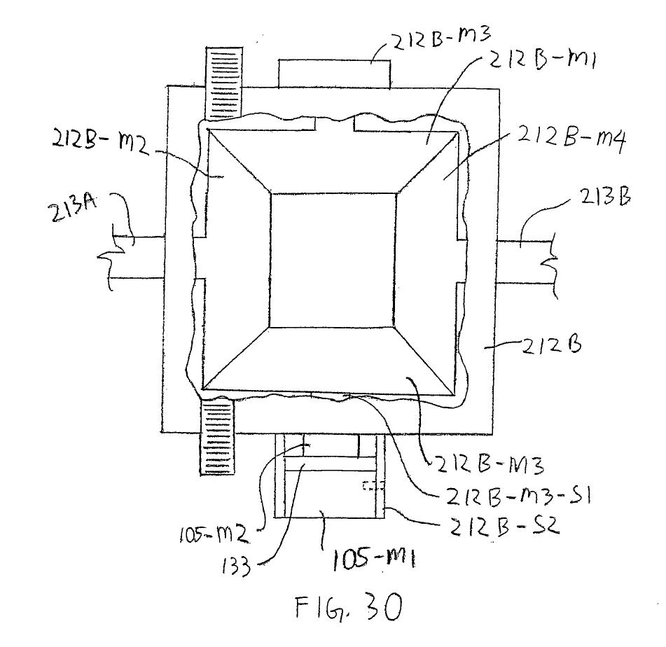

Another alternate configuration for a differential adjuster shaft, which is referred to differential adjuster shaft 3, is shown in FIG. 29. This design is identical to differential adjuster shaft 2; except here, in order to control the rotational position between the differential shafts, the rotational position of differential pinion, which here is labeled as differential B pinion 2 212B-M3 of its differential, which here is labeled as differential B 212B, is adjusted. The details of differential B 212B is shown in FIG. 30, it consists of differential B pinion 1 212B-M1 and differential B pinion 2 212B-M3, which are rotatable mounted on the housing of the differential and which engage with a differential B gear 1 212B-M2 and a differential B gear 2 212B-M4. Each differential gear is fixed to a differential shaft. Here differential B pinion 2 212B-M3 has a differential B pinion 2 shaft 212B-M3-S1, which extends through the housing of the differential. And to this shaft, the adjuster output member AD5 105-M2 is keyed, while the adjuster body AD5 105-M1 is fixed to the housing of the differential, via differential B attachment sleeve 212B-S2, which is shaped like a cylinder for which two opposite wall sections have been removed, see FIG. 29. And as in differential adjuster shaft 1, here a relative rotational position sensor 133 is mounted on the shaft end of adjuster body AD5 105-M1. In order to properly balance the differential, a differential B counter-weight 212B-S3 is fixed opposite of the adjuster AD5 105 on the housing of the differential. Furthermore, since the differential is rotating relative to the frame, the ring and brush connection described earlier can be used to transmit electrical signals from the computer to adjuster AD 105 via electrical rings mounted on the body of the differential and cables.

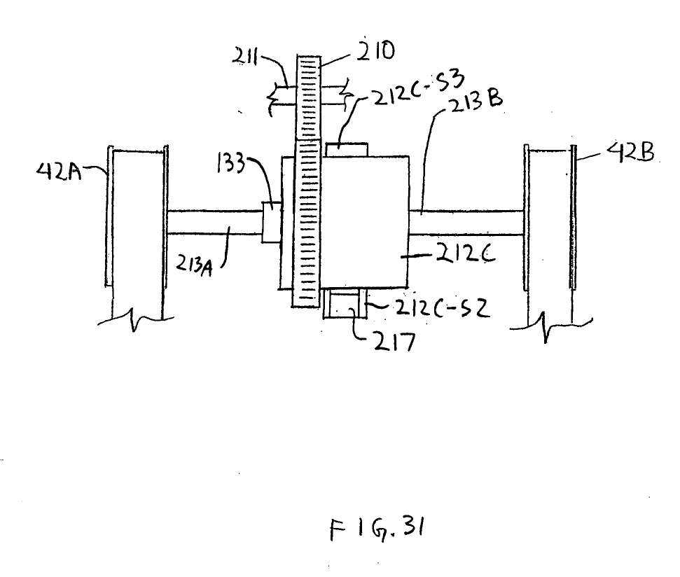

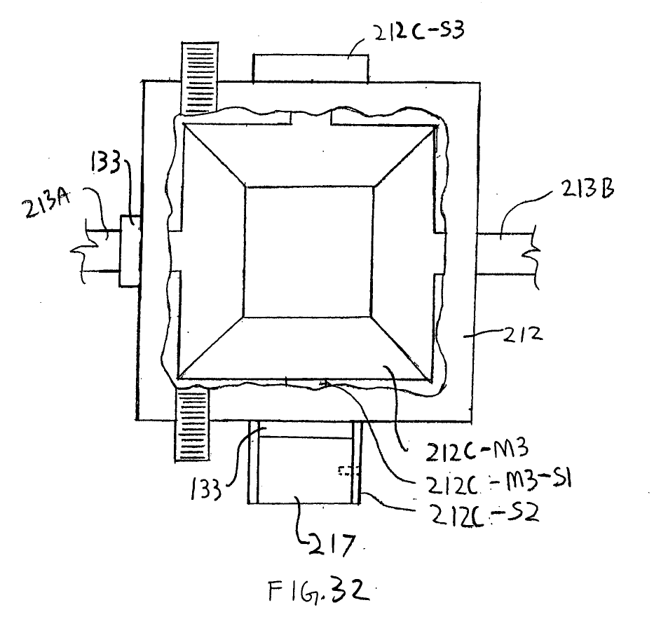

Another alternate configuration for a differential adjuster shaft, which is referred to differential adjuster shaft 4, is shown in FIG. 31. This design is identical to differential adjuster shaft 3, except here, no adjuster output member is attached to a pinion shaft of its differential and no adjuster body is attached to the differential, via an attachment sleeve. Instead, here a differential brake 217 is used to brake or release a pinion shaft of its differential, see FIG. 32, which shows the details of the differential used here, which is labeled as differential C 212C. In order to achieve this, differential brake 217 has a differential brake pad, not shown, which can be controlled to brake or release differential C pinion 2 shaft 212C-M3-S1 of differential C pinion 2 212C-M3. And in order to properly balance the differential, a differential C counter-weight 212C-S3 is fixed opposite of the differential brake 217 on the housing of the differential. And in order to control differential brake 217, the computer of the CVT is used. Since the differential is rotating relative to the frame, the ring and brush connection described earlier can be used to transmit electrical signals from the computer to the differential brake via electrical rings mounted on the differential. Braking the differential C pinion shaft 2 212C-M3-S1 locks the differential, so that no relative rotation between the differential shafts 213A and 213B, and the housing of the differential is allowed. And releasing the pinion shaft releases the differential, and this allows the differential shafts to rotate freely relative to the housing of the differential. The differential should be locked under all conditions, except in instances where the rotational position of the transmission pulleys relative to each other need to be adjusted in order to eliminate transition flexing and during transmission ratio change. As described earlier, in order to eliminate transition flexing, the rotational position between the transmission pulleys is adjusted while only one torque transmitting member is in contact with its transmission belt. In this instance, the pulling load on the transmission pulleys is different, one pulley is transmitting torque while the other is not. So by releasing the differential, the rotational position between the transmission pulleys can be adjusted. And in order to accurately adjust

the rotational position between the transmission pulleys, a relative rotational position sensor 133 is mounted on the housing of differential C 212C so that it can measure the amount that differential shaft 213A rotates relative to the housing of differential C 212C. Furthermore, as described earlier, during transmission ratio change, it is desirable to maintain an equal pulling load on the transmission pulleys, and releasing the differential will achieve this, since here the pulley that is transmitting more torque is forced to rotate slower than the other pulley, and this increases the pulling load on the other pulley. In any case, since releasing the differential allows free relative rotation between the transmission pulleys, excessive stresses in the transmission belts due to transmission ratio change rotation can not occur.

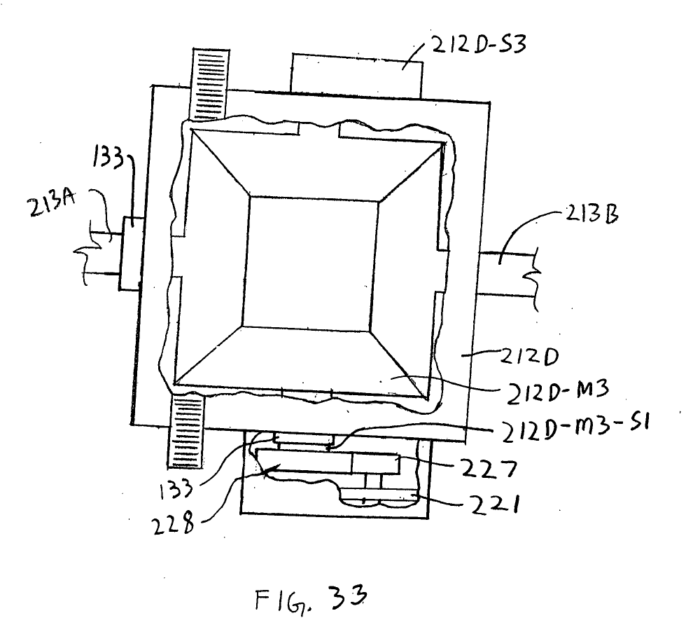

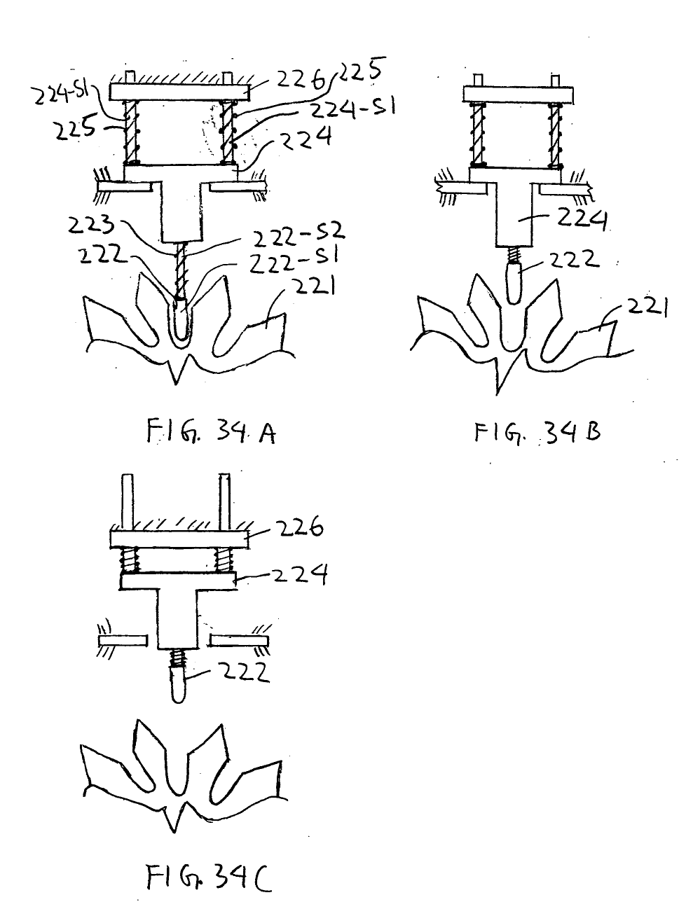

In addition, for differential adjuster shaft 4, it is difficult to accurately control the relative rotational position between the differential shafts using the differential brake 217. Since when differential C pinion shaft 2 212-M3-S1 is rotating, it does not stop immediately after the brake is applied. In order to better control differential adjuster shaft 4 using the same locking and releasing method an index wheel mechanism shown partially in FIGS. 33, 34A, 34B, and 34C might be used. Like the differential brake, the index wheel mechanism is used to lock or release its differential, which here is labeled as differential D 212D, see FIG. 33. The Index wheel mechanism consist of an index wheel mechanism frame 220, an index wheel 221, a locking pin 222, a locking pin spring 223, a solenoid A 224, a solenoid A spring 225, and a solenoid B 226. The index wheel 221, which rotational movements is controlled by locking pin 222, solenoid A 224, and solenoid B 226, is used to control the rotational movements of differential D pinion 2 212D-M3. In order to achieve this, index wheel 221 can be keyed to differential D pinion 2 shaft 212-M3-S I. However, in order to increase the resolution of the index wheel mechanism, it is recommended that one or several set of gears, that reduces the amount of rotation of the index wheel that is transmitted to the pinion shaft are used. In FIG. 33, which shows a partial side-view of differential 212D, which utilizes the index wheel mechanism, the rotational output of index wheel 221 is reduced by using a small index wheel mechanism gear 227 that is coupled to a large index wheel mechanism gear 228. The large index wheel mechanism gear 228 is then keyed to differential D pinion 2 shaft 212-M3-S1. More gears can be used for further refinements. And in order to properly balance the differential, a differential D counter-weight 212D-S3 is fixed opposite of the index wheel mechanism on the housing of the differential.

The physical description of the index wheel mechanism is described below. A partial top-view of the index wheel mechanism is shown in FIG. 34A. In order to lock index wheel 221, locking pin 222 is inserted into a groove of index wheel 221, see FIG. 34A. Locking pin 222 consist of two shapes, a locking pin lock 222-S1 and a locking pin rod 222-S2. The locking pin rod 222-S2 is slideably inserted into a matching hole of solenoid A 224, so that it can only slide axially relative to solenoid A 224. However, before locking pin rod 222-S2 is inserted, a locking pin spring 223 is slid into locking pin rod 222-S2. The locking pin spring 223 forces locking pin lock 222-S1 away from solenoid A 224. Furthermore, locking pin lock 222-S1 is magnetized, so that by energizing solenoid A 224, locking pin lock 222-S1 can be pulled towards solenoid A 224. In addition, on the surface of solenoid A 224, which is facing away from index wheel 221, two solenoid A rods 224-S1 exist. The solenoid A rods 224-S1, are slideably inserted into a matching holes of solenoid B 226 so that they can only slide axially relative to solenoid B 226. However, before the solenoid A rods 224-S1 are inserted, a solenoid A spring 225 is slid into each solenoid A rod 224-S I. The solenoid A springs 225 force solenoid A 224 away from solenoid B 226.

The operation of the index wheel mechanism, which is used to either lock or release index wheel 221, is described below. The locking position of the index wheel mechanism is shown in FIG. 34A. Here locking pin lock 222-S1 is positioned inside a groove of index wheel 221, and this prevents index wheel 221 from rotating. In order to stepwise control the rotational position of index wheel 221, solenoid A 224 is energized. This lifts locking pin lock 222-S1 out of the groove of index wheel 221, but not out of the triangular portion of that groove, see FIG. 34B. Here by using a pulse signal for solenoid A, the index wheel 221 is released one groove at a time. This method can be used to adjust the rotational position between the transmission pulleys to adjust for transition flexing. The amount of adjustment provided can be determined from the amount of pulse signals provided, or from a relative rotational position sensor 133 mounted on the housing of differential D 212D so that it can measure the amount that differential shaft 213A rotates relative to the housing of differential D 212D. And in order to completely release the index wheel, solenoid A 224 and solenoid B 226 should be energized. This lifts locking pin lock 222-S1 out of the triangular portion of its groove, see FIG. 34C. This method should be used during transmission ratio change. Although releasing the index wheel can also be accomplished by continuously energizing solenoid A 224, it is preferably to also use solenoid B 226. By only energizing solenoid A 224, the locking pin lock 222-S1 is not lifted out of the triangular portion of the index wheel, so that loss of energy due to the compression of the solenoid A spring 225 occurs as the index wheel is rotating.

Furthermore, since the index wheel mechanism is rotating relative to the frame where its controlling computer is attached, the ring and brush connection described earlier can be used to direct signals from the computer to the solenoids.

Furthermore, in order to change the transmission ratio unless the axial position of the cones can be changed, the axial position of the transmission pulleys need to be changed. In order to emphasize the function of the differential adjuster shaft in addressing the transition flexing and transmission ratio change issue, such detail have been previously omitted. In the following paragraphs, details on how to allow the axial position of the differential adjuster shaft mounted transmission pulleys to be changed will be described. The following details can be applied to any of the differential adjuster shafts described earlier.

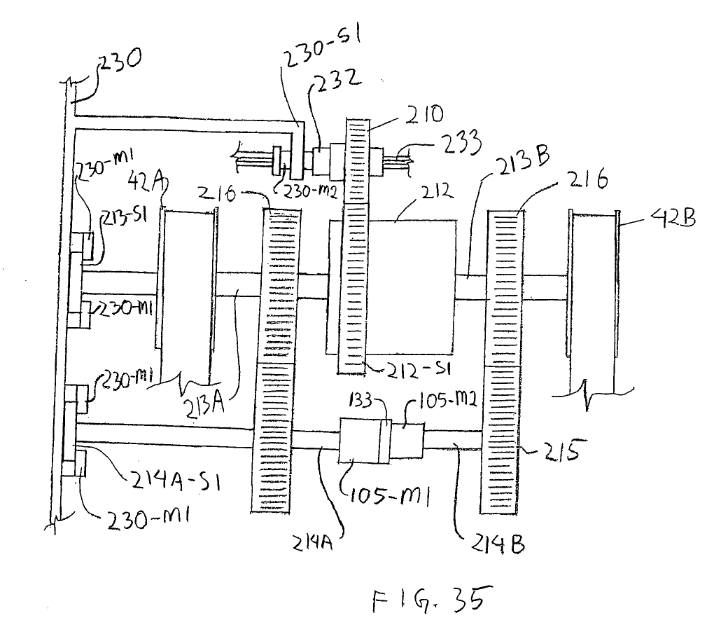

A simple method to allow the axial position of the differential adjuster shaft mounted transmission pulleys to be changed can be achieved by simple connecting the differential adjuster shaft and its adjuster shaft, if applicable, to a mover frame 230, which is connected to the mover gear rack 231 which engages a transmission ratio gear that is used to control the transmission ratio, see FIG. 35. Here the differential adjuster shaft and the adjuster shaft should be connected to mover frame 230 so that they move axially with the mover frame but are allowed to rotate relative to the mover frame. This can be achieved by simple having a differential shaft flange 213A-S1 and an adjuster shaft flange 214A-S1 at the end of the shafts. The mover flanges, can than be inserted into a matching cavity in mover frame 230 and secured by mover frame flange plates 230-M1, which are partially glued to mover frame 230. Also since here it might be unpractical to have differential adjuster input shaft 211 move axially with the mover frame 230. The input gear 210 can be mounted on an input gear sleeve 232, which can slide axially on an input gear spline 233, which is used instead of differential adjuster input shaft 211. The input gear sleeve 232 can then be connected by the use of mover arm 230-S1, which has a mover arm bearing 230-M2, to mover frame 230 so that it moves axially with the mover frame. Here mover arm bearing 230-M2 is used to allow the input gear sleeve 232 to rotate relative to the mover arm 230-S1. A more detailed description of the input gear sleeve 232 can be found in the next paragraph which describes in detail the configuration of a differential spline sleeve 241, which is nearly identical to the input gear sleeve 232.

Another configuration that allows the axial position of the differential adjuster shaft mounted transmission pulleys to be changed is shown in FIG. 36. Here differential shaft A 213A is replaced with differential spline A 240A and differential shaft B 213B is replaced with differential spline B 240B. In addition, here each transmission pulleys is keyed to a differential spline sleeve 241 using a differential spline set-screw 241-M1, so that they are rotatably and axially fixed relative to their differential spline sleeve. The differential spline sleeves 241 have a splined profile that matches the profile of a differential spline 240A and 240B; so that the differential spline sleeves can slide axially relative to their differential spline, but can not rotate relative to their differential spline. Each differential spline sleeve 241 consists of two main shapes, a differential spline sleeve pulley mount shape 241-S1 and a differential spline sleeve bearing mount shape 241-S2. Each differential spline sleeve pulley mount shape 241-S1 is shaped like a round cylinder that has a radial oriented threaded hole that does not extruded through the inner surface of the differential spline sleeve. This hole will be used for a differential spline sleeve set-screw 241-M1. The differential spline sleeve bearing mount shape 241-S2 is also shaped like a round cylinder; however, it is smaller in diameter than the differential spline sleeve pulley mount shape 241-S1 so that a shoulder is formed between the differential spline sleeve pulley mount shape 241-S1 and the differential spline sleeve bearing mount shape 241-S2. Furthermore, the free end of differential spline sleeve bearing mount shape 241-S2 is threaded. The transmission pulleys 42A and 42B are each mounted on their differential spline sleeve pulley mount shape 241-S1 and secured using a differential spline sleeve set-screw 241-M1. And a mover arm A bearing 242-M1, which is a thrust bearing that is tightly inserted into a matching hole of each mover arm A 242-S1 so as to prevent any relative movements between them, is slid into each differential shaft sleeve bearing mount shape 241-S2. Then a differential spline sleeve nut 241-M2 is threaded onto the threaded end of each differential shaft sleeve bearing mount shape, so that the mover arm A bearings 242-M1 are tightly sandwiched between the shoulder formed by their differential spline sleeve pulley mount shape 241-S1 and their differential spline sleeve bearing mount shape 241-S2, and their differential spline sleeve nut 241-M2. Under this set-up, the axial position of the differential spline sleeves 241 depend on the axial position of their mover arms A 242-S1. Also, here the mover arm A bearings 242-M1 allow their differential spline sleeves 241 to rotate without much frictional resistance relative to their mover arms A 242-S1. The mover arms A 242-S1 are then connected to a mover rod 242-S2, which is part of a mover frame A 242, which is used to change the axial position of the torque transmitting members and the transmission pulleys via a gear rack A 243. This mounting configuration can be used for differential adjuster shafts 2, 3, and 4.

In order to support the differential adjuster shafts, support bearings positioned so that they do not interfere with its operation of can be used. As before, the method of supporting the shafts will not be explained in this application, since the technique to do this is well known and a details for this will unnecessarily complicated the description for the invention without adding to the essence of the invention.

Spring-Loaded Adjuster

Another simple method to eliminate transition flexing is by using a spring-loaded adjuster that biases a spring-loaded adjuster mounted torque transmitting member towards a neutral position from which it can rotate clockwise and counter-clockwise relative to the shaft on which it is attached. Here first a spring-loaded adjuster AS1 171, which can be used to replace the adjusters AD1A 101A or AD1B 101B of CVT 1.1 will be described, then a spring-loaded adjuster AS2 172 that can be used as an adjuster AD4 104 for CVT 2.4 will be described. Also in order for a spring-loaded adjuster to work properly it is recommended that a tooth shape that has an apex, such as an involute tooth shape is used for torque transmission.

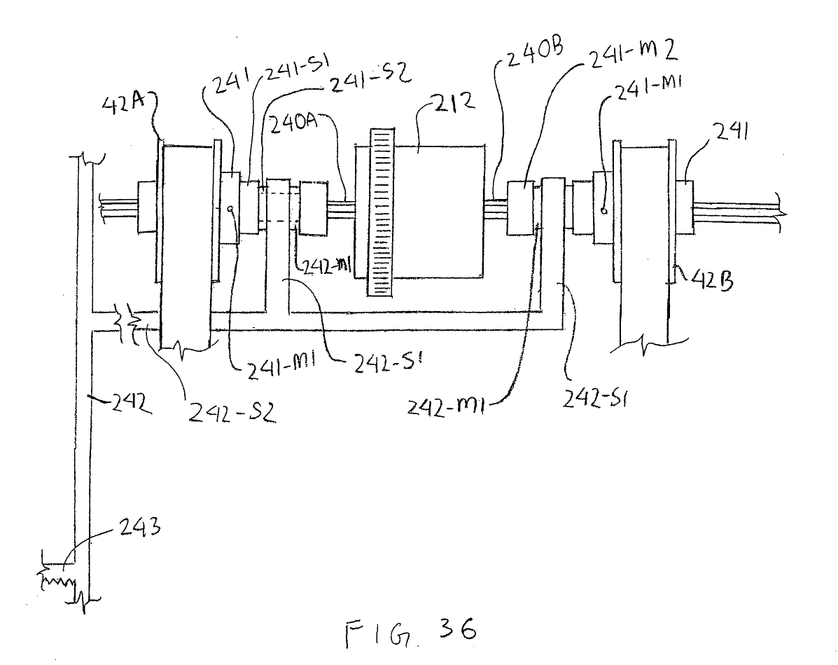

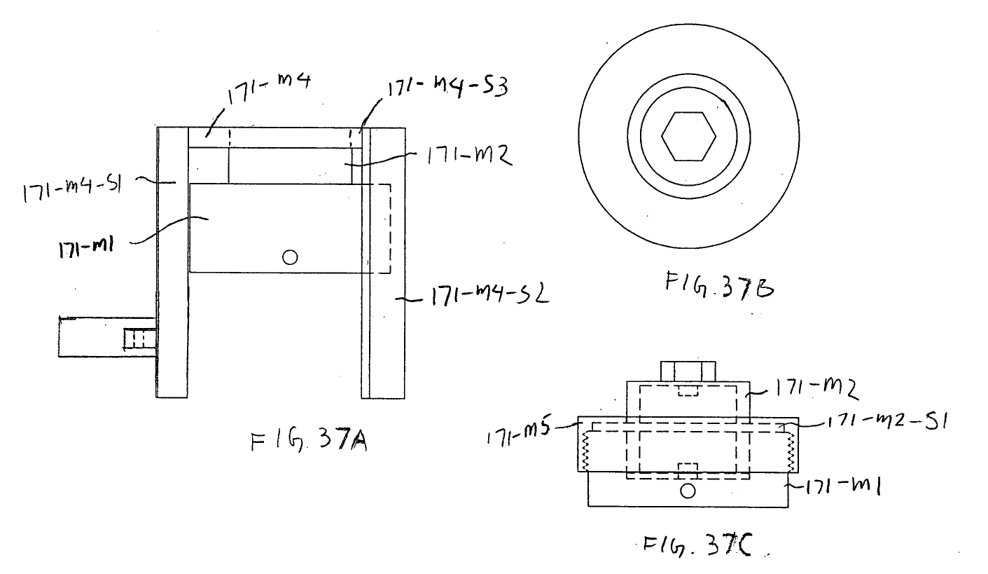

Spring-Loaded Adjuster AS1 171 (FIG. 37A-37D)

Another simple method to eliminate transition flexing is by having a parallel gap in the slots where the attachment pins used to attach a torque transmitting member to its cone assembly are inserted; and using a spring-loaded adjuster to bias the attachment pins of the gap mounted torque transmitting member towards the center of the gap. This allows for some rotational movement of the gap mounted torque transmitting member in instances where the pitch diameter of the gap mounted torque transmitting member is increased and decreased. In order to achieve this, a spring-loaded adjuster AS1 171 is needed. The spring-loaded adjuster AS1 171 consists mainly of a spring-loaded adjuster shaft 171-M2 that can rotate relative to a spring-loaded adjuster body 171-M1, and is biased by an adjuster spring 171-M3 towards a neutral position, see FIG. 37D. Also in order to mount the telescopes of a gap mounted torque transmitting member to the spring-loaded adjuster shaft 171-M2, a shaft end attachment 171-M4 is attached to the end of the spring-loaded adjuster shaft, see FIG. 37A. The shaft end attachment consist mainly of three shapes that form an inverted U-shape. One leg of the inverted U-shape, which is labeled as shaft end attachment extension arm 171-M4-S1, is shaped like the long leg of the adjuster extension arm AD1A-M2-S2 101A-M2-S2 of adjuster AD1A 101A of CVT 1.1, see FIG. 4, and is used in the same manner, hence it also has a constrainer mechanism CN1A 111A. The other leg of the inverted U-shape, which is labeled as shaft end attachment balancing arm 171-M4-S2, is shaped like the long leg of the adjuster balancing arm AD1A-M2-S3 101A-M2-S3 and is used to balance the centrifugal forces of the shaft end attachment extension arm 171-M4-S1 and its attachments. And the top horizontal member of the inverted U-shape, which is labeled as shaft end attachment mounting plate 171-M4-S3, is shaped like elongated rectangular plate that has a hexagonal cavity at its center. The hexagonal cavity of the shaft end attachment mounting plate 171-M4-S3 is used to securely press in a matching hexgonal notch located at the top end of the spring-loaded adjuster shaft 171-M2, see FIG. 37B. The spring-loaded adjuster body 171-M1 is basically shaped like a hollow cylinder, which has an open top end and a closed bottom end. And the spring-loaded adjuster shaft 171-M2 is basically shaped like a hollow cylinder, which has an open bottom end and a closed top end, see FIGS. 37C and 37D. The inner top end of the spring-loaded adjuster shaft 171-M2 and the bottom end of the spring-loaded adjuster body 171-M1, each have a square shaped notch, which function will be explained later. And the outer top end of the spring-loaded adjuster shaft 171-M2 has a hexagonal notch, which is used to attach the shaft end attachment 171-M4. The outer diameter of the spring-loaded adjuster shaft 171-M2 is slightly smaller than the inner diameter of the spring-loaded adjuster body 171-M1, so that when the spring-loaded adjuster shaft 171-M2 is inserted into the spring-loaded adjuster body 171-M1, only significant rotational movements between them is allowed. Also, the outer surface of the top end portion of the spring-loaded adjuster body is threaded. And the outer surface of the spring-loaded adjuster shaft 171-M2 has a spring-loaded adjuster flange 171-M2-S1, which diameter is slightly smaller than the outside diameter of the spring-loaded adjuster body. The spring-loaded adjuster flange 171-M2-S1 is positioned somewhere between the top end and the bottom end of the spring-loaded adjuster shaft 171-M2. The spring-loaded adjuster flange 171-M2-S1 should be positioned so that a sufficient amount of the spring-loaded adjuster shaft 171-M2 can be inserted into the spring-loaded adjuster body 171-M1 so that sufficient amount of moment and deflection can be resisted by the assembled spring-loaded adjuster AS1 171. An adjuster spring 171-M3 is inserted into the cavity formed by the inner top end surface and inner side surface of the spring-loaded adjuster shaft, and the inner bottom end surface and the bottom portion of the inner side surface of the spring-loaded adjuster body. At both ends of the adjuster spring 171-M3, the wire of the adjuster spring is shaped such that a square shaped loop, on which the square notches of the spring-loaded adjuster shaft and the spring-loaded adjuster body can be tightly inserted, is formed. The length of the adjuster spring 171-M3 is designed such that when the spring-loaded adjuster flange 171-M2-S1 is engaged with the top end surface of the spring-loaded adjuster body, the top end and the bottom end of the adjuster spring is always in contact with the top surface of the spring-loaded adjuster shaft 171-M2 and the bottom surface of the spring-loaded adjuster body 171-M1.

In order to securely fix the axial position of the spring-loaded adjuster shaft 171-M2 relative to the spring-loaded adjuster body 171-M1, a spring-loaded adjuster cap 171-M5 is used. The spring-loaded adjuster cap 171-M5 is shaped like a short cylinder, which has a top surface but not a bottom surface. The top surface of the spring-loaded adjuster cap has a hole at its center, which diameter is slightly larger than the diameter of the spring-loaded adjuster shaft 171-M2, but smaller than the diameter of the spring-loaded adjuster flange 171-M2-S1. And the inner side surface of the spring-loaded adjuster cap 171-M5 has internal threads that can engage with the external threads of the spring-loaded adjuster body 171-M1.

The spring-loaded adjuster 171 is assembled by first inserting the adjuster spring 171-M3 into the spring-loaded adjuster body 171-M1 such that the bottom square shaped loop of the spring-loaded adjuster spring is fully inserted into the square shaped notch of the spring-loaded adjuster body. Then the spring-loaded adjuster shaft 171-M2 is slid into the spring-loaded adjuster body 171-M1, in a manner such that the open end of the spring-loaded adjuster shaft is facing the open end of the spring-loaded adjuster body, and the top square shaped loop of the spring-loaded adjuster spring 171-M3 is fully inserted into the square shaped notch of the spring-loaded adjuster shaft 171-M2. Then the spring-loaded adjuster cap 171-M5 is inserted through the top-end of the spring-loaded adjuster shaft 171-M2 and tighten unto the spring-loaded adjuster body 171-M1 through the engagement of the internal threads of the spring-loaded adjuster cap with the external threads of the spring-loaded adjuster body. The spring-loaded adjuster cap 171-M5 should be tighten unto the spring-loaded adjuster body 171-M1 until the inner top surface of the spring-loaded adjuster cap pushes the spring-loaded adjuster flange 171-M2-S1 of the spring-loaded adjuster shaft 171-M2 towards the top surface of the spring-loaded adjuster body 171-M1, so that axial movements between the spring-loaded adjuster shaft 171-M2 and the spring-loaded adjuster body 171-M1 is minimized. Since the spring-loaded adjuster shaft has to rotate relative to the spring-loaded adjuster body, friction between the engaging surfaces of the spring-loaded adjuster cap, the spring-loaded adjuster shaft, and the spring-loaded adjuster body should be minimized. This can be done by coating the engaging surfaces of the spring-loaded adjuster flange of the spring-loaded adjuster shaft with bronze. However in order to prevent the spring-loaded adjuster cap from loosening, no low friction coating should be applied to internal and external threads. Next in order to be able to properly mount the telescopes of a gap mounted torque transmitting member and a constrainer mechanism to the spring-loaded adjuster shaft 171-M2, the shaft end attachment 171-M4 is attached to the spring-loaded adjuster shaft. In order to achieve this, the hexagonal notch at the outer top surface of the spring-loaded adjuster shaft 171-M2 is pressed into the hexagonal cavity of the shaft end attachment mounting plate 171-M4-S3. Here the dimension of the hexagonal cavity should be slightly smaller than the dimension of the hexagonal notch, so that sufficient friction between them, as to prevent any axial movements between them, is developed when separating forces encountered during normal operation is applied to them.

Spring-Loaded Adjuster AS2 172 (FIGS. 38A & 38B)

The spring-loaded adjuster AS2 172, shown in FIGS. 38A and 38B, can be used to replace the adjuster AD4 104 in CVT 2.5. The spring-loaded adjuster AS2 172 is identical to the spring-loaded adjuster AS1 171, except that here two radially opposite positioned threaded holes for two limiter rods 172-M1, are drilled into the spring-loaded adjuster shaft 171-M2. And two pairs of radially opposite positioned cylindrical limiter notches 172-M2 are welded on to the outer top surface of the spring-loaded adjuster cap 171-M5. The limiter rods 172-M1 and the limiter notches 172-M2 should be positioned, such that the adjuster spring 171-M3 biases each limiter rod towards the midpoint of the space created between a pair of limiter notches 172-M2. Also here the hexagonal notch of the spring-loaded adjuster shaft 171-M2 is not used to attach shaft end attachment 171-M4, but it is used to mount a cone assembly, which here should have a matching square opening, which should have a dimension such that sufficient friction between the notch and the opening exist as to prevent any significant relative movements between the cone assembly and its spring-loaded adjuster shaft. This adjuster can be further modified by drilling a hole through its entire length. Through this hole a shaft can be slid through. The hole can also have a notch for a key at its spring-loaded adjuster body, which can be used to key the spring-loaded adjuster body to its shaft.

Mechanical Adjuster

In this section a design for a mechanical adjuster AM1 181, that can be used as an adjuster AD4 104, and a mechanical adjuster AM2 182, that can be used as transition flexing adjuster AD1 101 is described. Since it is simpler, here the mechanical adjuster AM1 181, which is for CVT 2.5, will be described before the mechanical adjuster AM2 182, which is for CVT 1.1, is described.

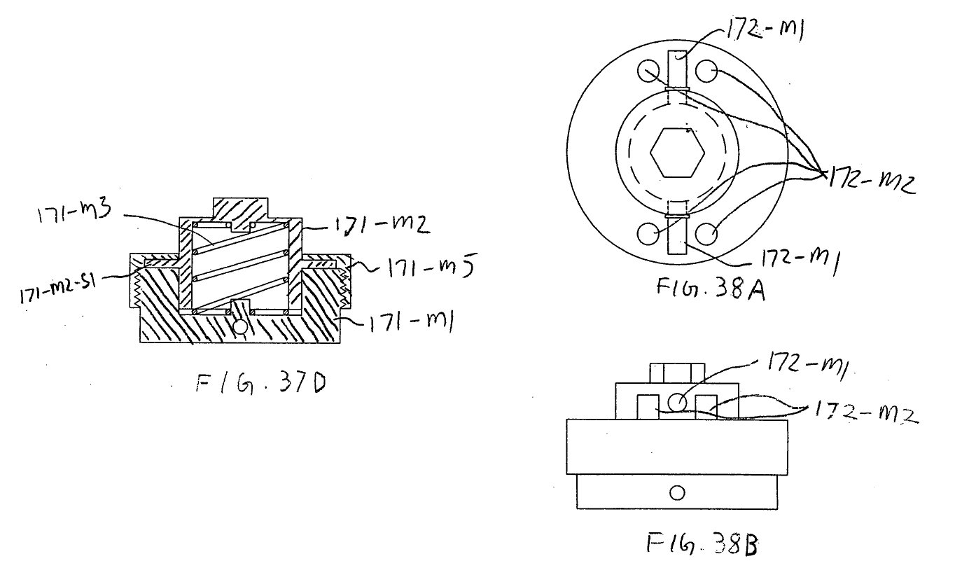

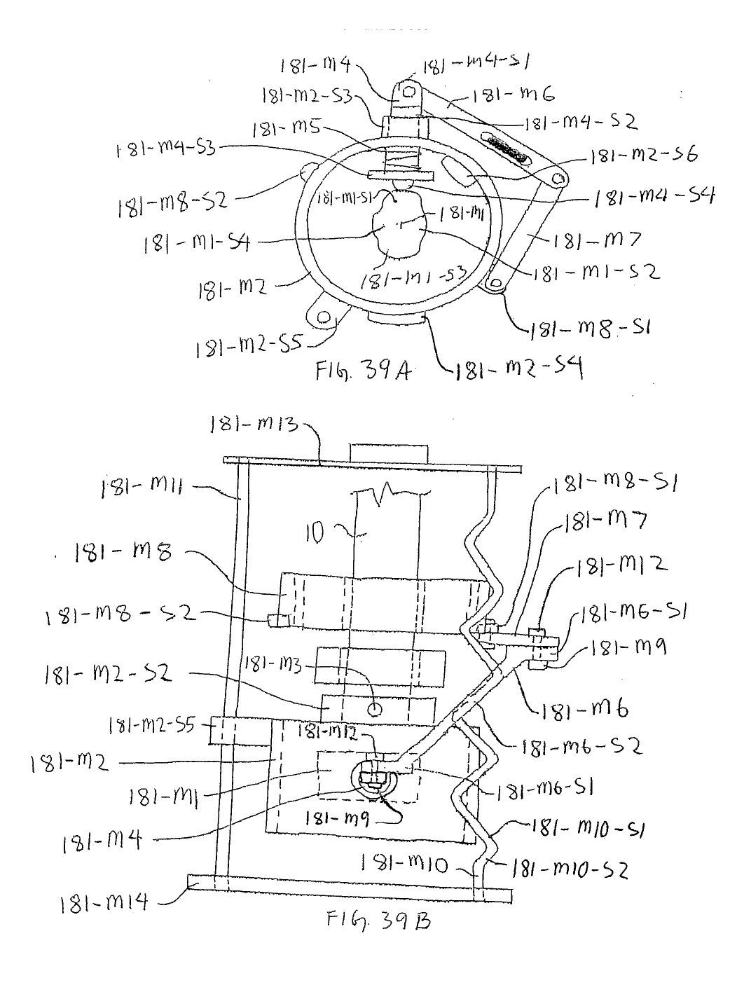

Mechanical Adjuster AM1 181 (FIGS. 39A, 39B, 40, and 41)

Like the electrical adjuster 160, the mechanical adjuster AM1 181, which is shown in FIGS. 39A and 39B, mainly consists of an adjuster body and an adjuster output member. However here, the rotational position between them is controlled by an adjustable ratio cam mechanism instead of an electrical motor. Here the adjuster body consist mainly of a cam 181-M1, cam sleeve 181-M2, a follower 181-M4, and a follower spring 181-M5. The cam 181-M1 is stationary relative to the shaft where the mechanical adjuster AM1 181 is used. The cam 181-M1 consist mainly of four shapes. The top shape of the cam, top cam shape 181-M1-S1, and the bottom shape of the cam, bottom cam shape 181-M1-S3, have a diameter Dc. The right shape of the cam, right cam shape 181-M1-S2 has a diameter D1, and the left shape of the cam, left cam shape 181-M2-S4, also has a diameter D1. Here the diameter Dc is larger than the diameter D1. Between the different shapes of the cam, transition shapes exist so that cam 181-M1 has-a smooth continuous surface. The cam sleeve 181-M2 is shaped like a hollow cylinder, which has an open end and a closed end. The closed end of the cam sleeve 181-M2 is shaped like a disk that has an cam sleeve attachment sleeve 181-M2-S2, which is used to attach the shaft where the mechanical adjuster AM1 181 is used, which here is labeled as shaft SH0 10. In order to fix the cam sleeve 181-M2 axially and rotatably to shaft SH0 10, cam sleeve attachment sleeve 181-M2-S2 has a threaded hole for a cam sleeve set screw 181-M3. In addition, cam sleeve 181-M2 has a radial hole, through which follower 181-M4 is inserted. And on top of the radial hole of cam sleeve 181-M2, a cam sleeve constrainer sleeve 181-M2-S3, which has the same inside diameter as the radial hole exist. Also, in order to balance the centrifugal forces due to cam sleeve constrainer sleeve 181-M2-S3, cam follower 181-M4, and portions of the centrifugal forces due to a link AM1-M6 181-M6 and a link AM1-M7 181-M7, a cam sleeve counter-weight 181-M2-S4 is shaped opposite of the cam sleeve constrainer sleeve 181-M2-S3 on the surface of constrainer sleeve 181-M2. Also extending radially outwards from the surface of the cam sleeve 181-M2 is a controller rod counter-weight arm 181-M2-S5. The controller rod counter-weight arm 181-M2-S5 has a hole through which a controller rod counter-weight 181-M11 will be slid through, so as to constrain the rotational position of the controller rod counter-weight 181-M11 relative to cam sleeve 181-M2. The controller rod counter-weight arm 181-M2-S5 is positioned so that a controller rod 181-M11 can be properly slid through the controller slot of the link AM1-M6 181-M6. Also in order to balance the centrifugal forces of the controller rod counter-weight arm 181-M2-S5, a counter-weight arm counter-weight 181-M2-S6 is positioned opposite of the controller rod counter-weight arm 181-M2-S5. The counter-weight arm counter-weight 181-M2-S6 is positioned on the inside surface of cam sleeve 181-M2, so that it does not interfere with the movements of link AM1-M6 181-M6. The follower 181-M4 consist mainly of four shapes. The top shape of the follower, which is labeled as follower top 181-M4-S1, is shaped like a flat bar that has a hole. The shape below it, which is labeled as follower round 181-M4-S2, is shaped like a round rod. During normal operation of the mechanical adjuster AM1 181, this shape of the follower is in contact with the radial hole and the hole of the constrainer sleeve 181-M2-S3 of cam sleeve 181-M2. Follower round 181-M4-S2 should have a dimension such it can only move radially in and out relative to cam sleeve 181-M2. The shape below it, which is labeled as follower shoulder 181-M4-S3, is the shoulder of follower 181-M4. It is shaped like a round disk, which diameter is larger than the diameter of the shape above it. And the bottom shape, which is labeled as follower bottom 181-M4-S4, is shaped like a half sphere. In the mechanical adjuster AM1 181 assembled state, cam 181-M1, which is stationery relative to the shaft, is inserted into the open end of cam sleeve 181-M2 such that they are concentric. And in order to ensure that the follower 181-M4 is always in contact with cam 181-M1, a follower spring 181-M5 is placed between the inner surface of cam sleeve 181-M2 and follower shoulder 181-M4-S3.

The adjuster output member of the mechanical adjuster AM1 181 is shaped like disk, and it will be referred to as the output disk 181-M8. The output disk 181-M8 has two opposite positioned bolt holes, which will be used to attach a cone assembly or a transmission pulley to the output disk. In addition, output disk 181-M8 has an output disk arm 181-M8-S1, which is a radial extension that has a hole. And in order to balance the centrifugal force due the output disk arm 181-M8-S1, and portions of the centrifugal forces due to link AM1-M6 181-M6 and link AM1-M7 181-M7, an output disk counter-weight 181-M8-S2 is shaped opposite of the output disk arm 181-M8-S2 on the surface of output disk 181-M8. In order to control the relative rotation between cam sleeve 181-M2 and output disk 181-M8, a link AM1-M6 181-M6 and link AM1-M7 181-M7, which connect the cam sleeve to the output disk, are used. Link AM1-M6 181-M6 is shaped like a monkey wrench. It has a middle shape, and two end shapes. Each end shape, which is labeled as link shape AM1-M6-S1 181-M6-S1, is shaped like a square plate that has a hole. And the middle shape, which is labeled as link shape AM1-M6-S2 181-M6-S2, is shaped like a slender rectangular plate that has a controller slot. The end shapes are parallel relative to each other but the middle shape is positioned diagonally relative to the end shapes. The other link, link AM1-M7 181-M7 is shaped like flat and slender bar that has two link holes at each of its ends. In addition, the ends of link AM1-M7 181-M7 have a half disk shape, which center is positioned at the center of the holes of link AM1-M7 181-M7.

In order for link AM1-M6 181-M6 and link AM1-M7 181-M7 to connect the cam sleeve 181-M2 to the output disk 181-M8, one end of link AM1-M6 181-M6 is connected to follower 181-M4 by inserting a link bolt 181-M9 through the hole of follower 181-M4, and then securing that bolt using a link nut 181-M12. And the other end of link AM1-M6 181-M6 is connected to one end of link AM1-M7 181-M7 by inserting a link bolt 181-M9 through the other hole of link AM1-M6 181-M6 and a hole of link AM1-M7 181-M7, and then securing that link bolt using a link nut 181-M12. And the other end of link AM1-M7 181-M7 is connected to the output disk arm 181-M8-S1 by inserting a link bolt 181-M9 through the other hole of link AM1-M7 181-M7 and the hole of the output disk arm 181-M8-S1, and then securing that link bolt using a link nut 181-M12. The surfaces of the link bolts and the link nuts that are in contact with follower 181-M4, link AM1-M6 181-M6, link AM1-M7 181-M7, or output disk arm 181-M8-S1, are preferably coated with a low friction material such as oil-impregnated bronze, so that the link AM1-M6 181-M6 and link AM1-M7 181-M7 can rotate without much frictional resistance.

In order to control the relative rotation between cam sleeve 181-M2 and output disk 181-M8, a controller rod 181-M10 is used. The controller rod 181-M10 is a slender steel rod that is bent repeatedly such that a zigzag profile is formed. The zigzag profile consist of two alternating shapes, a pivot shape 181-M10-S1 and a parallel shape 181-M10-S2, that can

be slid through the controller slot of link AM1-M6 181-M6. The angle between the pivot shape 181-M10-S1 and the parallel shape 181-M10-S2 should be 90°. The pivot shapes 181-M10-S1 are positioned perpendicular to the long surfaces of link AM1-M6 181-M6, so that they can act as pivots for link AM1-M6 181-M6. And the parallel shapes 181-M10-S2 are positioned parallel to the long surfaces of link AM1-M6 181-M6, so that they can act as constrainers for link AM1-M6 181-M6. The function of the controller rod 181-M10 is to properly adjust the rotation of the output disk 181-M8 relative to the cam sleeve 181-M2 due the profile of the cam 181-M1, by adjusting the pivot location of link AM1-M6 181-M6 or by constraining link AM1-M6 181-M6. By changing the axial position of the controller rod 181-M10 relative to link AM1-M6 181-M6, it can be selected whether a pivot shape 181-M10-S1 or a parallel shape 181-M10-S2 is positioned inside the controller slot of link AM1-M6 181-M6. In instances where a pivot shape 181-M10-S1 is located in the controller slot of link AM1-M6 181-M6, the position of the pivot for link AM1-M6 181-M6 can be changed by changing the axial position of the controller rod 181-M10 relative to link AM1-M6 181-M6. And changing the position of the pivot for link AM1-M6 181-M6, by changing the axial position of controller rod 181-M10 relative to link AM1-M6 181-M6, changes the amount of relative rotation between cam sleeve 181-M2 and output disk 181-M8 due to the profile of cam 181-M1. Furthermore, by inserting a parallel shape 181-M10-S2 into the controller slot of link AM1-M6 181-M6, link AM1-M6 181-M6 is constrained from pivoting, so that despite the profile of cam 181-M1, no relative rotation between cam sleeve 181-M2 and output disk 181-M8 exist. When follower 181-M4 is in contact with a diameter D1 of cam 181-M1, a positive angle, which is referred to as the controller angle, is formed between the flat profile of the controller rod 181-M10 and the controller slot of link AM1-M6 181-M6. The controller angle increases as the pivot is moved towards the follower 181-M4. The amount of relative rotation between the cam sleeve 181-M2 and the output disk 181-M8 increases proportionally with an increase in the controller angle. The diameters D1 should be selected as to eliminate transition flexing. When the follower 181-M4 is in contact with a diameter Dc of cam 181-M2, link AM1-M6 181-M6 is aligned such that the flat profile of controller rod 181-M10 is parallel to the controller slot of link AM1-M6 181-M6. In this configuration the axial position of controller rod 181-M10 relative to link AM1-M6 181-M6 can always be changed.

Furthermore, the zigzag profile of the controller rod 181-M10 and its pattern of axial movements relative to link AM1-M6 181-M6 should be designed based on the information shown in FIGS. 12A and 12C. Here in instances were the circumference of the surface of the cone were the torque transmitting members are positioned is a multiple of the width of their teeth, so that no relative rotation between cam sleeve 181-M2 and output disk 181-M8 is required, the parallel shape 181-M10-S2 of the controller rod 181-M10 should be positioned inside the controller slot of link AM1-M6 181-M6. And from FIG. 12A, it can be observed that the required amount of rotational adjustment linearly increases as the critical non-torque transmitting arc is increased from an even space, were it is a multiple of the width of the teeth of the torque transmitting members, until the next even space is reached. Furthermore, from FIG. 12A, it can be observed that the required amount of rotational adjustment linearly decreases as the critical non-torque transmitting arc is decreased from an even space until the next even space is reached. A slightly different set-up is shown in FIG. 12C, here the required amount of rotational adjustment linearly decreases as the critical non-torque transmitting arc is increased from an even space until the next even space is reached; and the required amount of rotational adjustment linearly increases as the pitch diameter is decreased from an even pitch diameter until the next even pitch diameter is reached. Here the pivot shape 181-M10-S1 of controller rod 181-M10 and its pattern of axial movement should be designed so that the position of the pivot can be properly adjusted with the change in pitch diameter so that transition flexing is eliminated or at least minimized. The axial distance between a parallel shape 181-M10-S2 to the next parallel shape 181-M10-S2 should correspond to the same axial distance that corresponds to an increase or decrease of a circumferential length of one tooth of the circumferential surface of the cone assembly where its torque transmitting member is positioned. The proper dimension and shape of the cam 181-M1, the follower 181-M4, the link AM1-M6 181-M6, the link AM1-M7 181-M7, the output disk arm 181-M8-S1, the controller rod 181-M10, and the cones, can be determined experimentally. One method would be to first estimate the proper dimension for each part and then adjusting the dimension of the controller rod 181-M10 and its controller rod slot. If that does not work-out then the dimensions of the cam 181-M1 can be adjusted. If this still does not work-out then the dimension of a different part can adjusted and so forth. Also the controller rod 181-M10 has to be slid through the controller slot of link AM1-M6 181-M6, which is rotating with the cam sleeve 181-M2, which in turn is rotating with shaft SH0 10. Hence, the controller rod 181-M10 has to be attached such that it rotates with shaft SH0 10 but can be moved axially relative to shaft SH0 10. In order to achieve this a controller rod mechanism, that consist of the controller rod 181-M10, a controller rod counter-weight 181-M11, a controller rod slider 181-M13, and a controller rod disk 181-M14, is used. Here in order to constrain the rotational position of the controller rod 181-M10 relative to the controller rod counter-weight 181-M11, the back end of the controller rod 181-M10 and the back end of an controller rod counter-weight 181-M11 are connected to the controller rod slider 181-M13, which slides freely on shaft SH0 10 and is positioned in the back of the controller rod disk 181-M14. And the front end of the controller rod 181-M10 and the front ends of the controller counter-weight 181-M11 are connected to the controller rod disk 181-M14, which is positioned in front of the cam sleeve 181-M2. As described earlier the controller rod counter-weight 181-M11 is slid through controller rod counter-weight arm 181-M2-S5 of cam sleeve 181-M2 so that the controller rod counter-weight 181-M11 rotates with cam sleeve 181-M2. And since controller rod 181-M10 and controller rod counter-weight 181-M11 are rotatably constrained relative to each other, controller rod 181-M10 is rotatably constrained relative to cam sleeve 181-M2. Therefore, controller rod 181-M10 rotates with cam sleeve 181-M2.

The controller rod 181-M10 and the controller rod counter-weight 181-M11, except their ends, are made from a round wire. And in order to avoid any vibrations due to unbalanced centrifugal forces, the weight of controller rod 181-M10 should be identical to the weight of controller rod counter-weight 181-M11. In order to attach controller rod 181-M10 and controller rod counter-weight 181-M11 to controller rod slider 181-M13 and controller rod disk 181-M14, the front-end and the back-end of the controller rod and the controller rod counter-weight are shaped like a straight square wire. The controller rod slider 181-M13 is shaped like a hollow cylinder with an plain end and a flanged end. The inner diameter of the controller rod slider 181-M13 is slightly larger than the diameter of shaft SH0 10, so that only significant relative axial movements between the controller rod slider 181-M12 and shaft SH0 10 is allowed. Furthermore, the plain end of the controller rod slider 181-M13 is facing away from cam sleeve 181-M2 and the flanged end of the controller rod slider is facing towards the cam sleeve. To the flanged end of the controller rod slider 181-M13, the back end of the controller rod 181-M10 and the back end of the controller rod counter-weight 181-M11 are attached. In order to achieve this, the flanged end of the controller rod slider has two opposite positioned square holes into which the back end of the controller rod and the back end of the controller counter-weight are securely pressed in. They are attached opposite of each other so that the centrifugal force of the controller rod is canceled out by the centrifugal force of the controller rod counter-weight. In addition, the controller rod and the controller rod counter-weight are also aligned so that their center-axis is parallel to the center-axis of shaft SH0 10. And the front end of the controller rod 181-M10 and the front end of the controller rod counter-weight 181-M1 are attached to the controller rod disk 181-M14, which also has two opposite positioned square holes into which the front end of the controller rod and the front end of the controller rod counter-weight are securely pressed in. And in order to control the axial position of the controller rod mechanism, a member of the controller rod mechanism can be connected to a member of the CVT where it is used, that moves axially with the torque transmitting members as the transmission ratio is changed, so that the axial position of the controller rod is automatically adjusted as the transmission ratio is changed. This method is shown in FIG. 40. Another method to control the axial position of the controller rod 181-M10 is to attach a controller rod mover mechanism, that is used to change the axial position of the controller rod relative to the link AM1-M6 181-M6, to the controller disk 181-M14. This method is shown in FIG. 41. For the configurations shown in FIGS. 40 and 41, the rotational adjustments provided by the mechanical adjuster should be based on the information shown in FIG. 12C.

A configuration of a CVT, where a mechanical adjuster AM1 181 can be utilized is shown in FIG. 40. For this CVT, which is referred to as CVT 2.6, the controller rod slider 181-M13 is directly connected to the mover sleeve CS4B-M6 24B-M6 of cone assembly CS4B 24B, which is identical to cone assembly CS3 23, except that it does not have a non-torque transmitting member. Here the mechanical adjuster AM1 181 is used to properly adjust the rotational position between cone assembly CS4A 24A and cone assembly CS4B 24B, and hence the rotational position between torque transmitting member CS4A-M1 24A-M1 and torque transmitting member CS4B-M1 24B-M1. Also as noted earlier the axial position of the controller rod 181-M10 can only be changed when its flat profile is parallel to the controller slot of link AM1-M6 181-M6, hence some stalling of the transmission ratio changing actuator is to be expected. The strength of transmission ratio changing actuator should be small enough such that it can not cause damaging internal stresses in the parts of mechanical adjuster AM1 181 or anywhere else in the CVT, when it tries to change the transmission ratio when the flat profile of the controller rod is not parallel to the controller slot of link AM1-M6 181-M6. A limiting clutch mounted on the output of the transmission ratio changing actuator that causes slippage between the output of the transmission ratio changing actuator and the rest of the mechanism used to change the transmission ratio when the torque at the transmission ratio changing actuator exceeds a limiting value can also be used. One problem with connecting a member of the controller rod mechanism directly or indirectly to the mover sleeve of a cone assembly is the fact that the controller rod 181-M10 and the link AM1-M6 181-M6 have a finite thickness so that when the axial positions of the controller rod and the torque transmitting members are changed, the parallel shape 181-M10-S2 of the controller rod and the controller slot of link AM1-M6 181-M6 are engaged for a finite axial distance. Since no rotational adjustment between the cam sleeve 181-M2 and the output disk 181-M8 is allowed when the parallel shape of the controller rod is engaged with controller slot of link AM1-M6 181-M6, no rotational adjustment is allowed for a finite axial distance. However since the critical non-torque transmitting arc(s), continuously change as the axial positions of the torque transmitting members and the controller rod is changed, the torque transmitting members are at an even space, where no rotational adjustment between the torque transmitting members is required, for an infinitesimal axial distance. Therefore, there are instances where no rotational adjustments is provided despite the fact that some adjustment in the rotational position of one torque transmitting member relative to the other is required. Hence here some transition flexing has to occur. Here, transition flexing can be reduced by reducing the thickness of link AM1-M6 181-M6 and the thickness of controller rod 181-M10 or by also using a spring-loaded adjuster AS2 172.

The following configuration of a CVT, as shown in FIG. 41, can be used to control the axial position of the controller rod 181-M10 so that transition flexing can be minimized without having to reduce the thickness of controller rod 181-M10 and the thickness of link AM1-M6 181-M6. For this CVT, which is referred to as CVT 2.7, the mechanical adjuster AM1 181 is used to adjust the rotational position of a cone assembly CS4C 24C relative to a cone assembly CS4D 24D, and hence the rotational position of torque transmitting member CS4C-M1 24C-M1 relative to torque transmitting member CS4D-M1 24D-M1. Here a cam adjuster gear rack 181-M16, which engages with a cam adjuster gear 181-M18, is attached to the front surface of the controller rod disk 181-M14 via a rotatable coupling 190. The rotatable coupling 190, which is shown in detail in FIG. 8, allows one end of the rotatable coupling to rotate relative to the other end of the rotatable coupling. It mainly consists of two coupling sleeves 190-M1, which each have an upper shape and a larger lower shape. The larger lower shapes are inserted into a joiner sleeve 190-M2. In order to prevent the coupling sleeves from moving axially relative to each other, joiner sleeve ends 190-M3, that engage with the shoulder created between the upper shapes and the lower shapes of the coupling sleeves, are glued on each end of joiner sleeve 190-M2. The upper shapes of the coupling sleeves 190-M1, each have two opposite positioned threaded holes, which are used to screw in coupling sleeve set-screws. Here for mounting purposes a controller rod disk shaft 181-M15 is centrically welded on to the front surface of the controller rod disk 181-M14; and a gear rack shaft 181-M17, is glued on to the back surface of the cam adjuster gear rack 181-M16. And in order to attach one end of a rotatable coupling 190 to the controller rod disk 181-M14, the controller rod disk shaft 181-M15 is inserted into one coupling sleeve, and a coupling sleeve set-screw is threaded through the controller rod disk shaft 181-M15; and in order to attach the other end of that rotatable coupling to the cam adjuster gear rack 181-M16, the gear rack shaft 181-M17 is inserted into the other coupling sleeve of the rotatable coupling 190, and a coupling sleeve set-screw is threaded through the gear rack shaft 181-M17. The cam adjuster gear 181-M18, which is keyed to a controller rod motor and engages with the cam adjuster gear rack 181-M16, will be used to control the axial position of the controller rod. In addition, the cam adjuster gear 181-M18 has a marked wheel attached to it, which will also be used to monitor the axial position of the controller rod via a rotational position sensor SN2 132. In order to properly control the axial movement of the controller rod, the controller rod motor is connected to the computer that controls CVT 2.7. The computer will then properly control the transmission ratio changing actuator and the controller rod motor as the eliminate or minimize the stretching of the transmission belts in instances where the circumferences of the cone assemblies where the torque transmitting members are positioned is not a multiple of the width of the teeth of the torque transmitting members. Changing the axial position of the controller rod when the follower is not in contact with the diameter Dc of the cam can damage the mechanical adjuster. In order to prevent this the strength of the controller rod motor should be small enough such that it can not cause damaging internal stresses in the mechanical adjuster AM1 181 or anywhere else in the CVT. In order to ensure this a limiting clutch can also be mounted on the output of the controller rod motor.

The following control scheme can be used to properly control the controller rod motor and the transmission ratio changing actuator. First of all as described earlier, the axial position of the controller rod 181-M10 should only be changed when follower 181-M4 is in contact with the diameter D_{C} of cam 181-M1, otherwise stalling of the controller rod actuator or slipping of its limiting clutch has to occur. Although not absolutely necessary, it is nice to prevent this by attaching a rotational position sensor on one of the cone assemblies of the CVT shown in FIG. 41, preferably cone assembly CS4C 24C, and connect this sensor to the computer of this CVT; and program the computer so that it only changes the axial position of the controller rod when the follower is in contact with the diameter D_{C} of cam 181-M1. The same method can also be used for the CVT shown in FIG. 40. Furthermore, the axial position of the controller rod 181-M10 should be changed such that it corresponds with the axial position of the torque transmitting members. Here a certain limit value is set as to limit the discrepancy between the required axial position of the controller rod based on the axial position of the torque transmitting members and the actual axial position of the controller rod. For example, when the controller rod has moved too far ahead relative to its required axial position based on the position of the torque transmitting members, the movement of the controller rod will be put on hold until the torque transmitting members have moved to a corresponding axial position which is within the required limit range. And when the torque transmitting members have moved too far ahead relative to the controller rod, the movement of the torque transmitting members will be put on hold until the controller rod has moved to a corresponding axial position which is within the required limit range. When the pivot shape of the controller rod is in the controller slot of link AM1-M6 181-M6, a corresponding movement of the torque transmitting members should result in a corresponding movement of the controller rod. And when the parallel shape of the controller rod is engaged with the controller slot of link AM1-M6 181-M6, then despite the movement of the controller rod, no movement of the torque transmitting members should occur.

Mechanical Adjuster AM2 182 (FIG. 42)

For the mechanical adjuster AM1 181, shown in FIGS. 39A and 39B, the adjuster output member, output disk AM1-M8 181-M8, is axially fixed relative to the shaft where it is used. Hence this mechanical adjuster can not be used as an adjuster AD1A 10A or AD1B 101B of CVT 1.1, since these adjusters move axially relative to their shaft when the axial position of the torque transmitting members is changed. In order to eliminate transition flexing for a CVT similar to CVT 1.1, which is shown in FIG. 42 and is referred to as CVT 1.3, a slightly modified version of mechanical adjuster AM1 181, which is labeled as mechanical adjuster AM2 182, is used. Mechanical adjuster AM2 182, is shown in detail on the left cone assembly, cone assembly CS2C 22C, of FIG. 42. It is identical to mechanical adjuster AM1 181, except that here in order to have an adjuster output member that can move axially with the torque transmitting members, an adjuster slider plate 182-M1 is added. Most of the members used for mechanical adjuster AM1 181 are also used for mechanical adjuster AM2 182. Here only the members that are different, or are not used in mechanical adjuster AM1 181 are labeled differently than in mechanical adjuster AM1 181. The adjuster slider plate 182-M1 is shaped like an elongated plate. On one side of the adjuster slider plate 182-M1, a cam adjuster extension arm 182-M2 and a cam adjuster balancing arm 182-M3 are welded on. The cam adjuster extension arm 182-M2 is shaped like the long leg of the adjuster extension arm AD1A-M2-S2 111A-M2-S2 of transition flexing adjuster AD1A 101A, which is used in CVT 1.1, see FIG. 4. And the cam adjuster balancing arm 182-M3 is shaped like the long leg of the adjuster balancing arm AD1A-M2-S3 101A-M2-S3 of transition flexing adjuster AD1A 10A. The cam adjuster extension arm 182-M2 is used to mount a gap mounted torque transmitting member, which here is torque transmitting member CS2C-M2 22C-M2, in the same manner as a gap mounted torque transmitting member is mounted on adjuster extension arm AD1A-M2-S2 101A-M2-S2. And like in adjuster AD1A 10A, the cam adjuster balancing arm 182-M3 is used to balance the centrifugal forces of the cam adjuster extension arm 182-M2 and its attachments. Also as in transition flexing adjuster AD1A 101A, here a constrainer mechanism CN1A 111A, that constrains the movements of the telescopes of torque transmitting member CS2C-M2 22C-M2, is attached to the cam adjuster extension arm 182-M2. Also for mounting purposes, on the same side and near the center of the adjuster slider plate 182-M1, an adjuster slider plate back tube 182-M4, which inner diameter is slightly larger than the diameter of the input shaft, is welded on. And on the other side of the adjuster slider plate 182-M1, two cam adjuster sliders 182-M5 are welded on in manner such that in the mechanical adjuster's AM2 182 assembled state, there are no members that prevent the cam adjuster sliders 182-M5 from moving axially. Also in order to ensure that the adjuster slider plate 182-M1 rotates with the output disk AM2-M8 182-M8, the output disk AM2-M8 182-M8 has two slider holes, into which the cam adjuster sliders 182-M5 can be slideably inserted. Also, the cam adjuster sliders 182-M5 are long enough such that they are engaged with the output disk AM2-M8 182-M8 for every axial position of the torque transmitting members. Also for mounting purposes, on the same side and near the center of the adjuster slider plate 182-M1, an adjuster slider plate front tube 182-M6, which inner diameter is slightly larger than the diameter of the input shaft, is welded on.

A configuration where two mechanical adjusters AM2 182 are used to eliminate transition flexing for a CVT 1.3 is shown in FIG. 42. For this CVT, a mechanical adjuster AM2 182 is used to properly adjust the rotational position of torque transmitting member CS2C-M2 22C-M2 of cone assembly CS2C 22C, and to properly adjust the rotational position of torque transmitting member CS2D-M2 22D-M2 of cone assembly CS2D 22D. Here a rotatable coupling 190, described in the previous section, is used to mount an adjuster slider plate 182-M1 to mover sleeve CS2C-M6 22C-M6 and to mount an adjuster slider plate 182-M1 to mover sleeve CS2D-M6 22D-M6. Here in order to attach one end of a rotatable coupling 190 to a mover sleeve, a portion of that mover sleeve is inserted into one coupling sleeve of coupling 190, and two coupling sleeve set-screws, positioned opposite from each other, are partially threaded through the walls of that mover sleeve; and in order to attach the other end of that rotatable coupling to an adjuster slider plate, the adjuster slider plate back tube 182-M4 is inserted into the other coupling sleeve, and two coupling sleeve set-screws, positioned opposite from each other, are partially threaded through the walls of that adjuster slider plate back tube. And another rotatable coupling 190 is used to rotatably connect an adjuster slider plate 182-M1 to its controller rod slider 181-M13, so that the axial position of the controller rod sliders 181-M13 are properly adjusted as the axial position of the torque transmitting members is changed. In order to attach one end of this rotatable coupling 190 to an adjuster slider plate, the adjuster slider plate front tube 182-M6 is inserted into one coupling sleeve of coupling 190, and two coupling sleeve set-screws, positioned opposite from each other, are partially threaded through the walls of that adjuster slider plate front tube; and in order to attach the other end of this rotatable coupling 190 to a controller rod slider 181-M13, a portion of the controller rod slider 181-M13 is inserted into the other coupling sleeve, and two coupling sleeve set-screws, positioned opposite from each other, are partially threaded through of the walls of the controller rod slider.

Also for a cone assembly CS4 24, such as cone assembly CS4A/B/C/D 24A/B/C/D, no non-torque transmitting member is used. Hence in order to maintain the longitudinal shape of the transmission belts as the transmission ratio is changed, guiding wheels 200 or a guides can be mounted on the tense side of the transmission belts such as shown FIGS. 43A and 43B. Like the tensioning wheels, which in FIGS. 43A and 43B are tensioning wheels TW1 61, the guiding wheels 200 move axially with the torque transmitting members, which in FIGS. 43A and 43B are torque transmitting members CS4-M1 24-M1, and the transmissions pulleys, which in FIGS. 43A and 43B are transmission pulleys PU1 41, as the transmission ratio is changed. However, while the tensioning wheels move vertically up or down as their axial position is changed, so that they can maintain proper tension in their transmission belts, the vertical positions of the guiding wheels do not need to change as their axial position is changed.

Gap in Teeth (FIG. 65)

In order to compensate for the inaccuracy of the adjusters another method besides relaying on the flexibility of the transmission belts or using spring-loaded adjusters is by having gaps between the teeth of the torque transmitting members and the torque transmitting devices coupled to them. Here, despite these gaps, the pitch, p, of the teeth of the torque transmitting members and the pitch, p, of the teeth of their transmission belts should be equal. And the gaps should be wide enough so that despite the inaccuracy of the adjusters, transition flexing can be eliminated. A partial sectional view of a torque transmitting member about to be engaged with a transmission belt, where between their teeth gaps, g1 and g2, exist is shown in FIG. 65, which shows the teeth of a torque transmitting member, which are individually labeled as torque transmitting member tooth 7, and a cross-section of the teeth of a transmission belt, which are individually labeled as transmission belt tooth 6. In order to fully utilize the benefits of these gaps, the adjusters should be programmed so that if adjustment is required, the adjusters adjust the position of the torque transmitting member about to be engaged or its transmission belt in manner such that when they are mated, gaps between their teeth, preferably equal in width, exist. And in order to avoid shock loads due to the engagement of the teeth and in order to more equally divide the load on the torque transmitting members, adjusters can be used. Here the adjuster rotates the torque transmitting member which was just mated but not yet engaged in the direction the torque transmitting member is rotating until it comes into engagement; or it rotates the torque transmitting member which is currently engaged in the direction opposite the torque transmitting member is rotating.

Friction Clutch Mounting

In order to account for transition flexing and transmission ratio change rotation, the cone assemblies and transmission pulleys of a CVT which rotational positions need to be adjusted can be mounted using friction clutches, which slip once their torque limit is exceeded. Slipping of the friction clutches allow the rotational position of the cone assemblies and transmission pulleys mounted on them to be adjusted. Although simple and cheap, this method of adjustment might cause significant energy loses due to frictional slippage. However, the friction clutch mounting method can be used as a safety measure in case the adjusters malfunction.

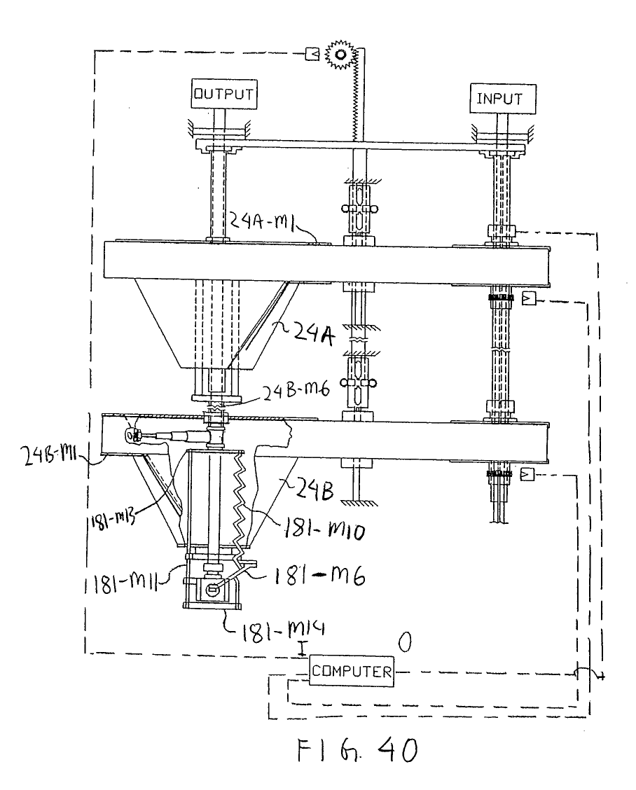

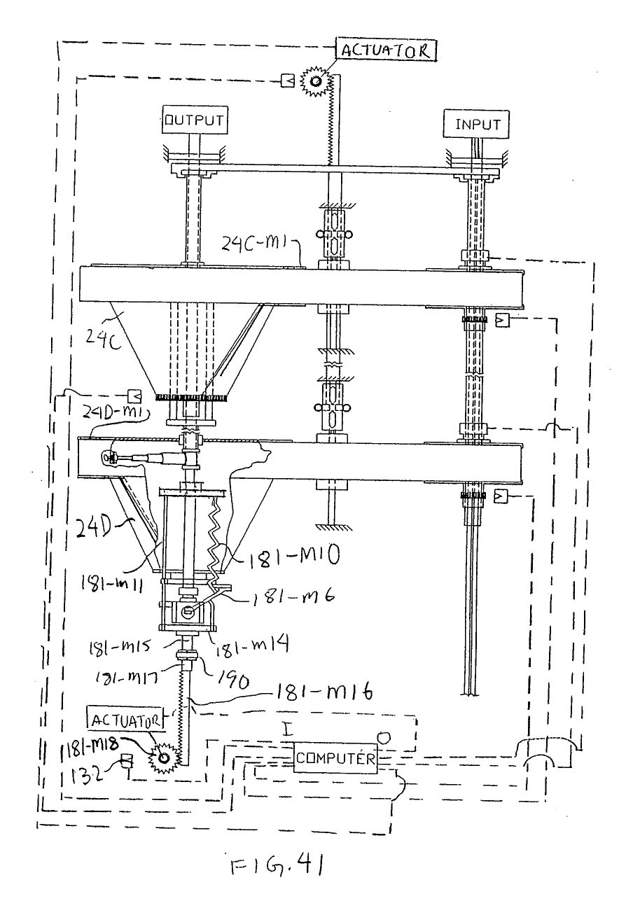

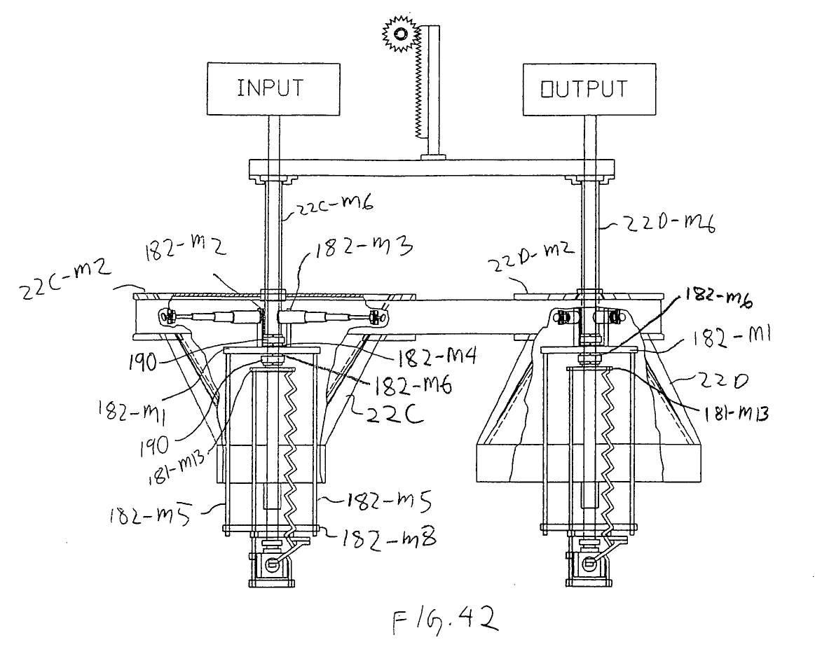

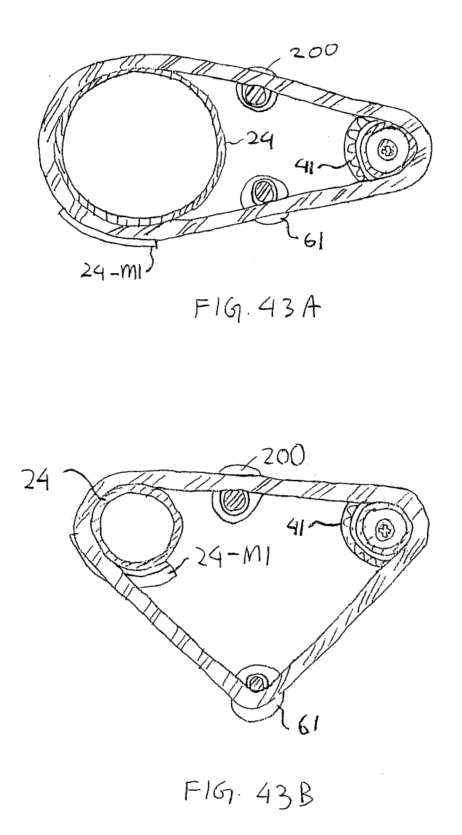

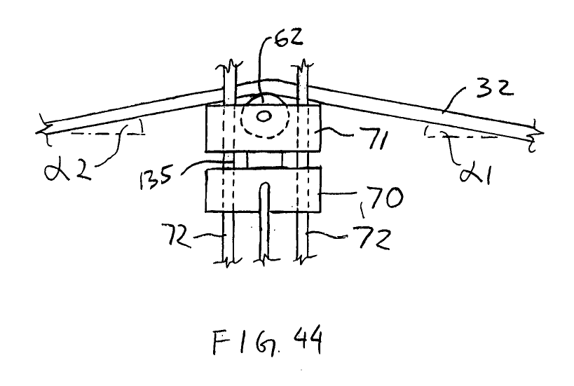

Tension Measuring Load Cell (FIG. 44)

For CVT 2.1, torque sensors are used to measure the pulling loads on the transmission pulleys. Another method to measure, or in this case estimate, the pulling load on a transmission pulley is by measuring the tension in the tense side of transmission belt BL2 32 via a load cell 135, see FIG. 44. Here the slider used to mount a tensioning wheel, which here is labeled as load cell wheel 62, is identical to the one described in U.S. Pat. No. 6,656,070 except that here it is horizontally cut into two halves. The lower half, which include the hole for the slide, is labeled as load cell lower slider 70. And the upper half, which include the shaft for mounting the tensioning wheel, is labeled as load cell upper slider 71. Between load cell lower slider 70 and load cell upper slider 71, load cell 135 is positioned. In order to maintain the position of load cell 135, load cell 135 is glued to the top surface of load cell lower slider 70. Also like the sliders for the tensioning wheels in U.S. Pat. No. 6,656,070, vertical guides 72, which here are inserted into vertical holes of the load cell lower slider 70 and load cell upper slider 71, are used to change the axial position of the load cell lower slider 70 and load cell upper slider 71 and maintain their proper orientation.

Furthermore, the angle between the horizontal plane and the tense side of transmission belt BL2 32 will be referred to as angle α1 and angle α2. Smaller values for angle α1 and angle α2 are preferred, so that a load cell 135 with a smaller load rating can be used. In order to determine the tension in transmission belt BL2 32, besides monitoring the measurement of load cell 135, the controlling computer of the CVT also needs to determine the angle α1 and angle α2. This can be done by programming the values for angle α1 and angle α2 for every transmission ratio, which is monitored, into the computer. Another method that can be used is by programming into the computer an equation for angle α1 and angle α2 based on the transmission ratio.

In addition to the additional embodiments directed specifically towards the adjuster systems, in the following paragraphs some additional embodiments for other parts of the CVTs described in U.S. Pat. No. 6,656,070 and this application will be described.

Sliding Cone Mounting Configuration (FIGS. 45, 46, 47)

In the sliding cone mounting configuration, in order to change the transmission ratio, the axial positions of the cones relative to their frame are changed, while the axial positions of the torque transmitting members and the transmission pulleys are held fixed relative to their frame. Using the sliding cone mounting configuration, the design for some CVTs can be simplified. Especially the design where a differential adjuster shaft is used.

A portion of the sliding cone mounting configuration is shown as a partial top-view in FIG. 45, which shows a portion of one of its cone assembly, which is labeled as cone assembly CS5 25. Here the rotors 25-M1, on which the telescopes of the torque transmitting members and the non-torque transmitting members are mounted, are keyed to a sliding cone spline 250 so as to constrain any rotational and axial movements between the rotors and the sliding cone spline. And cone assembly CS5 25 is slideably mounted on a sliding cone spline 250. Here cone assembly CS5 25 has a cone slider 25-S1 at the smaller end of its cone. The inner surfaces of cone slider 25-S1 form a splined profile that match the splined profile of the sliding cone spline 250 so that torque can be transmitted between them while also allowing cone slider 25-S1, and hence cone assemblies CS5 25, to slide freely on sliding cone spline 250. And the outer surface of cone slider 25-S1 is shaped like a round cylinder, which center axis is the rotational axis of its cone. Furthermore, the outer diameter of cone slider 25-S1 is smaller in diameter than the smaller end of its cone so that a shoulder is formed between a cone slider 25-S1 and the smaller end of its cone. In addition, the free end of cone slider 25-S1 is threaded. A mover arm B bearing 251-M1, which is a thrust bearing that is tightly inserted into a matching hole of a mover arm B 251-S1 so as to prevent any relative movements between them, is slid into cone slider 25-S1. Then a cone slider nut 25-M2 is threaded onto the threaded end of cone slider 25-S1, so that mover arm B bearing 251-M1 is tightly sandwiched between the shoulder formed by cone slider 25-S1 and the smaller end of its cone. Under this set-up, the axial positions of cone slider 25-S1, and hence the axial positions of cone assembly CS5 25, depend on the axial positions of mover arms B 251-S1. Also, here mover arm B bearing 251-M1 allow cone assembly CS5 25 to rotate without much frictional resistance relative to mover arm B 251-S1. Mover arm B 251-S1 is then connected to a mover rod B 251-S2, which is part of a mover frame B 251, which is used to change the axial position of the cone assemblies and the tensioning slides via a gear rack B 252.

In addition, in case the sliding cone configuration is used for a CVT 1.2 or CVT 2, in order to properly maintain the tension of the transmission belts the tensioning mechanism shown in FIG. 46 can be used. Here a tensioning slide A 253 and tensioning slide B 254 are connected by a tensioning slide end A 255 and a tensioning slide end B 256. Tensioning slide end A 255 is then connected to mover frame B 251, shown in FIG. 45, by a tensioning slide connector 257. Sliding on tensioning slide A 253 is a tensioning slider A 258 and sliding on tensioning slide B 254 is a tensioning slider B 259. Tensioning slider A 258 consists of two main shapes, a tensioning slider A block 258-S1 and a tensioning slider A shaft 258-S2. Tensioning slider A block 258-S1 has a horizontal slide hole through which the tensioning slide A 253 is inserted, see FIG. 47, which shows a partial front-view of a tensioning slider A 258. And to the left and to the right of the horizontal slide hole of tensioning slider A 258, two vertical holes through which the fixed vertical guides 260, which are fixed to the frame of the CVT, are inserted. Near the top of the tensioning slider A block 258-S1, the tensioning slider A shaft 258-S2 is shaped. The tensioning slider A shaft 258-S2 is used to insert a guiding wheel 200 or a tensioning wheel 61 is mounted to the clevis instead of a pulley. Tensioning slider B 259 is identical to tensioning slider A 258, except that here the tensioning slider B block 259-S1 has a angled slide hole through which tensioning slide B 254 is inserted instead of the horizontal slide hole through which the tensioning slide A 253 is inserted.

Torque Transmitting Member for Chain (FIGS. 48A, 48B, 49A, 49B, 50A, 50B, 51A, 51B, 52A, 52B, 53)

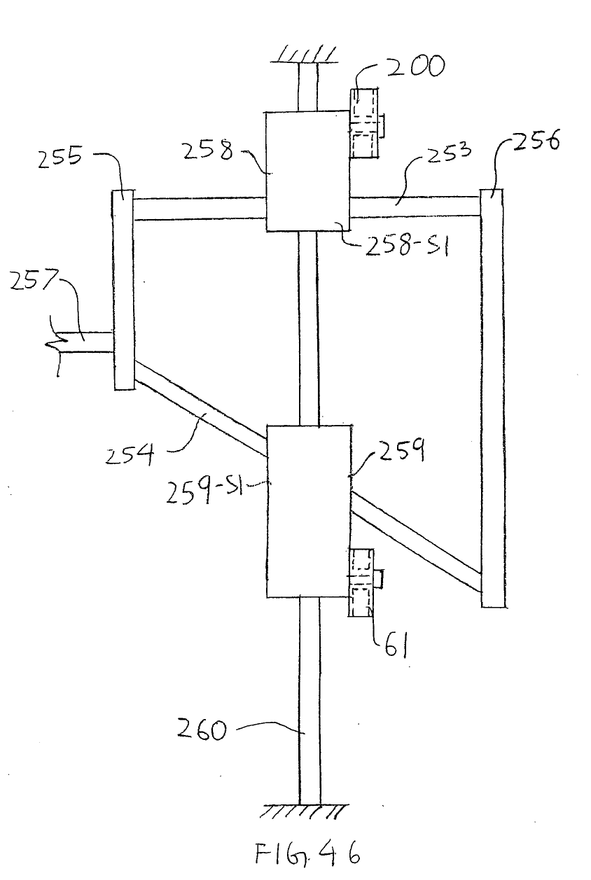

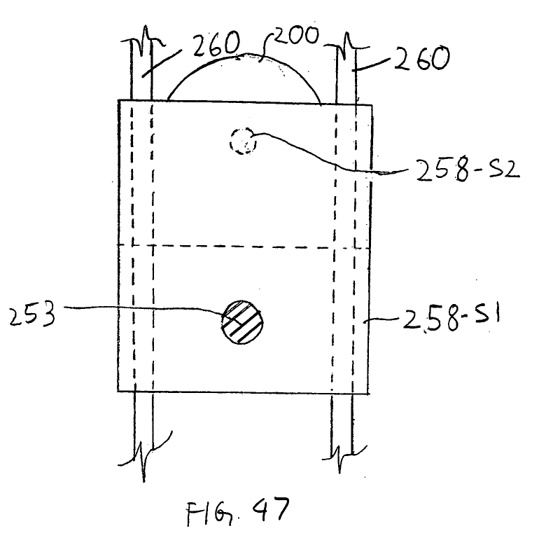

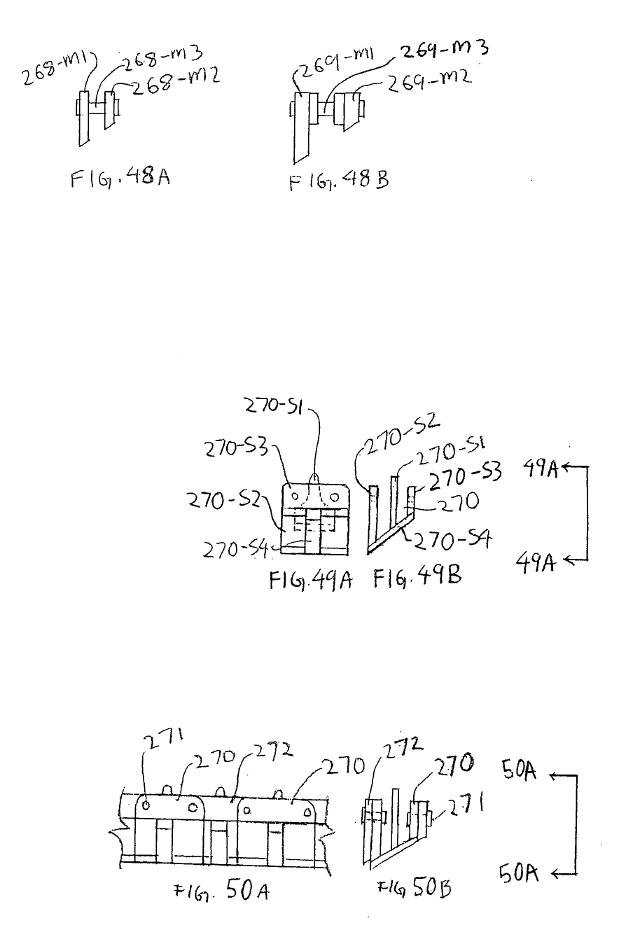

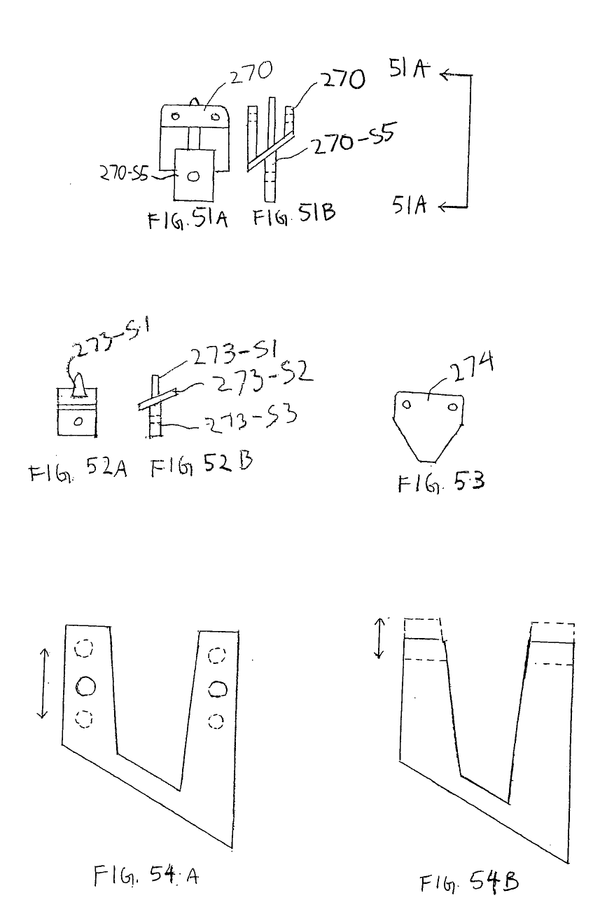

In case a chain is preferred instead of a belt, then a torque transmitting member that can accommodate a chain can be designed. For example, if a slightly modified bicycle chain is used, then links forming a torque transmitting member chain or a single tooth link can be used. The front-view of a modified bicycle chain link is shown in FIG. 48A, this chain link is identical to a regular bicycle chain link, except that here left chain link 1 side plate 268-M1 is deeper than right chain link 1 side plate 268-M2 and the bottom surfaces of the left chain link 1 side plate 268-M1 and left chain link 1 side plate 268-M1 are angled so that the chain link 1 pin 268-M3 is parallel to the shaft of its cone when that chain link rest on the surface of its cone. A front-view of another modified bicycle chain link is shown in FIG. 48B, this chain link is identical to a regular bicycle chain link except that here a left chain link 2 rubber leg 269-M1 and right chain link 2 rubber leg 269-M2 are attached to the chain link plates so that chain link 2 pin 269-M3 is parallel to the shaft of its cone when that chain link rest on the surface of its cone. Now a torque transmitting member chain or a single tooth link that can be used with the modified bicycle chain described above will be described. Here, FIG. 49A shows a side-view of a link A 270, as seen from the right side of the link, and FIG. 49B shows a front-view of a link A 270. Each link A 270 consist of a link A tooth 270-S1, which is shaped so that can properly engage with the pins of its chain, a left link A plate 270-S2, a right link A plate 270-S3, and a link A base 270-S4, which connects the link A tooth to the left link A plate and the right link A plate. The link A tooth and the link A plates are parallel relative to each other. But the link A base 270-S4 is positioned at an angle relative to the link A tooth and the link A plates, so that when link A base 270-S4 is resting on the surface of the cone on which it is attached, the link A tooth and the link A plates are parallel relative to the end surface(s) of their cone. In case a single tooth link is used, then the link A plates are not needed. The left link A plate 270-S2, which is longer than the right link A plate 270-S3, and the right link A plate 270-S3 each have two rivet holes, which are used to insert link rivets 271, used to connect links A 270 to links B 272 to from a torque transmitting member chain, see FIGS. 50A and 50B. For smooth operation, it is recommended that the rivet holes are located so that when the links formed torque transmitting member is properly engaged with its chain, the bending axis of the links formed torque transmitting member chain coincides with the bending axis of the chain. Here, if this is the case, then a smooth arc can be drawn through the centers of the rivet holes and the centers of the pins of the chain. In addition to links A 270, links B 272 will also be used to from a torque transmitting member chain. A torque transmitting member chain is formed by connecting a link A 270 to a link B 272, which is then connected to another link A 270, and so forth, so that a chain that consist of alternating links A 270 and links B 272 is formed. A link B 272 is identical to a link A 270, except that the parallel distance between its link plates is slightly larger than that of link A 270 so that the link plates of a link A 270 can be placed between the link plates of a link B 272. Link rivets 271 are then used to connect the ends of the left link plates of links A 270 to the ends of the left link plates of links B 272; and to connect the ends of the right link plates of links A 270 to the ends of the right link plates of links B 272. The dimensions and materials of link rivets 271 should be selected so that once riveted together, the links A 270 can rotate with ease relative to their links B 272. Also the base of each link A 270 and the base of each link B 272 should be short enough so that they do not interfere with the required flexing motion of the torque transmitting member chain. And if the left link plates interfere with the required flexing motion of the torque transmitting member chain, than they can be reshaped to accommodate this. An example of a reshaped left link plate, which is labeled as left link plate 274, is shown in FIG. 53.

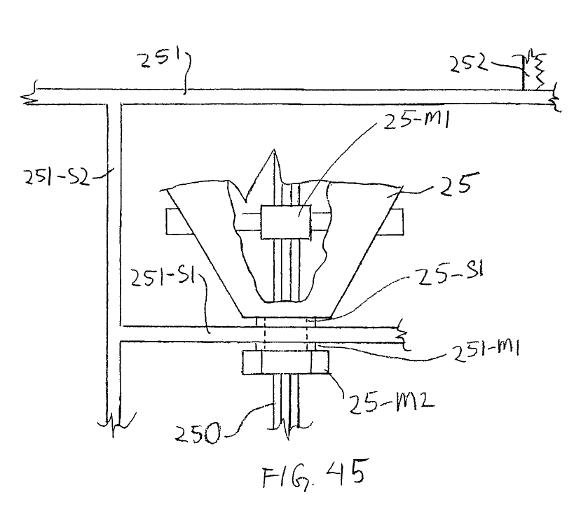

Furthermore, in order to attach a torque transmitting member chain to a cone assembly, the end links of the torque transmitting member chain each have a base to which a link attachment plate, which is identical to the link attachment plate of a torque transmitting member described in U.S. Pat. No. 6,656,070, is attached. The end link configuration for a link A 270, and its link A attachment plate 270-S5, which in its cone assembly's assembled state is slit into a slot of its cone and attached to a mover telescope, is shown as a side-view as seen from the right side of the link in FIG. 51A and as a front-view in FIG. 51B. The end link for a link B 272 has an identical link attachment plate as a link A 270. And in case single tooth link is used, which is shown in FIGS. 52A and 52B, than that tooth link needs to have an attachment plate at its base. For the single tooth link shown in FIGS. 52A and 52B, the tooth is labeled as single link tooth 273-S1, the base is labeled as single link base 273-S2, and the attachment plate is labeled as single link attachment plate 273-S3.

In addition, in order to maintain the shape of the torque transmitting member chain, it is recommended that the torque transmitting member chain is maintained under slight tension. Hence the engaging surfaces of the slots should be narrow enough and have sufficient depth to maintain the proper alignment of the link attachment plates.

Also, a molded torque transmitting member made out of flexible material, such as rubber for example, can also be used to accommodate a chain. In cases, where torque transmission is between the side surfaces of the torque transmitting members and their transmission belts, the neutral-axis of the torque transmitting members and their transmission belts coincide, almost coincide, or can be easily made to coincide by proper reinforcement placement or dimensioning. As should be known by somebody skilled in the art, the location of the neutral-axis of a torque transmitting member can easily be adjusted by adjusting the location of the reinforcement, as shown in FIG. 54A, and by adjusting the dimensions, as shown in FIG. 54B. In FIGS. 54A and 54B solid lines represent actual reinforcement location or dimension and dotted lines represent adjusted reinforcement location or dimension. Here the height of the neutral-axis increases as the location of the reinforcement is raised or the height of the side members of the torque transmitting member is increased, and the height of the neutral-axis decreases as the location of the reinforcement is lowered or the height of the side members is decreased. The same method of adjusting the neutral-axis of a torque transmitting member can also be used for a transmission belt. Here the location of the neutral-axis can also be adjusted by adjusting the location of the reinforcement, if used, and by adjusting the dimensions. However, for a molded torque transmitting member that can engage with a bicycle chain, torque transmission is not between the side surfaces of the torque transmitting member and the chain, hence the neutral-axis does not coincide, almost coincide, or can be easily made to coincide with the bending axis of the chain, which is located at the center-point of the pins of the chain. Here in order to adjust the location of the neutral-axis of the torque transmitting member, compensating shapes have to be used. An example of a torque transmitting member that can engage with a bicycle chain, which will be referred to as a chain torque transmitting member is shown as a front-view in FIG. 55. Here the chain torque transmitting member, consist of a chain torque transmitting member tooth 275-S1, a chain torque transmitting member base 275-S2, a chain torque transmitting member left compensating shape 275-S3, and a chain torque transmitting member right compensating shape 275-S4. The dimensions for the chain torque transmitting member left compensating shape 275-S3 and the chain torque transmitting member right compensating shape 275-S4 should be selected such that when the chain torque transmitting member is properly engaged with its chain, the neutral-axis of the chain torque transmitting member coincides with the bending axis of the chain.

For the designs described above for optimum performance, the surface of the cone utilizing a torque transmitting member chain, a single link tooth, or a chain torque transmitting member, should be shaped to accommodate the base(s) of the torque transmitting member chain links, single link tooth, or a chain torque transmitting member so that during operation no or minimal deformation of the transmission chain occurs as it comes in and out of contact with its torque transmitting member. This can be achieved by increasing the thickness of the side surface(s) of the cone which are never covered a torque transmitting member chain, single link tooth, or chain torque transmitting member, as to compensate for the thickness of the base(s) of the torque transmitting member chain links, single link tooth, or a chain torque transmitting member.

Using the description above, somebody skilled in the art should be able to construct a torque transmitting member for other chains, such as an inverted chain for example. And he/she should also be able to construct a torque transmitting member made out of chain links for various transmission belts. Here for smooth operation, the bending axis of the torque transmitting member made out of chain links, which location is determined by the location of the chain rivet holes, should coincide with the neutral-axis of its transmission belt.

Torque Transmitting Side Members (FIGS. 56, 57A, 57B, 57C)

In U.S. Pat. No. 6,656,070 it was mentioned that a torque transmitting member can be constructed out of two separate side members. The details for this configuration was not described in detail, since somebody skilled in the art should be able to do this. However, since more time was available in preparing this patent, for illustrative purposes, these details will be described in this patent. For this configuration, it is recommended that the location of the height center-line of the teeth used for torque transmission of the side members and the neutral-axis of the side members, which under this configuration will be referred to as torque transmitting side members, are located in the same horizontal plane, see FIG. 56. In FIG. 56, the torque transmitting member is formed by a left torque transmitting side member 280A and by a right torque transmitting side member 280B.

A detailed view of a torque transmitting side member 280, which can be used as a left torque transmitting side member, is shown in FIG. 57A, which shows a partial top-view, in FIG. 57B, which shows a side-view, and in FIG. 57C, which shows an end-view. Here on the right surface of torque transmitting side member 280, its side member teeth 280-S1 are formed. And since torque transmitting side member 280 does not have a base that connects it to its opposite torque transmitting side member, which helps maintain the longitudinal shape of the torque transmitting member as torque is being transmitted, here on the left surface of torque transmitting side member 280, a lateral bending reinforcement 280-S2 is formed. Furthermore, in order to attach torque transmitting side member 280 to its cone, side member attachment pins 281 are inserted near each end of torque transmitting side member 280. The side member attachment pins 281 are tied together by a side member reinforcement 282, which is a rope embedded in the torque transmitting side member 280 that has looped shaped ends into which the side member attachment pins 281 are inserted. It is recommended that side member reinforcement 282 is located in the same horizontal plane as the center-line of side member teeth 280-S1. Furthermore, for attachment purposes each side member attachment pin 281 has a side member attachment plate 281-S1 shaped at its bottom end. In the assembled state of a cone assembly utilizing torque transmitting side members, the side member attachment plates 281-S1 are slid into the slots of their cone and then secured using an attachment wheel and a mover telescope, in the same manner as the torque transmitting members in U.S. Pat. No. 6,656,070 are attached to their cone. Here a pair of mover telescopes is needed for each torque transmitting side member. Hence here, a complete torque transmitting member needs four mover telescopes mounted on a common rotor instead of two, unless another method of attachment is used, such as joining the side member attachment plates of a pair of torque transmitting side members together so that only one mover telescopes is needed for the two side member attachment plates, which are joined together. And joining the side member attachment plates of a pair of torque transmitting side members together also increases the lateral stability of the torque transmitting side members. It is also recommended that frictional engagement between the members of the mover telescopes is used as to prevent the mover telescope members from sliding up and down relative to each other as its cone assembly is rotating. For even better performance, the frictional engagement between the members of the mover telescopes can be selected such that the mover telescopes extend and contract in a predetermined fashion. For example, for a three member mover telescope, the frictional engagement of the top mover telescope member with the middle mover telescope member can be made lower than the frictional engagement of the middle mover telescope member with the bottom mover telescope member so that when extended, the top mover telescope member extends before the middle mover telescope member does. Besides mover telescopes, slider and slides, which can also be used to transmit torque, can also be used to change the axial position of a torque transmitting side member or a torque transmitting member. Here the slider is preferably attached to the outer side surface of a torque transmitting member at the length mid-point of the torque transmitting member. And its slide can be welded, so that it extends radially outwards, on a collar that can be keyed to the shaft on which the torque transmitting member is rotating about. And the ends of the torque transmitting member can again be attached to their cone by the use of attachment plates. However, here the attachment plates are not used to transmit torque. Also here the torque transmitting member needs to be stiff enough or properly reinforced so that it can maintain its shape when torque is transmitted near its ends and when its teeth are only partially engaged. Furthermore, for a CVT 2, instead of having the base of the transmission belts angled, the leveling loop used for a CVT 1 can also be used here.

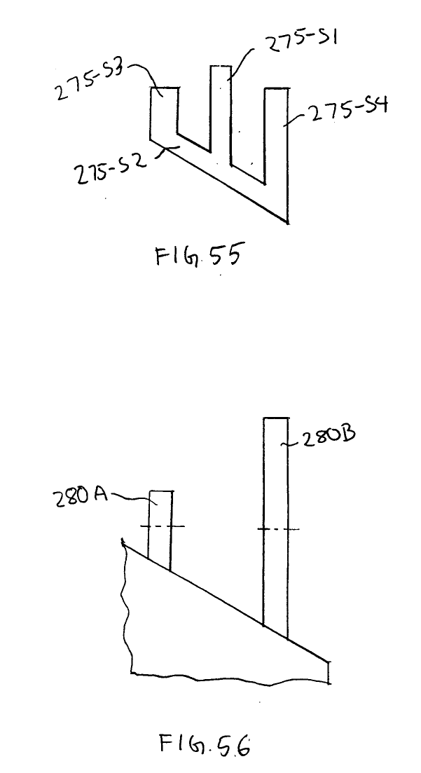

Alternate Cone Assemblies (FIGS. 58, 59, 60A, 60B, 61A, 61B, 62)

The main purpose of this application is to present adjuster systems that can increase the performance of CVTs that suffer from either or both transition flexing and a limited duration at which the transmission ratio can be changed by eliminating or reducing transition flexing and/or by increasing the duration at which the transmission ratio can be changed. Other CVTs not described in U.S. Pat. No. 6,656,070 that also suffer from either or both transition flexing and a limited duration at which the transmission ratio can be changed can also benefit from this invention.

Most likely, the adjuster systems of this invention, can benefit any machine that utilizes torque transmitting devices that alternately come in and out of contact with a common torque transmitting device, for which instances exist or can exist where rotational adjustment to an alternating torque transmitting device or a common torque transmitting device can improve the engagement of an alternating torque transmitting device with its common torque transmitting device; or for which instances exist where rotational adjustment(s) to alternating torque transmitting device(s) or common torque transmitting device(s) can compensate for the rotation of the torque transmitting device(s) that occur during transmission ratio change which may prevent transmission ratio change; or for which instances exist where rotational adjustment to a torque transmitting device which alternates between being in a moveable configuration, where the transmission ratio can be changed, and being in an un-moveable configuration, where the transmission ratio cannot be changed, can maintain that torque transmitting device in a moveable configuration.

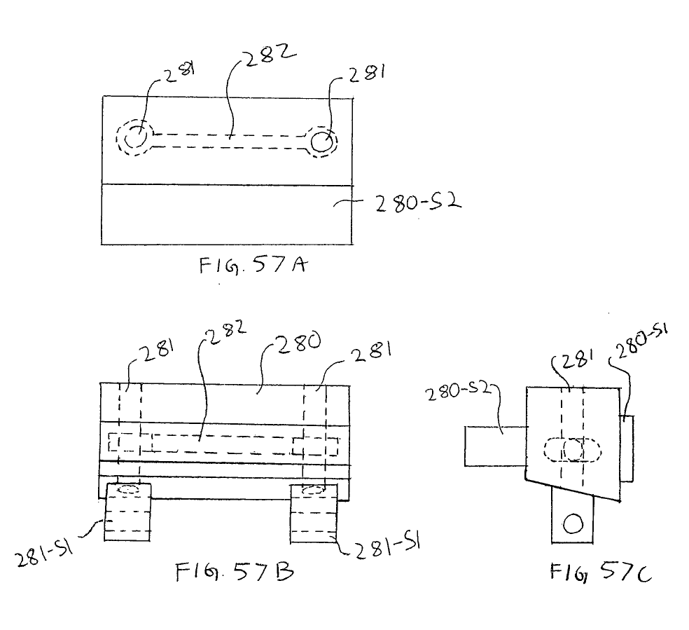

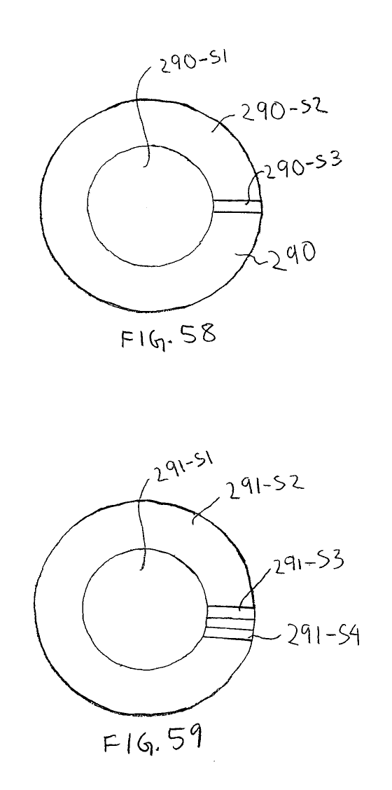

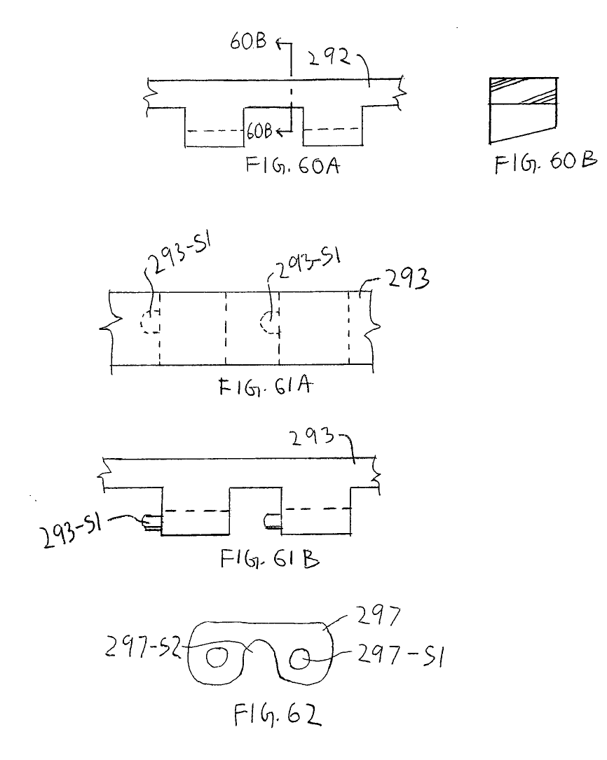

An example of other CVTs that can benefit from the adjuster systems of this patent are slightly modified CVT 2s that instead of the cone assemblies with torque transmitting members, uses a single tooth cone, which is a cone that has one fixed tooth 290-S3 that elongates from the single tooth cone smaller end 290-S1 to the cone's larger end on the single tooth cone side surface 290-S2, as shown as a top-view in FIG. 58. The main difference here is that for these CVTs an inverted chain or belt, for which an example is shown in FIG. 60A, which shows a side-view, and in FIG. 60B, which shows as sectional-view, has to be used. Another difference is that in most cases a fixed tooth 290-S3 covers a smaller arc length on the surface of its cone than torque transmitting members does. As described in U.S. Pat. No. 6,656,070, for proper operation of a CVT 2, it is recommended that during its operation at all instances a torque transmitting surface is engaged with its transmission belt. Here, because of the smaller arc length covered by the fixed tooth 290-S3, the transmission ratio range is most likely more limited. Since here for proper operation, for all transmission ratios at least half of the surfaces of the single tooth cones need to be covered by their transmission belts.

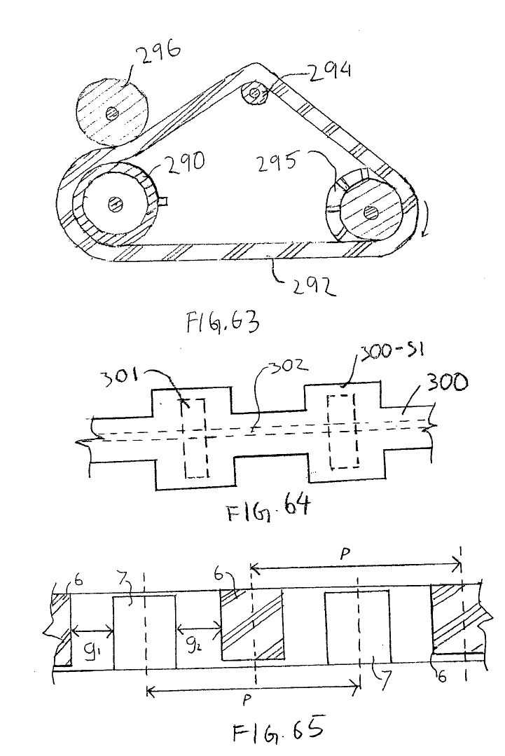

One method to increase the transmission ratio range for a single tooth cone CVT 2 is by using a supporting wheel, which is used to increase the coverage of the transmission belt on the surface of its cone for transmission ratios where it is required. In order to properly adjust the position of the supporting wheel as the transmission ratio is changed, a slide and a slider similar to the ones used for a tensioning wheel can be used for the supporting wheel. An example of this configuration is shown in FIG. 63, which shows a sectional-view of a single tooth cone CVT 2 cut near the smaller end of one of its cones, which is labeled as single tooth cone 290, where its transmission belt, labeled as inverted belt 292, is currently positioned. The inverted belt 292 is used to couple single tooth cone 290 to an inverted belt pulley 295. And the tensioning wheel, which here is labeled as inverted belt tensioning wheel 294 and the supporting wheel 296 are positioned on the tense side of the belt. Placing the inverted belt tensioning wheel 294 and the supporting wheel 296 on the slack side of the belt should also work; however here it might be necessary to take precautions that prevent the transmission belt to lose contact with its tensioning wheel due to excessive slack. In some set-ups, placing the supporting wheel opposite of the tensioning wheel will also work. Furthermore, if desired supporting wheels can also used be in CVTs that use cone with a torque transmitting members.

Another method to increase the transmission ratio range for a single tooth cone CVT 2 is by using an adjuster to compensate for the limited coverage of the single tooth cones. Here in instances where the transmission belts are not providing sufficient coverage, the adjuster(s) rotate the cone currently not engaged in the direction that the cone is rotating a sufficient amount so that the cone currently not engaged comes into engagement before the cone currently engaged comes out of engagement.

Also in order to prevent bending of a tooth of a transmission belt due to the moment created by the force applied by the fixed tooth on a tooth of the transmission belt, a supporting surface can be shaped on the side surface of a single tooth cone, see FIG. 59. In FIG. 59, which shows as a top-view, the smaller end of the cone is labeled as supported single tooth cone smaller end 291-S1, the side surface of the cone is labeled as supported single tooth cone side surface 291-S2, the fixed tooth is labeled as supported single tooth cone fixed tooth 291-S3, and the supporting surface is labeled as supported single tooth cone supporting surface 291-S4. For smoother operation and less flexing of the teeth of the transmission belt used, it is recommended, but not necessary that the supported single tooth cone supporting surface 291-S4 is shorter than the supported single tooth cone fixed tooth 291-S3. The inverted belt shown in FIG. 60A and in FIG. 60B can also be used with this cone. Here the supported single tooth cone supporting surface 291-S4 has to be positioned and shaped so that it can properly engage with the back surfaces of the teeth of the inverted belt.

And a specialized transmission belt that can be used with a supported single tooth cone is shown as a top-view in FIG. 61A and as a side-view in FIG. 61B. This transmission belt, which is labeled as supported single tooth cone inverted belt 293 has a tooth constraining surface 293-S1 shaped at the base of its tooth which can engage with the supporting surface of its cone. The engagement of the tooth constraining surface 293-S1 with the supported single tooth cone supporting surface 291-S4 prevents excessive twisting of the tooth of a transmission belt. For smoother engagement and less flexing of the tooth constraining surfaces 293-S1, it is recommended that the surface of the tooth constraining surface 293-S1 is rounded about the z-axis, which is the axis that is horizontal and parallel to the engagement surfaces to the teeth. The supported single tooth cone supporting surface 291-S4 should be positioned so that it is parallel to the supported single tooth cone fixed tooth 291-S3. Here for better engagement some fine adjustment to the position of the single tooth cone supporting surface 291-S4 based on experimentation to account for the changing curvature of the side surface of the cone and the flexing of the bases of the teeth of the supported single tooth cone inverted belt 293 can also be made. Here if the supported single tooth cone supporting surface 291-S4 is not parallel to the supported single tooth cone fixed tooth 291-S3, it is recommended that the surface of the tooth constraining surface 293-S1 is rounded about the y-axis, which is the axis that is vertical. Also if an inverted belt that has a constraining surface shaped on its teeth is used, only the surfaces of the teeth that do not have a constraining surface should be used for torque transmission.

Many variation of a single tooth cone can be devised. For example, instead of being straight, the fixed tooth and the supporting surface, if used, can be positioned at an angle relative to the surface of their cone; or an involute or modified involute shaped surfaces can be used for the fixed tooth and/or the supporting surface; or an inverted chain which has links for which a tooth profile is cut out, which engagement with the fixed tooth help maintain the orientation of the link currently engaged during torque transmission, can also be used. Such an inverted chain can be construct from links and pins in a similar manner as the chains described in the Torque Transmitting Member for Chain section are constructed. However here, it is desirable to have the centers of the pins of the chain located at the height mid-point of the tooth cut out profile at the mid-cross-sections of the link or mid-section of a pair of parallel links. If this the case, then torque transmission does not cause the link transmitting torque to bend out of its ideal alignment. This allows the tooth cut-out profile of a link to be slightly wider than its mating fixed tooth, since the engagement of the back surface of the fixed tooth with the tooth cut-out profile of a link is not needed in order to main ideal alignment of that link. FIG. 62 shows a side-view of such a chain link. Here the chain link, which is labeled as inverted chain link 297, has a inverted chain pin hole 297-S1 and an inverted chain tooth cut out profile 297-S2.

Basically a cone with a single fixed tooth, can be treated like a cone with a torque transmitting member except that here the coverage provided by a fixed tooth is most likely less than the coverage provided by a torque transmitting member. Also here an inverted belt or chain has to be used as a transmission belt. The main disadvantage of a cone with a single fixed tooth over a cone with a torque transmitting member is that here uneven wear of the fixed tooth can cause problem during transmission ratio change; and an inverted belt or chain is most likely less efficient in transmitting torque than a belt or chain that can be used with a cone with a torque transmitting member.

### Preferred Tooth Shapes

Somebody skilled in the art should be able to select a tooth shape for this application, since some well established theories about torque transmission using teeth can be applied here. Below the advantages and disadvantage of two tooth shapes recommended by the in are discussed. Obviously other tooth shapes can also be used. The simplest and quit efficient tooth shape is a square tooth shape. It has a straight engaging surface, which is ideal for torque transmission purposes. However the operation of this tooth shape is not very smooth, because some flexing of the transmission belt, if used, and the teeth occur when a tooth is only partially engaged with its mating tooth. If a gap is used between the teeth as described in the Gap in Teeth section of this patent, then the gap should be wide enough so that adjusters can be used to adjust the rotational position of a torque transmitting device relative to another so that flexing due to partially engaged teeth can be eliminated. Also the smoothness in operation of a square tooth shape can be increased by increasing the width to height ratio of the tooth. Another preferred tooth shape, is an involute tooth shape, this tooth shape offers the smoothest operation. By slightly modifying this tooth shape by increasing the width of the tooth at the base and continuously reducing the width of the tooth as the height is increased so that only perfectly aligned teeth engage, an even smoother operation can be achieved. However, this tooth shape is not as efficient as a square tooth shape in transmitting torque because of its narrow tip.

Reinforced Transmission Belt (FIG. 64)

Since the adjusters can minimize transition flexing, it is desirable to stiffen the transmission belt using reinforcement. A reinforced transmission belt 300 is shown as a top-view in FIG. 64. Here a steel reinforcement plate 301 is embedded at each reinforced transmission belt tooth 300-S1. The steel reinforcement plate 301 is then connected to a wire reinforcement 302.

Operation

In order to use an adjuster system described in this invention to improve the performance of a CVT that suffers from either or both transition flexing and a limited duration at which the transmission ratio can be changed, the designer uses one or several adjusters, which can adjust the rotational position of a torque transmitting device, such as a torque transmitting member of a cone assembly, a transmission pulley, a cone assembly, etc., relative to another torque transmitting device. The adjuster(s) should be mounted so that transition flexing can be eliminated and/or so that the duration at which the transmission ratio can be changed can be substantially increased.

In order to eliminate transition flexing, the amount of adjusters needed depend on the configuration of the CVT. One method of eliminating transition flexing is to adjust the rotational position of the alternating torque transmitting device(s) that causes transition flexing. Here an alternating torque transmitting device is a device that alternates between transmitting torque and not transmitting torque. For CVT 1, the alternating torque transmitting devices are the torque transmitting members. And for CVT 2, the alternating torque transmitting devices are the cone assemblies and the transmission pulleys, since they alternately transmit torque to/from a shaft from/to a transmission belt. Each alternating torque transmitting devices is coupled to a common torque transmitting device, which is a torque transmitting device that transmits torque to/receives torque from at least two alternating torque transmitting devices. For CVT 1, the common torque transmitting devices are the transmission belt, the input shaft, and the output shaft. And for CVT 2, the common torque transmitting devices are the input shaft and the output shaft.

Another method to eliminate transition flexing is to adjust the rotational position of the common torque transmitting devices. For example, for a CVT that comprises of a cone assembly with one torque transmitting member that is sandwiched by two gears, which are coupled to a common output shaft and alternately transmit torque from the torque transmitting member of the cone assembly, transition flexing can be eliminated by adjusting the rotational position of the cone assembly. The rotational position of the cone assembly should only be adjusted when the torque transmitting member of the cone assembly is only engaged with one gear. Also, for this configuration, the adjusting rotation at the cone assembly also affects the rotation of the gear with which it is engaged, unless there are instances where there is no torque being transmitted between the gears and the cone assembly. Hence, here it might be better to adjust the rotational position of a gear before it is coupled to the other gear instead.

When adjusters are used to adjust the rotational position of the alternating torque transmitting devices, then in most cases the following method can be used to determine how many adjuster are needed for a common torque transmitting device and how to mount them. When for a common torque transmitting device two alternating torque transmitting devices, which are coupled to each other, are used to transmit torque, then only one adjuster, which can be used on any of the alternating torque transmitting devices, is needed.

When more than two torque transmitting members are used, then the amount of adjusters needed depend on the configuration of the CVT. When for a rotational position two alternating torque transmitting devices can simultaneously be transmitting torque to/receiving torque from their common torque transmitting device, than one of those torque transmitting devices need to be mounted on an adjuster, so that its rotational position can be adjusted relative to the rotational position of the other alternating torque transmitting device. And when for a rotational position three alternating torque transmitting devices can simultaneously be transmitting torque to/receiving torque from their common torque transmitting device, than most likely two of those alternating torque transmitting devices need to be mounted on an adjuster, so that the rotational position of those two alternating torque transmitting devices can be adjusted relative to the rotational position of the non-adjuster mounted alternating torque transmitting device. So basically, if for a rotational position, n number of alternating torque transmitting devices can be simultaneously transmitting torque to/receiving torque from their common torque transmitting device, than most likely n−1 of those alternating torque transmitting devices need to be mounted on an adjuster. For all other rotational positions, the same rule applies. By determining all the different configurations of how the alternating torque transmitting devices can transmit torque to/receive torque from their common torque transmitting device and how many common torque transmitting devices are used, the amount of adjusters needed and how to mount them can be determined. Here for a common torque transmitting device, most likely the configuration obtained consist of groups of adjuster mounted alternating torque transmitting devices, preferably the same amount of adjuster mounted alternating torque transmitting devices in each group, that alternate with non-adjuster mounted torque transmitting devices to form a sequential and continuous torque transmitting means where at any instance only one non-adjuster mounted torque transmitting devices is transmitting torque.

Furthermore, in most cases the amount of adjusters needed determined from the method described in the previous paragraph can be reduced by coupling the alternating torque transmitting devices, which need to be mounted on adjusters but are never simultaneously engaged to a common torque transmitting device, to a common adjuster. The common adjuster can then be used to adjust the rotational position of the alternating torque transmitting device about to be engaged or engaged. Also here the common adjuster needs to be able to adjust the rotational position of the alternating torque transmitting device about to be engaged before it becomes engaged. For configuration where an instance exist where an alternating torque transmitting device coupled to a common adjuster is engaged while another alternating torque transmitting device coupled to the same common adjuster is about to come into engagement, the time available for the common adjuster to provide the adjustment can be very short so that an adjuster fast enough is needed. This time can be increased by using more adjusters, which can be common adjusters or otherwise.

And when adjusters are used to adjust the rotational position of the common torque transmitting devices, then in most cases the rotational position of the common torque transmitting devices need to be adjustable. This can be achieved by using an adjuster for each common torque transmitting device. For certain configurations this can also be achieved by using one adjuster to adjust the rotational position of several or all common torque transmitting devices. A possible scenario for this method is having an adjuster adjust the rotational position of a shaft on which several common torque transmitting devices are mounted. In this case, in instances where the rotational position of a common torque transmitting device is being adjusted, it should only be engaged with one alternating torque transmitting device, hence the arc lengths of the torque transmitting members of the common torque transmitting devices should be limited to ensure this.

Furthermore, adjusters can also be used to substantially increase the duration at which the transmission ratio of a CVT can be changed. One method to achieve this, is to use an adjuster to mount each cone assembly to its shaft. If the transmission ratio needs to be changed, these adjusters can then be used to rotate the cone assemblies relative to their shaft such that are maintained in a moveable configuration. This method is used for CVT 1.1 described earlier.

In a configuration of a CVT where a complete non-torque transmitting arc, which is the space of a cone assembly that is not covered by a torque transmitting member, is never completely covered by its coupled torque transmitting device, then the duration at which the transmission ratio can be changed can be substantially increased by compensating for transmission ratio change rotation. This method is used in CVT 2.1. In order to compensate for transmission ratio change rotation, the rotation of the alternating torque transmitting devices which changes in transmission ratio causes them to rotate differently than a referenced alternating torque transmitting device needs to be adjusted, which is achieved by using adjusters. Or the rotation of the alternating torque transmitting devices engaged or coupled to the alternating torque transmitting devices mentioned in the previous sentence need to be adjusted in the same manner.

In order to determine the transmission ratio change rotation of an alternating torque transmitting device, first all other alternating torque transmitting devices should be removed from the CVT while the rest of the CVT should be left alone. Next the CVT should be placed in either its highest or lowest transmission ratio. Then the alternating torque transmitting device, for which its transmission ratio change rotation needs to be determined, should be positioned so that it can transmit torque at a recorded initial rotational position. Next the transmission ratio should be changed while the rotation of that alternating torque transmitting member as the transmission ratio is changed is recorded. The recorded results provide the amount of transmission ratio change rotation for that initial rotational position. Using the same method the amount of transmission ratio change rotation for different initial rotational positions can be determined. From the collected data an equation that estimates the amount of transmission ratio change rotation for different initial rotational positions and different initial and final transmission ratios can be constructed. Mathematics can also be used to obtain such equation. An example on how to obtain such equation mathematically can be found in the Adjuster System for CVT 2 Section and the CVT 2.2 Section of this patent. Based on those examples, it should not be difficult for someone with a mathematics background to obtain such equation for different configurations of CVTs.

When the transmission ratio change rotation of each alternating torque transmitting device is different, then the method to determine the amount of adjusters needed and the basic configuration on how to mount them is identical to the method used in the case where adjusters are used to adjust the rotational position of the alternating torque transmitting devices in eliminating transition flexing.

In order to properly control the adjusters to compensate for transmission ratio change rotation the following methods can be used. The first method is by controlling the adjusters so that the differences in torque being transmitted by the alternating torque transmitting devices that are transmitting torque are within a predetermined range. In that predetermined range, the difference in torque being transmitted by the torque transmitting devices due to transmission ratio change rotation can be compensated by flexing of the torque transmitting devices used to transmit torque. And when the differences in torque being transmitted exceed the predetermined range, stalling of the transmission ratio changing actuator should occur. If this method is used then each alternating torque transmitting device need to have a device that measures the torque being transmitted by it, such as a torque sensor or load cell for example. Another method to compensate for transmission ratio change rotation is to determine the equations that estimates transmission ratio change rotation for each alternating torque transmitting device, and then control the adjusters based on those equations to compensate for transmission ratio change rotation. One method of adjustment is by having referenced alternating torque transmitting devices, which rotations are not adjusted, and adjusted alternating torque transmitting devices, which rotations are adjusted. The amount of adjusting rotation for an adjusted alternating torque transmitting devices is calculated by subtracting the amount of transmission ratio change rotation of that adjusted alternating torque transmitting device from the amount of transmission ratio change rotation of its referenced alternating torque transmitting device. Although not absolutely necessary, it is preferred that counter-clockwise rotations are considered positive and clockwise rotations are considered negative. Since the torque transmitting devices are rotating, the amount of adjustments required continuously change. Hence the value for the amount of adjustments needed should be updated at short enough intervals so that the amount of adjustments provided are sufficiently accurate to prevent excessive stalling of transmission ratio changing actuator. An example on how to use this method is discussed in the explanation for CVT 2.2. Furthermore, in case every alternating torque transmitting device is mounted on an adjuster, another method of adjustment is to cancel out transmission ratio change rotation for each alternating torque transmitting device by having the adjusters provide their alternating torque transmitting devices an equal amount of rotation as their transmission ratio change rotation but reversely directed.

Furthermore, as discussed in detail in the Adjuster System for CVT 2 Section, for an adjuster, it is preferred that in order to compensate for transmission ratio change rotation, it only needs to provide rotation which direction is opposite from the rotation of the shaft on which its alternating torque transmitting device is mounted. Since this will lower the torque requirement of the adjuster, since it only needs to provide releasing rotation. This is can be achieved by using an adjuster on each alternating torque transmitting member. This method is described in the CVT 2.3 Section and the CVT 2.4 Section of this patent. And for a CVT that consist of a cone assembly with one torque transmitting member that is sandwiched by two gears, here each gear need to have an adjuster that can adjust its rotational position relative to the rotational position of its shaft, which is coupled to the shaft of the other gear. Besides using an adjuster on each alternating torque transmitting member, another method to having an adjuster compensate for transmission ratio change rotation by only providing a releasing torque can be achieved by using a differential between each alternating torque transmitting device and have an adjuster control the rotational position of one differential shaft relative to the other. Examples of this method are described in the Differential adjuster shaft for CVT 2 Section of this patent. And for a CVT that consist of a cone assembly with one torque transmitting member that is sandwiched by two gears, each gear needs to be coupled to a differential shaft of a differential, while the input/output shaft is coupled to the housing of the differential.

Once the proper configuration for the adjuster utilizing CVT has been determined, the designer needs to determine what kind of adjuster the designer wants to or can use. The most versatile adjuster is the electrical adjuster, which can be used to eliminate transition flexing, maintain a cone assembly in a moveable configuration, and compensate for transmission ratio change rotation in almost all applications. However, in order to properly control an electrical adjuster, the designer needs to use a computer and various sensors, such as transmission ratio sensors, rotational position sensors, relative rotational position sensors, torque sensors, etc. The methods of utilizing the sensors and the methods for controlling an electrical adjuster are described in detail in the previous sections of this patent.

Another, less versatile, adjuster that might be useful for some CVTs is the mechanical adjuster. This adjuster can only be used to eliminate transition flexing. For the mechanical adjuster, it is not absolutely necessary, although it might be beneficial, to use a computer and various sensors in order to control it. Hence this adjuster might be preferred in machines where electrical power is not available, such as bikes for example.

Another adjuster that can be used, is the spring-loaded adjuster. This adjuster can be used to eliminate transition flexing and allow some relative rotation that slightly increase the moveable duration of a CVT. This adjuster is the simplest and most likely cheapest of the adjusters described in this patent. However, for this adjuster, shock loads occur when the pins of its gap mounted torque transmitting member hit a surface of the cone assembly that forms that gap. These shock loads might be negligible in low torque applications. But in high torque applications, unless properly damped, these shock loads can significantly decrease the live of the CVT and can cause undesirable driving conditions. However, damping these shock loads can also significantly reduce the efficiency of the CVT.

Based on the description in this patent, a machine designer can determine how to properly mount adjusters so that transition flexing can be eliminated and/or so that the duration at which the transmission ratio can be changed can be substantially increased in CVTs suffering from these problems. Also several adjusters, with their advantages and disadvantages, and their usage, has been described in this patent.

### CONCLUSION, RAMIFICATION, AND SCOPE

Accordingly, the reader will see that the adjuster systems of this invention can be used to improve the performance of a CVT that suffers from either or both transition flexing and a limited duration at which the transmission ratio can be changed in the following manner. First of all, they can eliminate or significantly reduce transition flexing. Excessive cycles of transition flexing can reduce the life of a CVT. Furthermore, the adjuster systems of this invention can also be used so that the duration at which the transmission ratio can be changed can be substantially increased so as to improve the transmission ratio changing responsiveness of a CVT. In addition, the adjuster systems of this invention can also improve the engagement between torque transmitting devices by compensating for tooth wear and partially engaged teeth. Hence using the adjuster systems of this invention improved CVTs which torque transmission does not need to depend on friction can be constructed.

While my above description contains many specifities, these should not be construed as limitation on the scope of the invention, but rather as an exemplification of one preferred embodiment thereof. Many other variations are possible.

Accordingly, the scope of the invention should be determined not by the embodiments illustrated, but by the appended claims and their legal equivalents.

1. A method for improving the performance of CVTs that suffer from either or both transition flexing and a limited duration at which the transmission ratio can be changed by using rotational position adjuster systems that can adjust the rotational position of one or several means for transmitting torque, such as torque transmitting members, cone assemblies, transmission pulleys, gears, etc., so that transition flexing can be minimized and/or the duration at which the transmission ratio can be changed can be significantly increased.
